(19) United States
(12) Patent Application Publication
(10) Pub. No.: US 2006/0111849 A1
(43) Pub. Date: May 25, 2006

(54) Computer systems and methods that use clinical and expression quantitative trait loci to associate genes with traits

(76) Inventors: Eric E Schadt, Kirkland, WA (US); Stephanie A Monks, Stillwater, OK (US)

Correspondence Address: JONES DAY, 222 EAST 41ST ST, NEW YORK, NY, 10017, US

(21) Appl. No.: 10/523,143

(22) PCT Filed: Aug. 1, 2003
(86) PCT No.: PCT/US03/23976

§ 371 Date: Aug. 16, 2005

Related U.S. Application Data
(60) Provisional application No. 60/460,303, filed on Apr. 2, 2003.

(30) Foreign Application Priority Data
Aug. 2, 2002 (US) 60400522

(51) Int. Cl. G06F 19/00

(52) U.S. Cl. 702/20

(57) ABSTRACT

A method for associating a gene G in the genome of a species with a clinical trait T exhibited by one or more organisms in a plurality of organisms of the species. An expression quantitative trait loci (eQTL) is identified for the gene G using a first quantitative trait loci (QTL) analysis. The first QTL analysis uses a plurality of expression statistics for gene G as a quantitative trait. Each expression statistic in the plurality of expression statistics represents an expression value for gene G in an organism in the plurality of organisms. A clinical quantitative trait loci (cQTL) that is linked to the clinical trait T is identified using a second QTL analysis. The second QTL analysis uses a plurality of phenotypic values as a quantitative trait. Each phenotypic value in the plurality of phenotypic values represents a phenotypic value for the clinical trait T in an organism in the plurality of organisms. When the eQTL and the cQTL colocalize to the same locus, the gene G is associated with clinical trait T.

### CROSS-REFERENCE TO RELATED APPLICATIONS

This application claims benefit, under 35 U.S.C. § 119(e), of U.S. Provisional Patent Application No. 60/460,303 filed on Apr. 2, 2003 which is incorporated herein, by reference, in its entirety. This application also claims benefit, under 35 U.S.C. § 119(e), of U.S. Provisional Patent Application No. 60/400,522 filed on Aug. 2, 2002 which is incorporated herein, by reference, in its entirety.

### 1. FIELD OF THE INVENTION

The field of this invention relates to computer systems and methods for identifying genes and biological pathways associated with traits. In particular, this invention relates to computer systems and methods for using both gene expression data and genetic data to identify gene-gene interactions, gene-phenotype interactions, and biological pathways linked to traits.

### 2. BACKGROUND OF THE INVENTION

A variety of approaches have been taken to identify genes and pathways that are associated with traits, such as human disease. In one approach, attempts have been made to use gene expression data to identify genes and pathways associated with such traits. In another approach, genetic information has been used to attempt to identify genes and pathways associated with traits. For instance, clinical measures of a population cab be taken to study a trait such as a disease found in the population. Risk factors for the trait can be established from these clinical measures. Demographic and environmental factors are further used to explain variation with respect to the trait. Further, genetic variations associated with traits, such as disease-related traits, as well as the disease itself are used to identify regions in the genome linked to a disease. For example, genetic variations in a population may be used to determine what percentage of the variation of the trait in the population of interest can be explained by genetic variation of a single nucleotide polymorphism (SNP), haplotype, or short tandem repeat (STR) marker. However, as will be described below, the elucidation of genes involved in biological pathways that influence a trait, such as a disease, using either gene expression or genetic expression approaches, is problematic and generally not successful in many instances.

### 2.1. Use of Measured Gene Expression Data to Identify Genes and Pathways Associated with Traits

Within the past decade, several technologies have made it possible to monitor the expression level of a large number of transcripts at any one time (see, e.g., Schena et al., 1995, Quantitative monitoring of gene expression patterns with a complementary DNA microarray, Science 270:467-470; Lockhart et al., 1996, Expression monitoring by hybridization to high-density oligonucleotide arrays, Nature Biotechnology 14:1675-1680; Blanchard et al., 1996, Sequence to array: Probing the genome's secrets, Nature Biotechnology 14, 1649; U.S. Pat. No. 5,569,588, issued Oct. 29, 1996 to Ashby et al. entitled “Methods for Drug Screening”). In organisms for which the complete genome is known, it is possible to analyze the transcripts of all genes within the cell. With other organisms, such as human, for which there is an increasing knowledge of the genome, it is possible to simultaneously monitor large numbers of the genes within the cell.

Such monitoring technologies have been applied to the identification of genes that are up regulated or down regulated in various diseased or physiological states, the analyses of members of signaling cellular states, and the identification of targets for various drugs. See, e.g., Friend and Hartwell, U.S. Pat. No. 6,165,709; Stoughton, U.S. Pat. No. 6,132,969; Stoughton and Friend, U.S. Pat. No. 5,965,352; Friend and Stoughton, U.S. Pat. No. 6,324,479; and Friend and Stoughton, U.S. Pat. No. 6,218,122, all incorporated herein by reference for all purposes.

Levels of various constituents of a cell are known to change in response to drug treatments and other perturbations of the biological state of a cell. Measurements of a plurality of such “cellular constituents” therefore contain a wealth of information about the effect of perturbations and their effect on the biological state of a cell. Such measurements typically comprise measurements of gene expression levels of the type discussed above, but may also include levels of other cellular components such as, but by no means limited to, levels of protein abundances, protein activity levels, or protein interactions. The collection of such measurements is generally referred to as the “profile” of the cell's biological state. Statistical and bioinformatical analysis of profile data has been used to try to elucidate gene regulation events. Statistical and bioinformatical techniques used in this analysis comprises hierarchical cluster analysis, reference or supervised classification approaches and correlation-based analyses, See, e.g., Tamayo et al., 1999, Interpreting patterns of gene expression with self-organizing maps: methods and application of hematopoietic differentiation, Proc. Natl. Acad. Sci. U.S.A. 96:2907-2912; Brown et al., 2000, Knowledge-based analysis of microarray gene expression data by using support vector machines, Proc. Natl. Acad. Sci. U.S.A.: 97, 262-267; Gaasterland and Bekinraov, Making the most of microarray data, Nat. Genet.: 24, 204-206, Cohen et al., 2000, A computational analysis of whole-genome expression data reveals chromosomal domains of gene expression, Nat. Genet. 24: 5-6, 2000.

The use of gene expression data to identify genes and elucidate pathways associated with traits has typically relied on the clustering of gene expression data over a variety of conditions. See, e.g., Roberts et al., 2000, Signaling and circuitry of multiple MAPK pathways revealed by a matrix of global gene expression profiles; Science 287:873; Hughes et al., 2000, Functional Discovery via a Compendium of Expression Profiles, Cell 102:109. However, gene expression clustering has a number of drawbacks. First, gene expression clustering has a tendency to produce false positives. Such false positives arise, for example, when two genes coincidentally have correlated expression profiles over a variety of conditions. Second, although gene expression clustering provides information on the interaction between genes, it does not provide information on the topology of biological pathways. For example, clustering of gene expression data over a variety of conditions may be used to determine that genes A and B interact. However, gene expression clustering typically does not provide sufficient information to determine whether gene A is downstream or upstream from gene B in a biological pathway. Third, direct biological experiments are often required to validate the involvement of any gene identified from the clustering of gene expression data in order to increase the confidence that the target is actually valid. For these reasons, the use of gene expression data alone to identify genes involved in traits, such as various complex human diseases, has often proven to be unsatisfactory.

### 2.2. Use of Genetics Data to Identify Genes and Pathways Associated with Traits

Genetics data have been used in the field of trait analysis in order to attempt to identify the genes that affect such traits. A key development in such pursuits has been the development of large collections of molecular/genetic markers, which can be used to construct detailed genetic maps of species, such as humans. These maps are used in Quantitative Trait Locus (QTL) mapping methodologies such as single-marker mapping, interval mapping, composite interval mapping and multiple trait mapping. (For a review, see Doerge, 2002, Mapping and analysis of quantitative trait loci in experimental populations, Nature Reviews: Genetics 3:43-62. QTL mapping methodologies provide statistical analysis of the association between phenotypes and genotypes for the purpose of understanding and dissecting the regions of a genome that affect traits.

A quantitative trait locus (QTL) is a region of any genome that is responsible for some percentage of the variation in the quantitative trait of interest. The goal of identifying all such regions that are associated with a specific complex phenotype is typically difficult to accomplish because of the sheer number of QTL, the possible epistasis or interactions between QTL, as well as many additional sources of variation that can be difficult to model and detect. To address these problems, QTL experiments can be designed with the aim of containing the sources of variation to a limited number in order to improve the chances of dissecting a complex phenotype. In general, a large sample of individuals has to be collected to represent the total population, to provide an observable number of recombinants and to allow a thorough assessment of the trait under investigation. Using this information, coupled with one of several methodologies to detect or locate QTL, associations between quantitative traits and genetic markers are made as steps toward understanding the genetic basis of complex traits.

A drawback with QTL approaches is that, even when genomic regions that have statistically significant associations with traits are identified, such regions are usually so large that subsequent experiments, used to identify specific causative genes in these regions, are time consuming and laborious. High density marker maps of the genomic regions are required. Furthermore, physical resequencing of such regions is often required. In fact, because of the size of the genomic regions identified, there is a danger that causative genes within such regions simply will not be identified. In the event of success, and the genomic region containing genes that are responsible for the trait variation are elucidated, the expense and time from the beginning to the end of this process is often too great for identifying genes and pathways associated with traits, such as complex human diseases.

In the case of humans, the use of genetics to identify genes and pathways associated with traits follows a very standard paradigm. First, a genome-wide linkage study is performed using hundreds of genetic markers in family-based data to identify broad regions linked to the trait. The result of this standard sort of linkage analysis is the identification of regions controlling for the trait, thereby restricting attention from the 30,000 plus genes to perhaps as few as 500 to 1000 genes in a particular region of the genome that is linked to the trait. However, the regions identified using linkage analysis are still far too broad to identify candidate genes associated with the trait. Therefore, such linkage studies are typically followed up by fine mapping the regions of linkage using higher density markers in the linkage region, increasing the number of families in the analysis, and identifying alternative populations for study. These efforts further restrict attention to narrower regions of the genome, on the order of 100 genes in a particular region linked to the trait. Even with the more narrowly defined linkage region, the number of genes to validate is still unreasonably large. Therefore, research at this stage focuses on identifying candidate genes based on putative function of known or predicted genes in the region and the potential relevance of that function to the trait. This approach is problematic because it is limited to what is currently known about genes. Often, such knowledge is limited and subject to interpretation. As a result, researchers are often led astray and do not identify the genes affecting the trait.

There are many reasons that standard genetic approaches have not proven very successful in the identification of genes associated with traits, such as common human diseases, or the biological pathways associated with such traits. First, common human diseases such as heart disease, obesity, cancer, osteoporosis, schizophrenia, and many others are complex in that they are polygenic. That is, they potentially involve many genes across several different biological pathways and they involve complex gene-environment interactions that obscure the genetic signature. Second, the complexity of the diseases leads to a heterogeneity in the different biological pathways that can give rise to the disease. Thus, in any given heterogeneous population, there may be defects across several different pathways that can give rise to the disease. This reduces the ability to identify the genetic signal for any given pathway. Because many populations involved in genetic studies are heterogeneous with respect to the disease, multiple defects across multiple pathways are operating within the population to give rise to the disease. Third, as outlined above, the genomic regions associated with a linkage to a complex disease are large and often contain a number of genes and possible variants that are potentially associated with the disease. Fourth, the traits and disease states themselves are often not well defined. Therefore, subphenotypes are often overlooked even though these subphenotypes implicate different sets of biological pathways. This reduces the power of detecting the associations. Fifth, even when genes and trait are highly correlated, the genes may not give the same genetic signature. Sixth, in cases where genes and a trait are moderately correlated, or not correlated at all, the genes may give rise to the same genetic signature.

In addition to the heterogeneity problems discussed above, the identification of genes and biological pathways associated with traits, such as complex human diseases, using genetics data is confounded, when using human subjects, due to the inability to use common genetic techniques and resources in humans. For example, humans cannot be crossed in controlled experiments. Therefore, there is very little pedigree data available for humans. In addition, human marker maps are not as dense as those found in model genetic organisms. Elucidation of genes associated with complex diseases in humans is also difficult because humans are diploid organisms containing two genomes in each nucleate cell, making it very hard to determine the DNA sequence of the haploid genome. Because of these limitations, genetic approaches to discovering genes and biological pathways associated with complex human diseases are unsatisfactory.

Companies such as deCode Genetics (Reykjavik, Iceland) study populations that are isolated and so are more homogenous with respect to disease, thereby increasing the power to detect association. The disease variations themselves in such populations are greatly reduced as founder effects for many diseases are evident (i.e., specific forms of diseases in such populations most likely arose from a single or small numbers of founders of the population). Other companies, such as Gemini Genomics (Cambridge, United Kingdom ), use twin cohorts to study complex diseases. Identical twins are a powerful tool in establishing the genetic component of a trait. The genetic component of a trait is defined as the degree to which a given trait is under genetic control. Dizygotic twins allow for age, gender and environment matching, which helps reduce many of the confounding factors that often reduce the power of genetic studies. In addition, the completion of the human genome has made the job of identifying candidate genes in a region of linkage far easier, and it reduces dependency on considering only known genes, since genomic regions can be annotated using ab initio gene prediction software to identify novel candidate genes associated with the disease. Further, the use of demographic, epidemiological and clinical data in more sophisticated models helps explain much of the trait variation in a population. Reducing the overall variation in this way increases the power to detect genetic variation. The identification of millions of SNPs allows finer mapping in any given region of the genome and direct association testing of very large case/control populations, thereby reducing the need to study families and more directly identify the degree to which any genetic variant affects a given population. Finally, our understanding of disease and the need to subphenotype a given disease is now more fully appreciated and aids in reducing the heterogeneity of the disease under study. Technologies such as microarrays have greatly facilitated the ability to subclassify disease subtypes for a given disease. However, all of the methods still fall short when it comes to efficiently identifying genes and pathways associated with complex diseases.

Thus, given the above background, what is needed in the art are improved methods for identifying genes and biological pathways that affect traits such as diseases.

Discussion or citation of a reference herein will not be construed as an admission that such reference is prior art to the present invention.

### 3. SUMMARY OF THE INVENTION

The present invention provides an improvement over the art by uniquely combining gene expression approaches with genetic approaches in order to determine the genes associated with traits, such as complex human diseases. In the computer systems and methods of the present invention, genetic approaches are used to filter out false positive genes from gene expression clusters. Furthermore, the computer systems and methods of the present invention are used to advantageously combine gene expression data with genetics data to elucidate biological pathways associated with traits. One embodiment of the invention provides a method for associating a gene G in the genome of a species with a clinical trait T exhibited by one or more organisms in a plurality of organisms of the species. In the method, an expression quantitative trait loci (eQTL) is identified for gene G using a first quantitative trait loci (QTL) analysis. This first QTL analysis uses a plurality of expression statistics for gene G as a quantitative trait. Each expression statistic in the plurality of expression statistics represents an expression value for gene G in an organism in the plurality of organisms. Further, a clinical quantitative trait loci (cQTL) that is linked to the clinical trait T is identified using a second QTL analysis. The second QTL analysis uses a plurality of phenotypic values as a quantitative trait. Each phenotypic value in the plurality of phenotypic values represents a phenotypic value for the clinical trait T in an organism in the plurality of organisms. Further still, a determining step determines whether the eQTL and the cQTL colocalize to the same locus in the genome of the species. When the eQTL and the cQTL colocalize to the same locus, the gene G is associated with the clinical trait T.

In some embodiments of the present invention, multiple clinical traits T and/or gene expression data for multiple genes is considered simultaneously using multivariate analysis in order to verify that each of the traits T and/or genes affect the trait of interest. Also, in some embodiments, gene expression data for multiple genes identified using the techniques described above are considered simultaneously using multivariate analysis in order to verify that each of the genes is involved in the same biological pathway. It is possible to have a plurality of genes having coregulated expression that actually represent unrelated biological pathways. The multivariate analysis of the present invention is advantageous is such situations because the analysis can be used to determine whether a set of genes represents more than one biological pathway. It is also possible to have genes that are not coregulated but belong to the same biological pathway. Multivariate analysis of the present invention is advantageous in these situations because the analysis can be used to confirm that such genes actually belong to the same biological pathway. In some embodiments, multivariate analysis is used to analyze data from multiple tissues in order to determine whether gene expression data from multiple tissues is correlated. In instances where gene expression data from multiple tissues is not correlated, further analysis is performed on each tissue sample. For example, gene expression data from each tissues sample is separately combined with genetic analysis data in order to identify genes and biological pathways associated with traits.

In some embodiments, the locus of the eQTL in the genome of the species corresponds to the physical location of the gene G in the genome of the species. In some embodiments, the eQTL corresponds to the physical location of the gene G when the eQTL and gene G colocalize within 1 cM or 3 cM of each other in the genome of the species. In some embodiments, the method further comprises testing whether the colocalization of the eQTL and the cQTL is caused by pleiotropy. In still other embodiments, the first QTL analysis and the second QTL analysis uses a genetic map that represents the genome of the species.

In yet other embodiments, the method further comprises a step of constructing the genetic map from a set of genetic markers associated with the plurality of organisms prior to performing the first QTL analysis. In some embodiments, the set of genetic markers comprises single nucleotide polymorphisms (SNPs), microsatellite markers, restriction fragment length polymorphisms, short tandem repeats, DNA methylation markers, sequence length polymorphisms, random amplified polymorphic DNA, amplified fragment length polymorphisms, simple sequence repeats, or haplotypes. In some embodiments, genotype data is used construct the genetic map. In such embodiments, the genotype data comprises knowledge of which alleles, for each marker in the set of genetic markers, are present in each organism in the plurality of organisms. In some embodiments, the plurality of organisms represents a segregating population and pedigree data is used to construct the genetic map. Exemplary pedigree data shows one or more relationships between organisms in the plurality of organisms. In still other embodiments, the plurality of organisms comprises an F2 population.

In some embodiments, each expression value is a normalized expression level measurement for the gene G in an organism in the plurality of organisms. In some embodiments, each expression level measurement is determined by measuring an amount of a cellular constituent encoded by the gene G in one or more cells from an organism in the plurality of organisms. In one embodiment, the amount of the cellular constituent comprises an abundance of an RNA present in the one or more cells of the organism. In some embodiments, the abundance of the RNA is measured by a method comprising contacting a gene transcript array with the RNA from the one or more cells of the organism, or with nucleic acid derived from the RNA. In such embodiments, the gene transcript array comprises a positionally addressable surface with attached nucleic acids or nucleic acid mimics and the nucleic acids or nucleic acid mimics are capable of hybridizing with the RNA species, or with nucleic acid derived from the RNA species. In some embodiments, normalized expression level measurements are obtained by a normalization technique such as Z-score of intensity, median intensity, log median intensity, Z-score standard deviation log of intensity, Z-score mean absolute deviation of log intensity, calibration DNA gene set, user normalization gene set, ratio median intensity correction, intensity background correction, or a combination of such techniques.

In some embodiments of the present invention, the first QTL analysis comprises (i) testing for linkage between (a) the genotype of the plurality of organisms at a position in the genome of the species and (b) the plurality of expression statistics for gene G, (ii) advancing the position in the genome by an amount, and (iii) repeating steps (i) and (ii) until the genome of the species has been tested. In one embodiment, the amount advanced is less than 100 centiMorgans, in another embodiment, the amount is less than 10 centiMorgans. In still other embodiments, the amount is less than 5 centiMorgans or less than 2.5 centiMorgans. In some embodiments, the test for linkages comprises performing linkage analysis or association analysis. In some embodiments, the linkage analysis or association analysis generates a statistical score for the position in the genome of the species, such as a logarithm of the odds (lod) score. In some embodiments, the eQTL is represented by a lod score that is greater than 2.0, greater than 3.0, greater than 4.0, or greater than 5.0.

In some embodiments of the present invention, the second QTL analysis comprises (i) testing for linkage between.(a) the genotype of the plurality of organisms at a position in the genome of the species and (b) the plurality of phenotypic values, (ii) advancing the position in the genome by an amount; and (iii) repeating steps (i) and (ii) until the genome of the species has been tested. In some embodiments, the amount advanced is less than 100 centiMorgans, less than 10 centiMorgans, less than 5 centiMorgans, or less than 2.5 centiMorgans. In some embodiments, the testing for linkage comprises performing linkage analysis or association analysis. In some embodiments, linkage analysis or association analysis generates a statistical score for the position in the genome of the species, such as a logarithm of the odds (lod) score. In some embodiments, the cQTL is represented by a lod score that is greater than 2.0, a lod score that is greater than 3.0, a lod score that is greater than 4.0, or a lod score that is greater than 5.0.

In some embodiments of the present invention, the plurality of organisms is human. In still other embodiments, the clinical trait T is a complex trait. In some embodiments, the complex trait is characterized by an allele that exhibits incomplete penetrance in the species. In some embodiments, the clinical trait T is a disease that is contracted by an organism in the population and the organism inherits no predisposing allele to the disease. In some embodiments, the clinical trait T arises when any of a plurality of different genes in the genome of the species is mutated. In some embodiments, the clinical trait T arises when any of a plurality of different genes in the genome of the species is mutated and certain environmental factors, such as smoking, lack of exercise, exposure to carcinogens are found In some embodiments, the clinical trait T requires the simultaneous presence of mutations in a plurality of genes in the genome of, the species. In still other embodiments, the clinical trait T is associated with a high frequency of disease-causing alleles in the species. In yet other embodiments, the clinical trait T is a phenotype that does not exhibit Mendelian recessive or dominant inheritance attributable to a single gene locus. In still other embodiments, the trait is susceptibility to heart disease, hypertension, diabetes, cancer, infection, polycystic kidney disease, early-onset Alzheimer's disease, maturity-onset diabetes of the young, hereditary nonpolyposis colon cancer, ataxia telangiectasia, nonalcoholic steatohepatitis (NASH), nonalcoholic fatty liver (NAFL), obesity, or xeroderma pigmentosum.

Another aspect of the present invention provides a computer program product for use in conjunction with a computer system. The computer program product comprises a computer readable storage medium and a computer program mechanism embedded therein. The computer program mechanism is for associating a gene G in the genome of a species with a clinical trait T exhibited by one or more organisms in a plurality of organisms of the species. The computer program mechanism comprises an expression quantitative trait loci (eQTL) identification module for identifying an expression quantitative trait loci (eQTL) for the gene G using a first quantitative trait loci (QTL) analysis. The first QTL analysis uses a plurality of expression statistics for gene G as a quantitative trait. Each expression statistic in the plurality of expression statistics represents an expression value for gene G in an organism in the plurality of organisms. The computer program mechanism further includes a clinical quantitative trait loci (cQTL) identification module for identifying a clinical quantitative trait loci (cQTL) that is linked to the clinical trait T using a second QTL analysis. The second QTL analysis uses a plurality of phenotypic values as a quantitative trait. Each phenotypic value in the plurality of phenotypic values represents a phenotypic value for the clinical trait T in an organism in the plurality of organisms. The computer program mechanism also includes a determination module for determining whether the eQTL and the cQTL colocalize to the same locus in the genome of the species. When the eQTL and the cQTL colocalize to the same locus, the gene G is associated with the clinical trait T.

Another aspect of the present invention provides a computer system for associating a gene G in the genome of a species with a clinical trait T exhibited by one or more organisms in a plurality of organisms of the species. The computer system comprises a central processing unit as well as a memory. The memory is coupled to the central processing unit. The memory stores an expression quantitative trait loci (eQTL) identification module, a clinical quantitative trait loci (cQTL) identification module, and a determination module. The expression quantitative trait loci (eQTL) identification module comprises instructions for identifying an expression quantitative trait loci (eQTL) for the gene G using a first quantitative trait loci (QTL) analysis. The first QTL analysis uses a plurality of expression statistics for gene G as a quantitative trait. Each expression statistic in the plurality of expression statistics represents an expression value for gene G in an organism in the plurality of organisms. The clinical quantitative trait loci (cQTL) identification module comprises instructions for identifying a clinical quantitative trait loci (cQTL) that is linked to the clinical trait T using a second QTL analysis. The second QTL analysis uses a plurality of phenotypic values as a quantitative trait. Each phenotypic value in the plurality of phenotypic values represents a phenotypic value for the clinical trait T in an organism in the plurality of organisms. The determination module comprises instructions for determining whether the eQTL and the cQTL colocalize to the same locus in the genome of the species. When the eQTL and the cQTL colocalize to the same locus, the gene G is associated with the clinical trait T

Another aspect of the present invention provides a method for determining the topology of a biological pathway that affects a trait. The method has the step of (A), identifying one or more expression quantitative trait loci (eQTL) for a gene in a plurality of genes using a first quantitative trait loci (QTL) analysis. This first QTL analysis uses a plurality of expression statistics for the gene as a quantitative trait. Each expression statistic in the plurality of expression statistics represents an expression value for the gene in an organism in a plurality of organisms of a species. The method further comprises the step of (B), repeating step (A) a first number of times, wherein each repetition of step (A) uses a different gene in the plurality of genes. In some embodiments, step (A) is repeated three or more times. In some embodiments, step (A) is repeated 5 or more times, 8 or more times, 12 or more times, 20 or more times, or 100 or more times. The method further comprises the step of (C), identifying a clinical quantitative trait loci (cQTL) that is lied to a clinical trait in a plurality of clinical traits using a second QTL analysis. The second QTL analysis uses a plurality of phenotypic values as a quantitative trait. Each phenotypic value in the plurality of phenotypic values represents a phenotypic value for the clinical trait in the plurality of clinical traits in an organism in the plurality of organisms. The method further comprises the step of (D), repeating step (C) a second number of times. Each repetition of step (C) uses a different clinical trait in a plurality of clinical traits. In some embodiments, step (C) is repeated 3 or more times. In some embodiments, step (C) is repeated 5 or more times, 8 or more times, 12 or more times, 20 or more times, or 100 or more times. Finally, the method comprises the step of (E), using (i) the identity of each eQTL, identified in an iteration of step (A), that colocalizes with a cQTL, identified in an iteration of step (C), and (ii) a physical location of each gene in the plurality of genes on a molecular map for the species, in order to determine the topology of the biological pathway that affects the trait.

### 4. BRIEF DESCRIPTION OF THE DRAWINGS

FIG. 1 illustrates a computer system for associating a gene with a trait exhibited by one or more organisms in a plurality of organisms in accordance with one embodiment of the present invention.

FIG. 2 illustrates processing steps for associating a gene with a trait exhibited by one or more organisms in a plurality of organisms of a species using a clustering approach, in accordance with an embodiment of the present invention.

FIG. 3A illustrates an expression/genotype warehouse in accordance with one embodiment of the present invention.

FIG. 3B illustrates a gene expression statistic found in an expression/genotype warehouse in accordance with one embodiment of the present invention.

FIG. 3C illustrates an expression/genotype warehouse in accordance with another embodiment of the present invention.

FIG. 4 illustrates quantitative trait locus results database in accordance with one embodiment of the present invention.

FIG. 5 illustrates genetic crosses used to derive a mouse model for a complex human disease in accordance with one embodiment of the present invention.

FIG. 6 provides a histogram for p-values of segregation analyses performed on 2,726 genes across four CEPH families in accordance with one embodiment of the present invention.

FIG. 7 illustrates expression quantitative trait loci (“eQTL”) identified for a diversity of transcript abundance polymorphisms in accordance with one embodiment of the present invention.

FIG. 8 highlights a range of gene-centered polymorphisms known to exist between DBA and B6 mouse strains, in accordance with one embodiment of the present invention.

FIG. 9 illustrates how quantitative trait loci analysis using gene expression as a quantitative trait can detect a quantitative trait loci for a gene that has a higher copy number in one parent than the other, in accordance with one embodiment of the present invention.

FIG. 10 illustrates how the use of expression data as a quantitative trait can detect differential splicing, in accordance with one embodiment of the present invention.

FIG. 11 illustrates the pathways associated with nicotinate and nicotinamide metabolism in accordance with the prior art.

FIG. 12 provides a key for important enzymes in the pathways associated with nicotinate and nicotinamide metabolism that are illustrated in FIG. 11.

FIG. 13 illustrates how the use of expression data as a quantitative trait can detect nonsense mutations, in accordance with one embodiment of the present invention.

FIG. 14 illustrates the results of a QTL analysis in a region of mouse chromosome 11 for the phenotypic traits “free fatty acid” (curve 1402) and “triglyceride level” (curve 1404), in accordance with one embodiment of the present invention.

FIG. 15 illustrates expression QTL (“eQTL”) from several genes that are known to be involved with glucose and lipid metabolism which overlap with the “free fatty acid” and “triglyceride level” clinical trait QTL (“cQTL”) on chromosome 11, in accordance with one embodiment of the present invention.

FIG. 16 shows a scatter plot that breaks down the mean log ratios for the mouse peroxisome proliferator activated receptor (PPAR) binding protein by mouse genotype at the chromosome 11 location across the F2 mouse population (120 F2 mouse livers) that was profiled in accordance with one embodiment of the present invention.

FIG. 17 shows a scatter plot that breaks down the mean log ratios for the mouse PPAR binding protein by mouse genotype at the chromosome 15 location across the F2 mouse population (1 20 F2 mouse livers) that was profiled in accordance with one embodiment of the present invention.

FIG. 18 is a plot that illustrates how genes -known to be involved in lipid metabolism are linked by eQTL analysis to the same genetic locus, even though they physically reside at different unlinked locations.

FIG. 19 illustrates processing steps for associating a gene G in the genome of a species with a clinical trait T that is exhibited by one or more organisms in a plurality of organisms of the species, in accordance with an embodiment of the present invention.

FIG. 20 illustrates clinical quantitative trait loci (cQTL) for four mouse obesity-related traits that co-localize with the expression QTL (eQTL) for four genes at a QTL hot spot on mouse chromosome 2, in accordance with an embodiment of the present invention.

FIG. 21 illustrates a plurality of phenotypic statistics sets, in accordance with an embodiment of the present invention.

FIG. 22 illustrates computing modules in accordance with an embodiment of the present invention.

FIG. 23 illustrates the hierarchical clustering of 123 genes that are linked to a particular chromosome 2 locus or are highly correlated with genes that are linked to this locus (x-axis), against the hierarchical clustering of F2 mice in the highest and lowest quartile for the phenotype “subcutaneous fat pad mass” (y-axis), in accordance with one embodiment of the present invention.

FIG. 24 illustrates a hypothetical example in which a biological pathway that affects the trait obesity is deduced, in accordance with one embodiment of the present invention.

FIG. 25 illustrates a target validation strategy in accordance with one embodiment of the present invention.

FIG. 26 illustrates processing steps for subdividing a disease population P into n subgroups in accordance with a preferred embodiment of the present invention.

FIG. 27 illustrates a data structure that comprises that data used to identify cellular constituents that discriminate a trait under study.

FIG. 28 illustrates the classification of a trait of interests into subtraits in accordance with one embodiment of the present invention.

Like reference numerals refer to corresponding parts throughout the several views of the drawings.

### 5. DETAILED DESCRIPTION

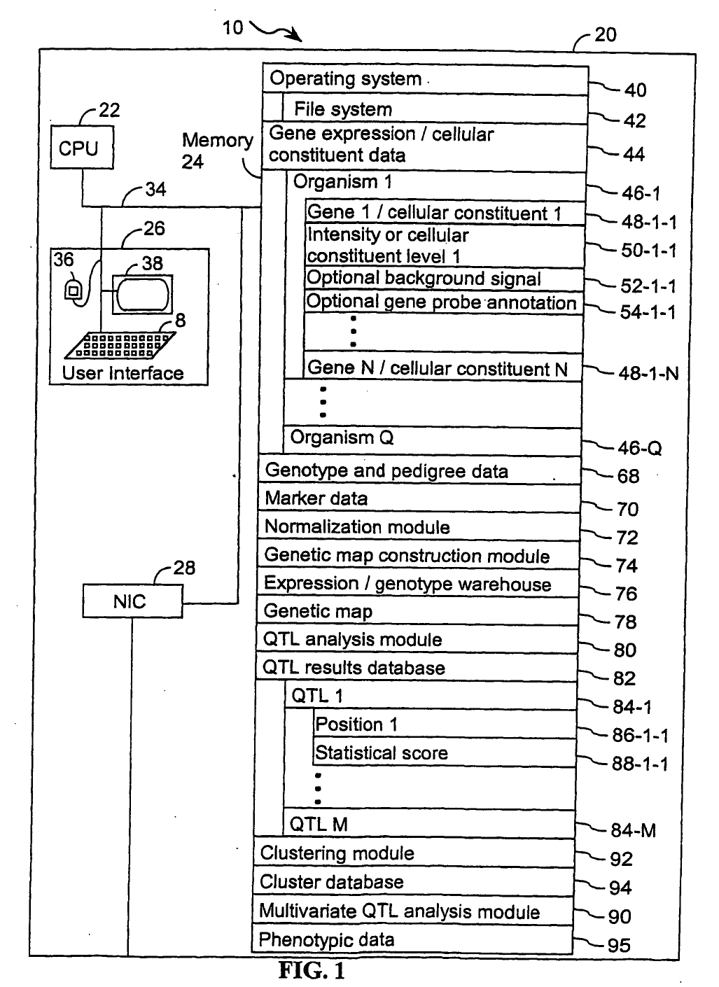

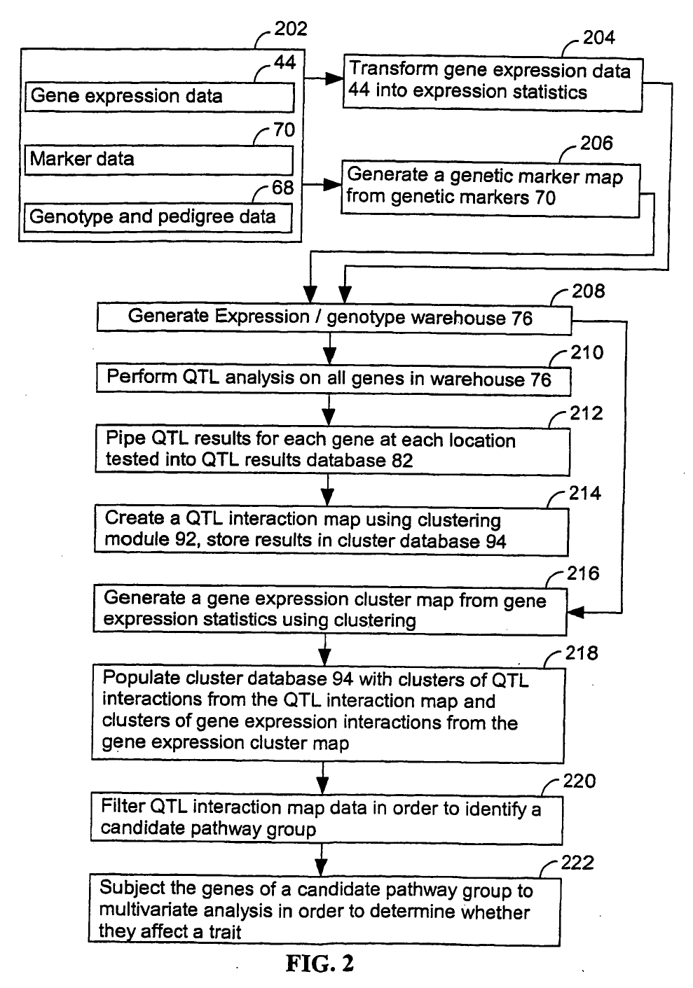

The present invention provides an apparatus and method for associating a gene with a trait exhibited by one or more organisms in a plurality of organisms of a single species. Exemplary organisms include, but are not limited to, plants and animals. In specific embodiments, exemplary organisms include, but are not limited to plants such as corn, beans, rice, tobacco, potatoes, tomatoes, cucumbers, apple trees, orange trees, cabbage, lettuce, and wheat. In specific embodiments, exemplary organisms include, but are not limited to animals such as mammals, primates, humans, mice, rats, dogs, cats, chickens, horses, cows, pigs, and monkeys. In yet other specific embodiments, organisms include, but are not limited to, Drosophila, yeast, viruses, and C. elegans. In some instances, the gene is associated with the trait by identifying a biological pathway in which the gene product participates. In some embodiments of the present invention, the trait of interest is a complex trait such as a human disease. Exemplary human diseases include, but are not limited to, diabetes, obesity, cancer, asthma, schizophrenia, arthritis, multiple sclerosis, and rheumatosis. In some embodiments, the trait of interest is a preclinical indicator of disease, such as, but not limited to, high blood pressure, abnormal triglyceride levels, abnormal cholesterol levels, or abnormal high-density lipoprotein/low-density lipoprotein levels. In a specific embodiment of the present invention, the trait is low resistance to an infection by a particular insect or pathogen. Additional exemplary diseases are found in Section 5.12, infra. In the invention, the expression level measurement of each gene in each of a plurality of organisms is transformed into a corresponding expression statistic. An “expression level measurement” of a gene can be, for example, a measurement of the level of its encoded RNA (or cDNA) or proteins or activity levels of encoded proteins. In some embodiments, this transformation is a normalization routine in which raw gene expression data is normalized to yield a mean log ratio, a log intensity, and a background-corrected intensity. Further, a genetic map 78 (FIG. 1) is constructed from a set of genetic markers associated with the plurality of organisms. Then, for each gene G in a plurality of genes expressed by an organism in the population, a quantitative trait locus (QTL) analysis is performed using the genetic map in order to produce QTL data A set of expression statistics represents the quantitative trait used in each QTL analysis. QTL analyses are explained in greater detail, infra, in conjunction with FIG. 2, element 210. This set of expression statistics, for any given gene G, comprises an expression statistic for gene G, for each organism in the plurality of organisms. Next, the QTL data obtained from each QTL analysis is clustered to form a QTL interaction map. Identification of tightly clustered QTLs in the QTL interaction map helps to identify genes that are genetically interacting. This information, in turn, helps to elucidate biological pathways that are affected by complex traits, such as human disease. In some embodiments of the present invention, tightly clustered QTLs in the QTL interaction map are considered candidate pathway groups. These candidate pathway groups are subjected to multivariate analysis in order to verify whether the genes in the candidate pathway group affect a particular trait.

One embodiment of the present invention provides a method for associating a gene with a trait exhibited by one or more organisms in a plurality of organisms of a single species. In the method, quantitative trait locus data from a plurality of quantitative trait locus analyses are clustered to form a quantitative trait locus interaction map. Each quantitative trait locus analysis in the plurality of quantitative trait locus analyses are performed for a gene G in a plurality of genes in the genome of the plurality of organisms using a genetic map and a quantitative trait in order to produce the quantitative trait locus data. For each quantitative trait locus analysis, the quantitative trait comprises an expression statistic for the gene G for which the quantitative trait locus analysis has been performed, for each organism in the plurality of organisms. The genetic map is constructed from a set of genetic markers associated with the plurality of organisms. Further, in the method, the quantitative trait locus interaction map is analyzed to identify a gene associated with a trait, thereby associating the gene with the trait exhibited by one or more organisms in the plurality of organisms.

### 5.1. Overview of the Invention

FIG. 1 illustrates a system 10 that is operated in accordance with one embodiment of the present invention. In addition, FIG. 2 illustrates the processing steps that are performed in accordance with one embodiment of the present invention. These figures will be referenced in this section in order to disclose the advantages and features of the present invention. System 10 comprises at least one computer 20 (FIG. 1). Computer 20 comprises standard components including a central processing unit 22, memory 24 (including high speed random access memory as well as non-volatile storage, such as disk storage) for storing program modules and data structures, user input/output device 26, a network interface 28 for coupling server 20 to other computers via a communication network (not shown), and one or more busses 34 that interconnect these components. User input/output device 26 comprises one or more user input/output components such as a mouse 36, display 38, and keyboard 8.

Memory 24 comprises a number of modules and data structures that are used in accordance with the present invention. It will be appreciated that, at any one time during operation of the system, a portion of the modules and/or data structures stored in memory 24 is stored in random access memory while another portion of the modules and/or data structures is stored in non-volatile storage. In a typical embodiment, memory 24 comprises an operating system 40. Operating system 40 comprises procedures for handling various basic system services and for performing hardware dependent tasks. Memory 24 further comprises a file system 42 for file management. In some embodiments, file system 42 is a component of operating system 40.

The present invention begins with gene expression data 44 (e.g. from a gene expression study or a proteomics study) and a genotype and pedigree data 68 from an experimental cross or human cohort under study (FIG. 1; FIG. 2, step 202). In one embodiment, gene expression data 44 consists of the processed microarray images for each individual (organism) 46 in a population under study. In some embodiments, such data comprises, for each individual 46, intensity information 50 for each gene 48 represented on the array, background signal information 52, and associated annotation information 54 describing the gene probe (FIG. 1). In some embodiments, gene expression data 44 is, in fact, protein levels for various proteins in the organisms 46 under study.

In one aspect of the present invention, the expression level of a gene G in an organism in the population of interest is determined by measuring an amount of at least one cellular constituent that corresponds to the gene G in one or more cells of the organism. As used herein, the term “cellular constituent” comprises individual genes, proteins, mRNA expressing a gene, RNA, and/or any other variable cellular component or protein activity, degree of protein modification (e.g., phosphorylation), for example, that is typically measured in a biological experiment by those skilled in the art. In some embodiments, a cellular constituent corresponds to a gene G when the cellular constituent is encoded by the gene. For example, an mRNA or a protein can be encoded by a gene G. In some embodiments, a cellular constituent corresponds to a gene G if the abundance of the cellular constituent is determined by a level of expression of the gene. In some embodiments, the expression level of a gene G is determined by a degree of modification of a cellular constituent that corresponds to the gene. Such a degree of modification can be, for example, an amount of phosphorylation of the cellular constituent. In one embodiment, the amount of the at least one cellular constituent that is measured comprises abundances of at least one RNA species present in one or more cells. Such abundances can be measured by a method comprising contacting a gene transcript array with RNA from one or more cells of the organism, or with cDNA derived therefrom. A gene transcript array comprises a surface with attached nucleic acids or nucleic acid mimics. The nucleic acids or nucleic acid mimics are capable of hybridizing with the RNA species or with cDNA derived from the RNA species. In some embodiments, gene expression data 44 is taken from tissues that have been associated with the trait under study. For example, in one nonlimiting embodiment where the complex trait under study is human obesity, gene expression data is taken from the liver, brain, or adipose tissues.

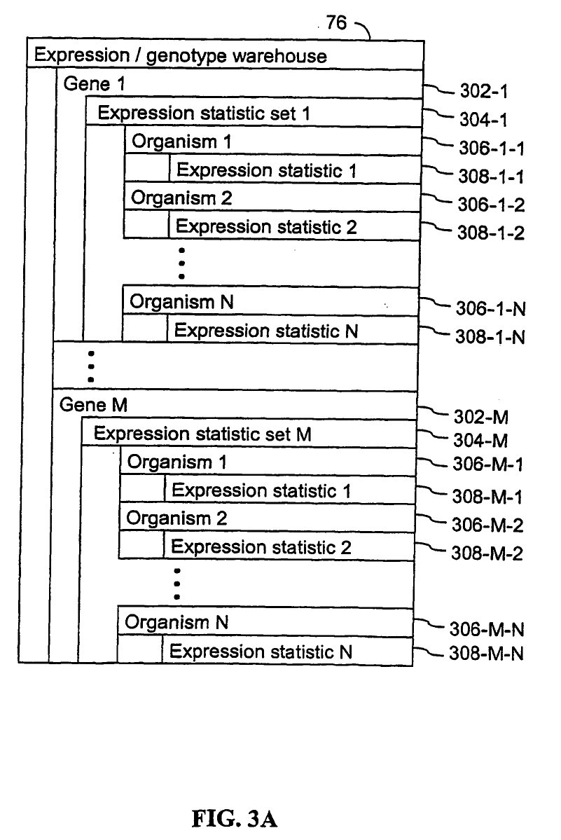

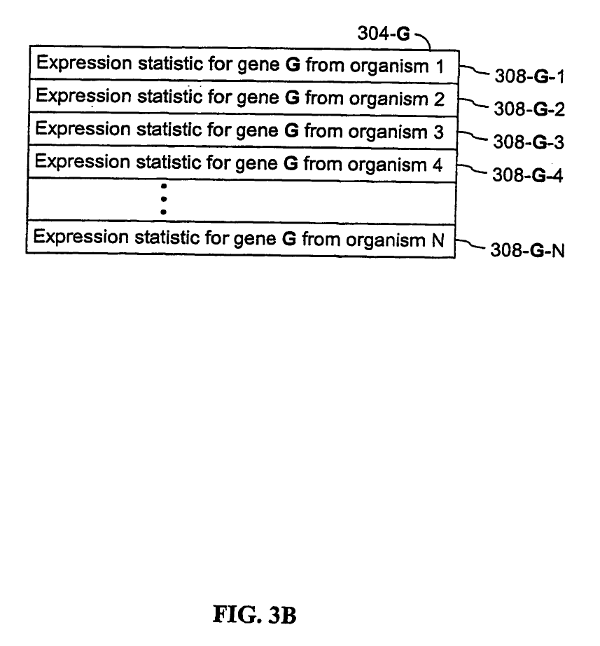

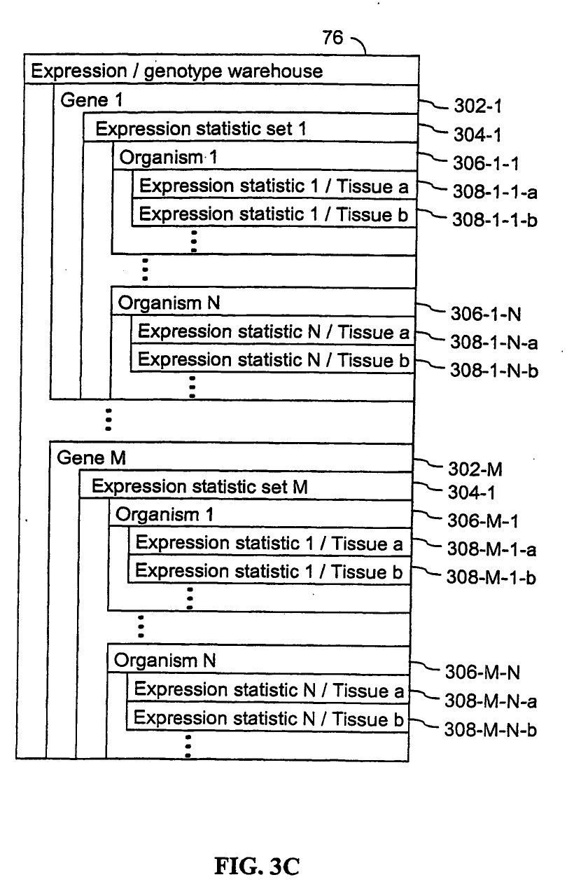

In some embodiments of the present invention, gene expression/cellular constituent data 44 is measured from multiple tissues of each organism 46 (FIG. 1) under study. For example, in some embodiments, gene expression/cellular constituent data 44 is collected from one or more tissues selected from the group of liver, brain, heart, skeletal muscle, white adipose from one or more locations, and blood. In such embodiments, the data is stored in an exemplary data structure such as that disclosed in FIG. 3C. This data structure is described in more detail below.

Genotype and/or pedigree data 68 (FIG. 1) comprise the actual alleles for each genetic marker typed in each individual under study, in addition to the relationships between these individuals. The extent of the relationships between the individuals under study may be as simple as an F2 population or as complicated as extended human family pedigrees. Exemplary sources of genotype and pedigree data are described in Section 6.1, infra. In some embodiments of the present invention, pedigree data is optional.

Marker data 70 at regular intervals across the genome under study or in gene regions of interest is used to monitor segregation or detect associations in a population of interest Marker data 70 comprises those markers that will be used in the population under study to assess genotypes. In one embodiment, marker data 70 comprises the names of the markers, the type of markers the physical and genetic location of the markers in the genomic sequence. Exemplary types of markers include, but are not limited to, restriction fragment length polymorphisms “RFLPs”, random amplified polymorphic DNA “RAPDs”, amplified fragment length polymorphisms “AFLPs”, simple sequence repeats “SSRs”, single nucleotide polymorphisms “SNPs”, microsatellites, etc.). Further, marker data 70 comprises the different alleles associated with each marker. For example, a particular microsatellite marker consisting of ‘CA’ repeats may have represented ten different alleles in the population under study, with each of the ten different alleles in turn consisting of some number of repeats. Representative marker data 70 in accordance with one embodiment of the present invention is found in Section 5.2, infra. In one embodiment of the present invention, the genetic markers used comprise single nucleotide polymorphisms (SNPs), microsatellite markers, restriction fragment length polymorphisms, short tandem repeats, DNA methylation markers, and/or sequence length polymorphisms.

Once starting data are assembled, the first step (FIG. 2, step 204) is to transform gene expression data 44 into expression statistics that are used to treat each cellular constituent abundance in gene expression data 44 as a quantitative trait. In some embodiments, gene expression data 44 (FIG. 1) comprises gene expression data for a plurality of genes or cellular constituents that correspond to the plurality of genes. In one embodiment, the plurality of genes comprises at least five genes. In another embodiment, the plurality of genes comprises at least one hundred genes, at least one thousand genes, at least twenty thousand genes, or more than thirty thousand genes. The expression statistics commonly used as quantitative traits in the analyses in one embodiment of the present invention include, but are not limited to the mean log ratio, log intensity, and background-corrected intensity. In other embodiments, other types of expression statistics are used as quantitative traits. In one embodiment, this transformation (FIG. 2, step 204) is performed using normalization module 72 (FIG. 1). In such embodiments, the expression level of a plurality of genes in each organism under study are normalized. Any normalization routine may be used by normalization module 72. Representative normalization routines include, but are not limited to, Z-score of intensity, median intensity, log median intensity, Z-score standard deviation log of intensity, Z-score mean absolute deviation of log intensity calibration DNA gene set, user normalization gene set, ratio median intensity correction, and intensity background correction. Furthermore, combinations of normalization routines may be run. Exemplary normalization routines in accordance with the present invention are disclosed in more detail in Section 5.3, infra. The expression statistics formed from the transformation are then stored in Expression/genotype warehouse 76, where they are ultimately matched with the corresponding genotype information.

In addition to the generation of expression statistics from gene expression data 44, a genetic map 78 is generated from genetic markers 70 (FIG. 1; FIG. 2, step 206) and pedigree data 68. In one embodiment of the present invention, a genetic map is created using genetic map construction module 74 (FIG. 1). Further, in one embodiment, genotype probability distributions for the individuals under study are computed. Genotype probability distributions take into account information such as marker information of parents, known genetic distances between markers, and estimated genetic distances between the markers. Computation of genotype probability distributions generally requires pedigree data. In some embodiments of the present invention, pedigree data is not provided and genotype probability distributions are not computed.

Once the expression data has been transformed into corresponding expression statistics and genetic map 78 has been constructed, the data is transformed into a structure that associates all marker, genotype and expression data for input into QTL analysis software. This structure is stored in expression/genotype warehouse 76 (FIG. 1; FIG. 2, step 208).

A quantitative trait locus (QTL) analysis is performed using data corresponding to each gene in a plurality of genes as a quantitative trait (FIG. 2, step 210). For 20,000 genes, this results in 20,000 separate QTL analyses. For embodiments in which multiple tissues samples are collected for each organism, this results in even more separate QTL analysis. For example, in embodiments in which samples are collected from two different tissues, an analysis of 20,000 genes requires 40,000 separate QTL analyses. In one embodiment, each QTL analysis is performed by QTL analysis module 80 (FIG. 1). In one example, each QTL analysis steps through each chromosome in the genome of the organism of interest Linkages to the gene under consideration are tested at each step or location along the length of the chromosome. In such embodiments, each step or location along the length of the chromosome is at regularly defined intervals. In some embodiments, these regularly defined intervals are defined in Morgans or, more typically, centiMorgans (cM). A Morgan is a unit that expresses the genetic distance between markers on a chromosome. A Morgan is defined as the distance on a chromosome in which one recombinational event is expected to occur per gamete per generation. In some embodiments, each regularly defined interval is less than 100 cM. In other embodiments, each regularly defined interval is less than 10 cM, less than 5 cM, or less than 2.5 cM.

In each QTL analysis, data corresponding to a gene selected from a plurality of genes under study is used as a quantitative trait. More specifically, for any given gene, the quantitative trait used in the QTL analysis is an expression statistic set such as set 304 (FIG. 3A). Expression statistic set 304 comprises the corresponding expression statistic 308 for the gene 302 from each organism 306 in the population under study. FIG. 3B illustrates an exemplary expression statistic set 304 in accordance with one embodiment of the present invention Exemplary expression statistic set 304 includes the expression level 308 of a gene G (or cellular constituent that corresponds to gene G) from each organism in a plurality of organisms. For example, consider the case where there are ten organisms in the plurality of organisms, and each of the ten organisms expresses gene G. In this case, expression statistic set 304 includes ten entries, each entry corresponding to a different one of the ten organisms in the plurality of organisms. Further, each entry represents the expression level of gene G in the organism represented by the entry. So, entry “1” (308-G-1) corresponds to the expression level of gene G in organism 1, entry “2” (308-G-2) corresponds to the expression level of gene G in organism 2, and so forth.

Referring to FIG. 3C, in some embodiments of the present invention, expression data from multiple tissue samples of each organism 306 (FIG. 1, 46) under study are collected. When this is the case, the data can be stored in the exemplary data structure illustrated in FIG. 3C. In FIG. 3C, a plurality of genes 302 are represented. Further, there is an expression statistic set 304 for each gene 302. Each expression statistic set 304 represents the expression level (308) of the gene or an abundance of a cellular constituent (308) that corresponds to the gene in each of a plurality of organisms 306 (FIG. 1, 46). In one example, a cellular constituent is a particular protein and the cellular constituent corresponds to a gene when the gene codes for the cellular constituent.

In one embodiment of the present invention, each QTL analysis (FIG. 2, step 210) comprises: (i) testing for linkage between a position in a chromosome and the quantitative trait used in the quantitative trait locus (QTL) analysis, (ii) advancing the position in the chromosome by an amount, and (iii) repeating steps (i) and (ii) until the end of the chromosome is reached. In typical embodiments, the quantitative trait is the expression statistic set 304, such as the set illustrated in FIG. 3B. In some embodiments, testing for linkage between a given position in the chromosome and the expression statistic set 304 comprises correlating differences in the expression levels found in the expression level statistic with differences in the genotype at the given position using single marker tests (for example using t-tests, analysis of variance, or simple linear regression statistics). See, e.g., Statistical Methods, Snedecor and Cochran, 1985, Iowa State University Press, Ames, Iowa. However, there are many other methods for testing for linkage between expression statistic set 304 and a given position in the chromosome. In particular, if expression statistic set 304 is treated as the phenotype (in this case, a quantitative phenotype), then methods such as those disclosed in Doerge, 2002, Mapping and analysis of quantitative trait loci in experimental populations, Nature Reviews: Genetics 3:43-62, may be used. Concerning steps (i) through (iii) above, if the genetic length of a given chromosome is N cM and 1 cM steps are used, then N different tests for linkage are performed on the given chromosome. For organisms having multiple chromosomes, this process is repeated for each chromosome in the genome.

In some embodiments, the QTL data produced from each respective QTL analysis comprises a logarithm of the odds score (lod) computed at each position tested in the genome under study. A lod score is a statistical estimate of whether two loci are likely to lie near each other on a chromosome and are therefore likely to be genetically linked. In the present case, a lod score is a statistical estimate of whether a given position in the genome under study is linked to the quantitative trait corresponding to a given gene. Lod scores are further defined in Section 5.4, infra. A lod score of three or more is generally taken to indicate that two loci are genetically linked. The generation of lod scores requires pedigree data Accordingly, in embodiments in which a lod score is generated, processing step 210 is essentially a linkage analysis, as described in Section 5.13, with the exception that the quantitative trait under study is derived from data, such as cellular constituent expression statistics, rather than classical phenotypes such as eye color.

In situations where pedigree data is not available, genotype data from each of the organisms 46 (FIG. 1) for each marker in genetic map 78 may be compared to each quantitative trait (expression statistic set 304) using allelic association analysis, as described in Section 5.14, infra, in order to identify QTL that are linked to each expression statistic set 304. In one form of association analysis, an affected population is compared to a control population. In particular, haplotype or allelic frequencies in the affected population are compared to haplotype or allelic frequencies in a control population in order to determine whether particular haplotypes or alleles occur at significantly higher frequency amongst affected compared with control samples. Statistical tests such as a chi-square test are used to determine whether there are differences in allele or genotype distributions.

Regardless of whether linkage analysis or association analysis is used in step 210, the results of each QTL analysis are stored in QTL results database 82 (FIG. 1; FIG. 2, step 212). For each quantitative trait 84 (expression statistic set 304), QTL results database 82 comprises all positions 86 in the genome of the organism that were tested for linkage to the quantitative trait 84. Positions 86 are obtained from genetic map 70. Further, for each position 86, genotype data 68 provides the genotype at position 86, for each organism in the plurality of organisms under study. For each such position 86 analyzed by QTL analysis, a statistical measure (e.g., statistical score 88), such as the maximum lod score between the position and the quantitative trait 84, is listed. Thus, data structure 82 comprises all the positions in the genome of the organism of interest that are genetically inked to each quantitative trait 84 tested.

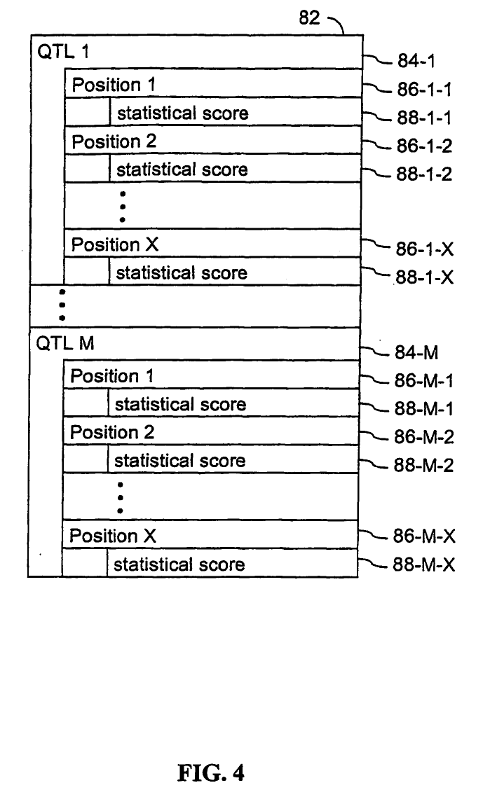

FIG. 4 provides a more detailed illustration of QTL results database 82. Each statistical score 88 (e.g. lod score) measures the degree to which a given position 86 is linked to the corresponding quantitative trait 84. The set of statistical scores 88 for any given quantitative trait 84 may be considered (may be viewed as) a QTL vector. Thus, in some embodiments of the present invention, a QTL vector is created for each gene tested in the chromosome of the organism studied. In some embodiments in which gene expression/cellular constituent data 44 is collected from multiple tissue samples in each organism under study, a separate QTL vector is created for each tissue type from which data 44 was collected. For example, consider the case in which data 44 (FIG. 1) is collected from two different tissues types from each organism 46 under study. In such embodiments, two QTL vectors are created for each cellular constituent (e.g., gene, protein) 48 tested. The first QTL vector for a given gene/cellular constituent 48 corresponds to one tissue type sample and the second QTL vector for the given gene/cellular constituent 48 corresponds to the second tissue type sampled. Thus, in effect, in some embodiments in which data from multiple tissues is collected, the data from each tissue type is treated for purposes of processing steps 202 through 220 as if the data were collected from independent organism. However, in step 222, the data from multiple tissues types is optionally compared in order to determine the affect that tissue type has on the linkage analysis. Methods that incorporated data from multiple tissues types are described in more detail in conjunction with step 222 below as well as Section 5.6, below.

In some embodiments, a QTL vector is created for each gene tested in the entire genome of the organism studied. The QTL vector comprises the statistical score at each position tested by the quantitative trait locus (QTL) analysis corresponding to the gene. In addition to QTL vectors, gene expression vectors may be constructed from transformed gene expression data 44. Each gene expression vector represents the transformed expression level of the gene from each organism in the population of interest. Thus, any given gene expression vector comprises the transformed expression level of the gene from a plurality of different organisms in the population of interest.

With the QTL vectors generated, the next step of the present invention involves the generation of QTL interaction maps from the QTL vectors (FIG. 2, step 214). To generate QTL interaction maps, the QTL vectors are clustered into groups of QTLs based on the strength of interaction between the QTL vectors. In some embodiments of the present invention, QTL interaction maps are generated by clustering module 92. In embodiments in which QTL vectors are generated from several different tissue types, only QTL representing the same tissue type are clustered. In some requirements, QTL representing diverse tissues types are clustered. In one embodiment of the present invention, agglomerative hierarchical clustering is applied to the QTL vectors. In this clustering, similarity is determined using Pearson correlation coefficients between the QTL vectors pairs. In other embodiments, the clustering of the QT-L data from each QTL analysis comprises application of a hierarchical clustering technique, application of a k-means technique, application of a fizzy k-means technique, application of Jarvis-Patrick clustering technique, application of a self-organizing map or application of a neural network. In some embodiments, the hierarchical clustering technique is an agglomerative clustering procedure. In other embodiments, the agglomerative clustering procedure is a nearest-neighbor algorithm, a farthest-neighbor algorithm, an average linkage algorithm, a centroid algorithm, or a sum-of-squares algorithm. In still other embodiments, the hierarchical clustering technique is a divisive clustering procedure. Illustrative clustering techniques that may be used to cluster QTL vectors are described in Section 5.5, infra.

Since each QTL corresponds to a given gene in a plurality of genes in the population of interest, QTL interaction maps provide information on which QTLs are linked. Such information may be combined with gene expression data to help elucidate biological pathways that affect complex traits. In one embodiment of the present invention, a gene expression cluster map is constructed from gene expression statistics (FIG. 2, step 216). A plurality of gene expression vectors are created. Each gene expression vector in the plurality of gene expression vectors represents the expression level, activity, or degree of modification of a particular cellular constituent, such as a gene or gene product, in a plurality of cellular constituents in the population of interest. Then, a plurality of correlation coefficients is computed. Each correlation coefficient in the plurality of correlation coefficients is computed between a gene expression vector pair in the plurality of gene expression vectors. Then, the plurality of gene expression vectors are clustered based on the plurality of correlation coefficients in order to form the gene expression cluster map. In one embodiment of the present invention, each correlation coefficient in the plurality of correlation coefficients is a Pearson correlation coefficient. In another embodiment of the present invention, clustering of the plurality of gene expression vectors comprises application of a hierarchical clustering technique, application of a k-means technique, application of a fuzzy k-means technique, application of a self-organizing map or application of a neural network In one embodiment of the present invention, the hierarchical clustering technique is an agglomerative clustering procedure such as a nearest-neighbor algorithm, a farthest-neighbor algorithm, an average linkage algorithm, a centroid algorithm, or a sum of squares algorithm. In another embodiment of the invention, the hierarchical clustering technique is a divisive clustering procedure. Illustrative clustering techniques that may be used to cluster the gene expression vectors are described in Section 5.5, infra.

At this stage, the QTL interaction map provides information on individual genes in gene expression clusters found in gene expression cluster maps. Gene expression clusters found in gene expression cluster maps may be considered to be in the same candidate pathway group. QTL interactions can be used to identify those genes that are “closer” together in a candidate pathway group than other genes. Furthermore, genes in -gene expression clusters found in a gene expression map that are not at all genetically interacting may be down-weighted with respect to those genes that are genetically interacting. In this way, QTL interaction maps help to refine candidate pathway groups that are identified in gene expression cluster maps. However, the QTL interaction map does not provide the actual topology of the pathway. An illustrative topology of a biological pathway may be, for example, that gene A is upstream of gene B. Another drawback of the QTL interaction map is that the map may include false positives. For example, a cluster within the QTL interaction map may include a genes that do not interact genetically. To shed light on the topology of biological pathways associated with complex diseases, as well as to eliminate false positive genes, processing steps 216 through 222 are performed, as described in detail below.

In one embodiment of the present invention, the next step involves mapping all probes used to generate gene expression data 44 (FIG. 1) to their respective genomic and genetic coordinates. This information aids in establishing the potential for a given gene to correspond directly to a particular QTL (i.e., that a gene actually was the QTL).

In one embodiment of the present invention, clusters of QTL interactions from the QTL interaction maps and clusters of gene expression interactions from the gene expression cluster maps are represented in cluster database 94 (FIG. 1; FIG. 2, step 218). Cluster database 94 is used to identify the patterns that feed a multivariate QTL analyses. In addition to the QTL and gene expression cluster information, the physical locations of the QTLs and genes are represented in cluster database 94.

In some embodiments of the present invention, a gene is identified in the QTL interaction map by filtering the QTL interaction map in order to obtain a candidate pathway group. In one embodiment, this filtering comprises selecting those QTL for the candidate pathway group that interact most strongly with another QTL in the QTL interaction map. In some embodiments, the QTL that interact most strongly with another QTL in the QTL interaction map are all QTL, represented in the QTL interaction map, that share a correlation coefficient with another QTL in the QTL interaction map that is higher than 75%, 85%, or 95% of all correlation coefficients computed between QTLs in the QTL interaction map.

In one embodiment of the present invention, cluster database 94 is used to associate a gene with a trait. Typically, the trait of interest is a complex trait. Representative traits include, but are not limited to, disease status, tumor stage, triglyceride levels, blood pressure, and/or diagnostic test results. In this embodiment, the QTL interaction map and/or data stored in cluster database 94 is filtered in order to obtain a candidate pathway group (FIG. 2, step 220). This filtering comprises identifying a QTL in the candidate pathway group in the gene expression cluster map. In one example in accordance with this embodiment of the present invention, the QTL interaction map is filtered by identifying groups of QTL within the QTL interaction map that interact closely with one another. The genes associated with each QTL in the groups of QTL that interact closely with one another in a QTL interaction map are considered candidate pathway groups. In some embodiments, the filtering further comprises looking up the genes in each of the candidate pathway groups in the gene expression interaction map. Of interest is whether the genes in the candidate pathway groups identified in the QTL interaction map interact closely with each other in the gene expression interaction map. In some embodiments, the topology of pathway groups (e.g., biological pathways) can be determined by identifying genes that colocalize with one of their QTL, as described in Section 6.7.1, infra.

In general, patterns of interest may be identified by querying cluster database 94. Such groups may be identified by filtering on strength of QTL-QTL interactions, which identifies those genes that are most strongly genetically interacting, and then combining this information with genes that are the most tightly clustered within these groups. The size of these groups is easily adjusted by scaling the threshold parameters used to ident QTL and/or genes that are interacting. Such groups could themselves be considered putative pathway groups. However, another approach is to fit the groups to genetic models in order to test whether the genes are actually part of the same pathway.

In one embodiment in accordance with the present invention, the degree to which each QTL making up a candidate pathway group belongs with other QTLs within the candidate pathway group is tested by fitting a multivariate statistical model to the candidate pathway group (FIG. 2; step 222). Multivariate statistical models have the capability to simultaneously consider multiple quantitative traits simultaneously, model epistatic interactions between the QTL and test other interesting variations that test whether genes in a candidate pathway group belong to the same or related biological pathway. Specific tests can be done to determine if the traits under consideration are actually controlled by the same QTL (pleiotropic effects) or if they are independent.

Importantly, multivariate statistical analysis can be used to simultaneously consider multiple traits at the same time. This is of use to determine whether the traits are genetically linked to each other. Accordingly, in such embodiments, a cluster of QTL found in the QTL interaction map produced in step 214 and verified using the gene expression cluster map produced in step 216 can be subjected to multivariate statistical analysis in order to determine whether the QTL are all genetically linked. Such an analysis may determine that some of the QTL in the cluster found in the QTL interaction map are, in fact, linked whereas other QTL in the cluster are not linked.

Multivariate statistical analysis can also be used to study the same trait from multiple tissues. Multivariate statistical analysis of the same trait from multiple tissues can be used to determine whether genetic linkage varies on a tissue specific basis. Such techniques are of use, for example, in instances where a complex disease has a tissue specific etiology. In some instance, multivariate analysis can be used to simultaneously consider multiple traits from multiple tissues. Exemplary multivariate statistical models that may be used in accordance with the present invention are found in Section 5.6, infra.

The results of the multivariate QTL analysis are used to “validate” the candidate pathway groups. These validated groups are then represented in a database and made available for the final stage of analysis, which involves reconstructing the pathway. At this stage the database comprises genes that are under some kind of common genetic control, interact to some degree at the expression level, and that have been shown to be strongly enough interacting at these different levels to perhaps belong to the same or related pathways. Thus, in some instance, the association of a gene with a trait exhibited by one or more organisms in a population of interest results in the placement of the gene in a pathway group that comprises genes that are part of the same or related pathway.

The final step involves an attempt to partially reconstruct the pathways within a given pathway group. For each candidate pathway group, the interactions between the representative QTL vectors and gene expression vectors can be examined. Furthermore, QTL and probe location information can be used to begin to piece together causal pathways. In addition, graphical models can be fit to the data using the interaction strengths, QTL overlap and physical location information accumulated from the previous steps to weight and direct the edges that link genes in a candidate pathway group. Application of such graphical models is used to determine which genes are more closely linked in a candidate pathway group and therefore suggests models for constraining the topology of the pathway. Thus, such models test whether it is more likely that the candidate pathway proceeds in a particular direction, given the evidence provided by the interactions, QTL overlaps, and physical QTL/probe location. The end result of this process, after starting with expression data, genotype data, marker data, and clinical trait data, is a set of pathway groups consisting of genes that are supported as being part of the same or related pathway, and causal information that indicates the exact relationship of genes in the pathway (or of a partial set of genes in the pathway).

### 5.2. Sources of Marker Data

Several forms of genetic markers that are used to construct a marker map are known in the art. A common genetic marker is single nucleotide polymorphisms (SNPs). SNPs occur approximately once every 600 base pairs in the genome. See, for example, Kruglyak and Nickerson, 2001, Nature Genetics 27, 235. The present invention contemplates the use of genotypic databases such as SNP databases as a source of genetic markers. Alleles making up blocks of such SNPs in close physical proximity are often correlated, resulting in reduced genetic variability and defining a limited number of “SNP haplotypes” each of which reflects descent from a single ancient ancestral chromosome. See Fullerton et al., 2000, Am. J. Hum. Genet. 67, 881. Such haplotype structure is useful in selecting appropriate genetic variants for analysis. Patil et al. found that a very dense set of SNPs is required to capture all the common haplotype information. Once common haplotype information is available, it can be used to identify much smaller subsets of SNPs useful for comprehensive whole-genome studies. See Patil et al., 2001, Science 294, 1719-1723.

Other suitable sources of genetic markers include databases that have various types of gene expression data from platform types such as spotted microarray (microarray), high-density oligonucleotide array (HDA), hybridization filter (filter) and serial analysis of gene expression (SAGE) data. Another example of a genetic database that can be used is a DNA methylation database. For details on a representative DNA ethylation database, see Grunau et al., in press, MethDB—a public database for DNA methylation data, Nucleic Acids Research; or the URL: http://genome.imb-jena.de/public.html.

In one embodiment of the present invention, a set of markers is derived from any type of genetic database that tracks variations in the genome of an organism of interest. Information that is typically represented in such databases is a collection of locus within the genome of the organism of interest. For each locus, strains for which genetic variation information is available are represented. For each represented strain, variation information is provided. Variation information is any type of genetic variation information. Representative genetic variation information includes, but is not limited to, single nucleotide polymorphisms, restriction fragment length polymorphisms, microsatellite markers, restriction fragment length polymorphisms, and short tandem repeats. Therefore, suitable genotypic databases include, but are not limited to:

| Genetic | |
|---|---|
| variation | |
| type | Uniform resource location |
| SNP | http://bioinfo.pal.roche.com/usuka_bioinformatics/cgi- |
| | bin/msnp/msnp.pl |
| SNP | http://snp.cshl.org/ |
| SNP | http://www.ibc.wustl.edu/SNP/ |
| SNP | http://www-genome.wi.mit.edu/SNP/mouse/ |
| SNP | http://www.ncbi.nlm.nih.gov/SNP/ |
| Micro- | http://www.informatics.jax.org/searches/polymorphis |
| satellite | m_form.shtml |
| markers | |
| Restriction | http://www.informatics.jax.org/searches/polymorphis |
| fragment | m_form.shtml |
| length | |
| polymorphisms | |
| Short | http://www.cidr.jhmi.edu/mouse/mmset.html |
| tandem repeats | |
| Sequence | http://mcbio.med.buffalo.edu/mit.html |
| length | |
| polymorphisms | |
| DNA | http://genome.imb-jena.de/public.html |
| methylation | |
| database | |
| Short | Broman et al., 1998, Comprehensive human genetic |
| tandem-repeat | maps: Individual and sex-specific variation in |
| polymorphisms | recombination, American Journal of Human Genetics |
| | 63, 861-869 |
| Micro- | Kong et al., 2002, A high-resolution recombination |
| satellite | map of the human genome, Nat Genet 31, 241-247 |
| markers | |

In addition, the genetic variations used by the methods of the present invention can involve differences in the expression levels of genes rather than actual identified variations in the composition of the genome of the organism of interest. Therefore, genotypic databases within the scope of the present invention include a wide array of expression profile databases such as the one found at the URL: http://www.ncbi.nlm.nih.gov/geo/.

Another form of genetic marker that can be used to provide marker data needed to construct a genetic map 78 is restriction fragment length polymorphisms (RFLPs). RFLPs are the product of allelic differences between DNA restriction fragments caused by nucleotide sequence variability. As is well known to those of skill in the art, RFLPs are typically detected by extraction of genomic DNA and digestion with a restriction endonuclease. Generally, the resulting fragments are separated according to size and hybridized with a probe; single copy probes are preferred. As a result, restriction fragments from homologous chromosomes are revealed. Differences in fragment size among alleles represent an RFLP (see, for example, Helentjaris et al., 1985, Plant Mol. Bio. 5:109-118, and U.S. Pat. No. 5,324,631). Another form of genetic marker that can be used to construct a marker map that is in turn, used to construct a genetic map 78, is random amplified polymorphic DNA (RAPD). The phrase “random amplified polymorphic DNA” or “RAPD” refers to the amplification product of the distance between DNA sequences homologous to a single oligonucleotide primer appearing on different sites on opposite strands of DNA Mutations or rearrangements at or between binding sites will result in polymorphisms as detected by the presence or absence of amplification product (see, for example, Welsh and McClelland, 1990, Nucleic Acids Res. 18:7213-7218; Hu and Quiros, 1991, Plant Cell Rep. 10:505-511 ). Yet another form of marker data that can be used to construct genetic map 78 is amplified fragment length polymorphisms (AFLP). AFLP technology refers to a process that is designed to generate large numbers of randomly distributed molecular markers (see, for example, European Patent Application No. 0534858 A1). Still another form of marker data that can be used to construct a genetic map 78 is “simple sequence repeats” or “SSRs”. SSRs are di-, tri- or tetra-nucleotide tandem repeats within a genome. The repeat region can vary in length between genotypes while the DNA flanking the repeat is conserved such that the same primers will work in a plurality of genotypes. A polymorphism between two genotypes represents repeats of different lengths between the two flanking conserved DNA sequences (see, for example, Akagi et al., 1996, Theor. Appl. Genet. 93, 1071-1077; Bligh et al., 1995, Euphytica 86:83-85; Struss et al., 1998, Theor. Appl. Genet. 97, 308-315; Wu et al., 1993, Mol. Gen. Genet. 241, 225-235; and U.S. Pat. No. 5,075,217). SSR are also known as satellites or microsatellites.

As described above, many genetic markers suitable for use with the present invention are publicly available. Those skilled in the art can also readily prepare suitable markers. For molecular marker methods, see generally, The DNA Revolution by Andrew H. Paterson 1996 (Chapter 2) in: Genome Mapping in Plants (ed. Andrew H. Paterson) by Academic Press/R. G. Landis Company, Austin, Tex., 7-21.

### 5.3. Exemplary Normalization Routines

A number of different normalization protocols may be used by normalization module 72 to normalize gene expression data 44. Some such normalization protocols are described in this section. Typically, the normalization comprises normalizing the expression level measurement of each gene in a plurality of genes that is expressed by an organism in a population of interest Many of the normalization protocols described in this section are used to normalize microarray data. It will be appreciated that there are many other suitable normalization protocols that may be used in accordance with the present invention. All such protocols are within the scope of the present invention. Many of the normalization protocols found in this section are found in publically available software, such as Microarray Explorer (Image Processing Section, Laboratory of Experimental and Computational Biology, National Cancer Institute, Frederick, Md. 21702, USA).

One normalization protocol is Z-score of intensity. In this protocol, raw expression intensities are normalized by the (mean intensity)/(standard deviation) of raw intensities for all spots in a sample. For microarray data, the Z-score of intensity method normalizes each hybridized sample by the mean and standard deviation of the raw intensities for all of the spots in that sample. The mean intensity mnIᵢ and the standard deviation sdIᵢ are computed for the raw intensity of control genes. It is useful for standardizing the mean (to 0.0) and the range of data between hybridized samples to about −3.0 to +3.0. When using the Z-score, the Z differences (Z_{diff}) are computed rather than ratios. The Z-score intensity (Z-scoreᵢⱼ) for intensity Iᵢⱼ for probe i (hybridization probe, protein, or other binding entity) and spot j is computed as:
Z-scoreᵢⱼ=(Iᵢⱼ−mnIᵢ)/sdIᵢ,
and
Zdiffᵢ(x,y)=Z-scoreₓⱼ−Z-score_{yj}

where,

x represents the x channel and y represents the y channel.

Another normalization protocol is the median intensity normalization protocol in which the raw intensities for all spots in each sample are normalized by the median of the raw intensities. For microarray data, the median intensity normalization method normalizes each hybridized sample by the median of the raw intensities of control genes (medianIᵢ) for all of the spots in that sample. Thus, upon normalization by the median intensity normalization method, the raw intensity Iᵢⱼ for probe i and spot j, has the value Imᵢⱼ where,
Imᵢⱼ=(Iᵢⱼ/medianIᵢ).

Another normalization protocol is the log median intensity protocol. In this protocol, raw expression intensities are normalized by the log of the median scaled raw intensities of representative spots for all spots in the sample. For microarray data, the log median intensity method normalizes each hybridized sample by the log of median scaled raw intensities of control genes (medianIᵢ) for all of the spots in that sample. As used herein, control genes are a set of genes that have reproducible accurately measured expression values. The value 1.0 is added to the intensity value to avoid taking the log(0.0) when intensity has zero value. Upon normalization by the median intensity normalization method, the raw intensity Iᵢⱼ for probe i and spot j, has the value Imᵢⱼ where,
Imᵢⱼ=log(1.0+(Iᵢⱼ/medianIᵢ)).

Yet another normalization protocol is the Z-score standard deviation log of intensity protocol. In this protocol, raw expression intensities are normalized by the mean log intensity (mnLIᵢ) and standard deviation log intensity (sdLIᵢ). For microarray data, the mean log intensity and the standard deviation log intensity is computed for the log of raw intensity of control genes. Then, the Z-score intensity Z log Sᵢⱼ for probe i and spot j is:
Z log Sᵢⱼ=(log(Iᵢⱼ)−mnLIᵢ)/sdLIᵢ.

Still another normalization protocol is the Z-score mean absolute deviation of log intensity protocol. In this protocol, raw expression intensities are normalized by the Z-score of the log intensity using the equation (log(intensity)-mean logarithm)/standard deviation logarithm. For microarray data, the Z-score mean absolute deviation of log intensity protocol normalizes each bound sample by the mean and mean absolute deviation of the logs of the raw intensities for all of the spots in the sample. The mean log intensity mnLIᵢ and the mean absolute deviation log intensity madLIᵢ are computed for the log of raw intensity of control genes. Then, the Z-score intensity Z log Aᵢⱼ for probe i and spot j is:
Z log Aᵢⱼ=(log(Iᵢⱼ)−mnLIᵢ)/madLIᵢ.

Another normalization protocol is the user normalization gene set protocol. In this protocol, raw expression intensities are-normalized by the sum of the genes in a user defined gene set in each sample. This method is useful if a subset of genes has been determined to have relatively constant expression across a set of samples. Yet another normalization protocol is the calibration DNA gene set protocol in which each sample is normalized by the sum of calibration DNA genes. As used herein, calibration DNA genes are genes that produce reproducible expression values that are accurately measured. Such genes tend to have the same expression values on each of several different microarrays. The algorithm is the same as user normalization gene set protocol described above, but the set is predefined as the genes flagged as calibration DNA.

Yet another normalization protocol is the ratio median intensity correction protocol. This protocol is useful in embodiments in which a two-color fluorescence labeling and detection scheme is used. (see Section 5.8.1.5.). In the case where the two fluors in a two-color fluorescence labeling and detection scheme are Cy3 and Cy5, measurements are normalized by multiplying the ratio (Cy3/Cy5) by medianCy5/medianCy3 intensities. If background correction is enabled, measurements are normalized by multiplying the ratio (Cy3/Cy5) by (medianCy5-medianBkgdCy5)/(medianCy3-medianBkgdCy3) where medianBkgd means median background levels.

In some embodiments, intensity background correction is used to normalize measurements. The background intensity data from a spot quantification programs may be used to correct spot intensity. Background may be specified as either a global value or on a per-spot basis. If the array images have low background, then intensity background correction may not be necessary.

### 5.4. Logarithm of the Odds Scores

Denoting the joint probability of inheriting all genotypes P(g), and the joint probability of all observed data x (trait and marker species) conditional on genotypes P(x|g), the likelihood L for a set of data is
L=ΣP(g)P(x|g)
where the summation is over all the possible joint genotypes g (trait and marker) for all pedigree members. What is unknown in this likelihood is the-recombination fraction θ, on which P(g) depends.

The recombination fraction θ is the probability that two loci will recombine during meioses. The recombination fraction θ is correlated with the distance between two loci. By definition, the genetic distance is defined to be infinity between the loci on different chromosomes (nonsyntenic loci), and for such unlinked loci, θ=0.5. For linked loci on the same chromosome (syntenic loci), θ<0.5, and the genetic distance is a monotonic function of θ. See, e.g., Ott, 1985, Analysis of Human Genetic Linkage, first edition, Baltimore, Md., John Hopkins University Press. The essence of linkage analysis described in Section 5.13, is to estimate the recombination fraction θ and to test whether θ=0.5. When the position of one locus in the genome is known, genetic linkage can be exploited to obtain an estimate of the chromosomal position of a second locus relative to the first locus. In linkage analysis described in Section 5.2, linkage analysis is used to map the unknown location of genes predisposing to various quantitative phenotypes relative to a large number of marker loci in a genetic map. In the ideal situation, where recombinant and nonrecombinant meioses can be counted unambiguously, θ is estimated by the frequency of recombinant meioses in a large sample of meioses. If two loci are linked, then the number of nonrecombinant meioses N is expected to be larger than the number of recombinant meioses R. The recombination fraction between the new locus and each marker can be estimated as:

$${θ}^{⋒} = \frac{R}{N + R}$$

The likelihood of interest is:
L=ΣP(g|θ)P(x|g)
and inferences are based about a test recombination fraction θ on the likelihood ratio Λ=L(θ)/ L(½) or, equivalently, its logarithm.

Thus, in a typical clinical genetics study, the likelihood of the trait and a single marker is computed over one or more relevant pedigrees. This likelihood function L(θ) is a function of the recombination fraction θ between the trait (e.g., classical trait or quantitative trait) and the marker locus. The standardized log likelihood Z(θ)=log₁₀ [L(θ)/L(½)] is referred to as a lod score. Here, “lod” is an abbreviation for “logarithm of the odds.” A lod score permits visualization of linkage evidence. As a rule of thumb, in human studies, geneticists provisionally accept linkage if
Z(\hat{θ})≧3
at its maximum θ on the interval [0,½], where \hat{θ} represents the maximum θ on the interval. Further, linkage is provisionally rejected at a particular θ if
Z(\hat{θ})≦−2.
However, for complex traits, other rules have been suggested. See, for example, Lander and Kruglyak, 1995, Nature Genetics 11, p. 241.

Acceptance and rejection are treated asymmetrically because, with 22 pairs of human autosomes, it is unlikely that a random marker even falls on the same chromosome as a trait locus. See Lange, 1997, Mathematical and Statistical Methods for Genetic Analysis, Springer-Verlag, New York; Olson, 1999, Tutorial in Biostatistics: Genetic Mapping of Complex Traits, Statistics in Medicine 18, 2961-2981.

When the value of L is large, the null hypothesis of no linkage, L(½), to a marker locus of known location can be rejected, and the relative location of the locus corresponding to the quantitative trait can be estimated by \hat{θ}. Therefore, lod scores provide a method to calculate linkage distances as well as to estimate the probability that two genes (and/or QTLs) are linked.

Those of skill in the art will appreciate that lod score computation is species dependent. For example, methods for computing the lod score in mouse different from that described in this section. However, methods for computing lod scores are known in the art and the method described in this section is only by way of illustration and not by limitation.

### 5.5. Clustering Techniques

The subsections below describe exemplary methods for clustering QTL vectors in order to form QTL interaction maps. The same techniques can be applied to gene expression vectors in order to form gene expression cluster maps. In these techniques, QTL vectors or gene expression vectors are clustered based on the strength of interaction between the QTL vectors or gene expression vectors. More information on clustering techniques can be found in Kaufman and Rousseeuw, 1990, Finding Groups in Data: An Introduction to Cluster Analysis, Wiley, New York, N.Y.; Everitt, 1993, Cluster analysis (3d ed.), Wiley, New York, N.Y.; Backer, 1995, Computer-Assisted Reasoning in Cluster Analysis, Prentice Hall, Upper Saddle River, N.J.; and Duda et al., 2001, Pattern Classification, John Wiley & Sons, New York, N.Y.

### 5.5.1. Hierarchical Clustering Techniques

Hierarchical cluster analysis is a statistical method for finding relatively homogenous clusters of elements based on measured characteristics. Consider a sequence of partitions of n samples into c clusters. The first of these is a partition into n clusters, each cluster containing exactly one sample. The next is a partition into n-1 clusters, the next is a partition into n-2, and so on until the n^{th}, in which all the samples form one cluster. Level k in the sequence of partitions occurs when c=n−k+1. Thus, level one corresponds to n clusters and level n corresponds to one cluster. Given any two samples x and x*, at some level they will be grouped together in the same cluster. If the sequence has the property that whenever two samples are in the same cluster at level k they remain together at all higher levels, then the sequence is said to be a hierarchical clustering. Duda et al., 2001, Pattern Classification, John Wiley & Sons, New York, 2001, 551.

### 5.5.1.1. Agglomerative Clustering

In some embodiments, the hierarchical clustering technique used to cluster gene analysis vectors is an agglomerative clustering procedure. Agglomerative (bottom-up clustering) procedures start with n singleton clusters and form a sequence of partitions by successively merging clusters. The major steps in agglomerative clustering are contained in the following procedure, where c is the desired number of final clusters, Dᵢ and Dⱼ are clusters, xᵢ is a gene analysis vector, and there are n such vectors:

| | |
|---|---|
| 1 | begin initialize c, ĉ [symbol] n, Dᵢ {xᵢ}, i = 1, ..., n |

| | |
|---|---|
| 2 | do ĉ [symbol] ĉ −1 |

| | |
|---|---|
| 3 | find nearest clusters, say, Dᵢ and Dⱼ |
| 4 | merge Dᵢ and Dⱼ |

| | |
|---|---|
| 5 | until c = ĉ |

| | |
|---|---|
| 6 | return c clusters |

| | |
|---|---|
| 7 | end |

In this algorithm, the terminology a←b assigns to variable a the new value b. As described, the procedure terminates when the specified number of clusters has been obtained and returns the clusters as a set of points. A key point in this algorithm is how to measure the distance between two clusters Dᵢ and Dⱼ. The method used to define the distance between clusters Dᵢ and Dⱼ defines the type of agglomerative clustering technique used. Representative techniques include the nearest-neighbor algorithm, farthest-neighbor algorithm, the average linkage algorithm, the centroid algorithm, and the sum-of-squares algorithm.

Nearest-neighbor algorithm. The nearest-neighbor algorithm uses the following equation to measure the distances between clusters:

$$d min ( Di , Dj ) = {min}_{\begin{matrix}x ∈ Di \\ {x}^{′} ∈ Dj\end{matrix}} ‖ x - {x}^{′} ‖ .$$

This algorithm is also known as the minimum algorithm. Furthermore, if the algorithm is terminated when the distance between nearest clusters exceeds an arbitrary threshold, it is called the single-linkage algorithm. Consider the case in which the data points are nodes of a graph, with edges forming a path between the nodes in the same subset Dᵢ. When dmin( ) is used to measure the distance between subsets, the nearest neighbor nodes determine the nearest subsets. The merging of Dᵢ and Dⱼ corresponds to adding an edge between the nearest pair of nodes in Dᵢ and Dⱼ. Because edges linking clusters always go between distinct clusters, the resulting graph never has any closed loops or circuits; in the terminology of graph theory, this procedure generates a tree. If it is allowed to continue until all of the subsets are linked, the result is a spanning tree. A spanning tree is a tree with a path from any node to any other node. Moreover, it can be shown that the sum of the edge lengths of the resulting tree will not exceed the sum of the edge lengths for any other spanning tree for that set of samples. Thus, with the use of dmin( ) as the distance measure, the agglomerative clustering procedure becomes an algorithm for generating a minimal spanning tree. See Duda et al., id, pp. 553-554.

Farthest-neighbor algorithm. The farthest-neighbor algorithm uses the following equation to measure the distances between clusters:

$$d max ( Di , Dj ) = {max}_{\begin{matrix}x ∈ Di \\ {x}^{′} ∈ Dj\end{matrix}} ‖ x - {x}^{′} ‖ .$$

This algorithm is also known as the maximum algorithm. If the clustering is terminated when the distance between the nearest clusters exceeds an arbitrary threshold, it is called the complete-linkage algorithm. The farthest-neighbor algorithm discourages the growth of elongated clusters. Application of this procedure can be thought of as producing a graph in which the edges connect all of the nodes in a cluster. In the terminology of graph theory, every cluster contains a complete subgraph. The distance between two clusters is terminated by the most distant nodes in the two clusters. When the nearest clusters are merged, the graph is changed by adding edges between every pair of nodes in the two clusters.

Average linkage algorithm. Another agglomerative clustering technique is the average linkage algorithm. The average linkage algorithm uses the following equation to measure the distances between clusters:

$${d}_{avg} ( Di , Dj ) = \frac{1}{{n}_{i} {n}_{j}} {\sum }_{x ∈ Di} {\sum }_{{x}^{′} ∈ Dj} ‖ x - {x}^{′} ‖ .$$

Hierarchical cluster analysis begins by making a pair-wise comparison of all gene analysis vectors in a set of such vectors. After evaluating similarities from all pairs of elements in the set, a distance matrix is constructed. In the distance matrix, a pair of vectors with the shortest distance (i.e. most similar values) is selected. Then, when the average linkage algorithm is used, a “node” (“cluster”) is constructed by averaging the two vectors. The similarity matrix is updated with the new “node” (“cluster”) replacing the two joined elements, and the process is repeated n-1 times until only a single element remains. Consider six elements, A-F having the values:
A{4.9}, B{8.2}, C{3.0}, D{5.2}, E{8.3), F{2.3}.
In the first partition, using the average linkage algorithm, one matrix (sol. 1) that could be computed is:
A {4.93, B-E{8.25}, C{3.0}, D {5.2}, F{2.3}. (sol. 1)
Alternatively, the first partition using the average linkage algorithm could yield the matrix:
A {4.9}, C{3.0}, D{5.2}, E-B{8.25}, F{2.3}. (sol. 2)

Assuming that solution 1 was identified in the first partition, the second partition using the average linkage algorithm will yield:
A-D{5.05}, B-E{8.25}, C{3.0}, F{2.3} (sol. 1-1)
or
B-E{8.25}, C{3.0}, D-A{5.05}, F{2.3}. (sol. 1-2)

Assuming that solution 2 was identified in the first partition, the second partition of the average linkage algorithm will yield:
A-D{5.05}, C{3.0}, E-B {8.25}, F{2.3} (sol. 2-1)
or
C{3.0}, D-A{5.05}, E-B {8.25}, F{2.3}. (sol. 2-2)

Thus, after just two partitions in the average linkage algorithm, there are already four matrices. See Duda et al., Pattern Classification, John Wiley & Sons, New York, 2001, p. 551.

### 5.5.1.2. Clustering with Pearson Correlation Coefficients

In one embodiment of the present invention, QTL vectors and/or gene expression vectors are clustered using agglomerative hierarchical clustering with Pearson correlation coefficients. In this form of clustering, similarity is determined using Pearson correlation coefficients between the QTL vectors pairs, gene expression pairs, or sets of cellular constituent measurements. Other metrics that can be used, in addition to the Pearson correlation coefficient, include but are not limited to, a Euclidean distance, a squared Euclidean distance, a Euclidean sum of squares, a Manhattan metric, and a squared Pearson correlation coefficient. Such metrics may be computed using SAS (Statistics Analysis Systems Institute, Cary, N.C.) or S-Plus (Statistical Sciences, Inc., Seattle, Wash.).

### 5.5.1.3. Divisive Clustering

In some embodiments, the hierarchical clustering technique used to cluster QTL vectors and/or gene expression vectors is a divisive clustering procedure. Divisive (top-down clustering) procedures start with all of the samples in one cluster and form the sequence by successfully splitting clusters. Divisive clustering techniques are classified as either a polythetic or a monthetic method. A polythetic approach divides clusters into arbitrary subsets.

### 5.5.2. K-Means Clustering

In k-means clustering, sets of QTL vectors, gene expression vectors, or sets of cellular constituent measurements are randomly assigned to K user specified clusters. The centroid of each cluster is computed by averaging the value of the vectors in each cluster. Then, for each i=1, . . . , N, the distance between vector xi and each of the cluster centroids is computed. Each vector xᵢ is then reassigned to the cluster with the closest centroid. Next, the centroid of each affected cluster is recalculated. The process iterates until no more reassignments are made. See Duda et al., 2001, Pattern Classification, John Wiley & Sons, New York, N.Y., pp. 526-528. A related approach is the fuzzy k-means clustering algorithm, which is also known as the f c-means algorithm In the fizzy k-means clustering algorithm, the assumption that every QTL vector, gene expression vector, or set of cellular constituent measurements is in exactly one cluster at any given time is relaxed so that every vector (or set) has some graded or “fuzzy” membership in a cluster. See Duda et al., 2001, Pattern Classification, John Wiley & Sons, New York, N.Y., pp. 528-530.

### 5.5.3. Jarvis-Patrick Clustering

Jarvis-Patrick clustering is a nearest-neighbor non-hierarchical clustering method in which a set of objects is partitioned into clusters on the basis of the number of shared nearest-neighbors. In the standard implementation advocated by Jarvis and Patrick, 1973, IEEE Trans. Comput., C-22:1025-1034, a preprocessing stage identifies the K nearest-neighbors of each object in the dataset. In the subsequent clustering stage, two objects i and j join the same cluster if (i) i is one of the K nearest-neighbors of j, (ii) j is one of the K nearest-neighbors of i, and (ii) i and j have at least kₘᵢₙ of their K nearest-neighbors in common, where K and kₘᵢₙ are user-defined parameters. The method has been widely applied to clustering chemical structures on the basis of fragment descriptors and has the advantage of being much less computationally demanding than hierarchical methods, and thus more suitable for large databases. Jarvis-Patrick clustering may be performed using the Jarvis-Patrick Clustering Package 3.0 (Barnard Chemical Information, Ltd., Sheffield, United Kingdom).

### 5.5.4. Neural Networks

A neural network has a layered structure that includes a layer of input units (and the bias) connected by a layer of weights to a layer of output units. In multilayer neural networks, there are input units, hidden units, and output units. In fact, any function from input to output can be implemented as a three-layer network In such networks, the weights are set based on training patterns and the desired output. One method for supervised training of multilayer neural networks is back-propagation. Back-propagation allows for the calculation of an effective error for each hidden unit, and thus derivation of learning rule for the input-to-hidden weights of the neural network.

The basic approach to the use of neural networks is to start with an untrained network, present a training pattern to the input layer, and pass signals through the net and determine the output at the output layer. These outputs are then compared to the target values; any difference corresponds to an error. This error or criterion function is some scalar function of the weights and is minimized when the network outputs match the desired outputs. Thus, the weights are adjusted to reduce this measure of error. Three commonly used training protocols are stochastic, batch, and on-line. In stochastic training, patterns are chosen randomly from the training set and the network weights are updated for each pattern presentation. Multilayer nonlinear networks trained by gradient descent methods such as stochastic back-propagation perform a maximum-likelihood estimation of the weight values in the model defined by the network topology. In batch training, all patterns are presented to the network before learning takes place. Typically, in batch training, several passes are made through the training data. In online training, each pattern is presented once and only once to the net.

### 5.5.5. Self-Organizing Maps

A self-organizing map is a neural-network that is based on a divisive clustering approach. The aim is to assign genes to a series of partitions on the basis of the similarity of their expression vectors to reference vectors that are defined for each partition Consider the case in which there are two microarrays from two different experiments. It is possible to build up a two-dimensional construct where every spot corresponds to the expression levels of any given gene in the two experiments. A two-dimensional grid is built, resulting in several partitions of the two-dimensional construct. Next, a gene is randomly picked and the identify of the reference vector (node) closest to the gene picked is determined based on a distance matrix. The reference vector is then adjusted so that it is more similar to the vector of the assigned gene. That means the reference vector is moved one distance unit on the x axis and y-axis and becomes closer to the assigned gene. The other nodes are all adjusted to the assigned gene, but only are moved one half or one-fourth distance unit. This cycle is repeated hundreds of thousands times to converge the reference vector to fixed value and where the grid is stable. At that time, every reference vector is the center of a group of genes. Finally, the genes are mapped to the relevant partitions depending on the reference vector to which they are most similar.

### 5.6. Multivariate Statistical Models

Using the methods of the present invention, candidate pathway groups are identified from the analysis of QTL interaction map data and gene expression cluster maps. Each candidate pathway group includes a number of genes. The methods of the present invention are advantageous because they filter the potentially thousands of genes in the genome of the population of interest into a few candidate pathway groups using clustering techniques. In a typical case, a candidate pathway group represents a group of genes that tightly cluster in a gene expression cluster map. The genes in a candidate pathway group may also cluster tightly in a QTL interaction map. The QTL interaction map serves as a complementary approach to defining the genes in a candidate pathway group. For example, consider the case in which genes A, B, and C cluster tightly in a gene expression cluster map. Furthermore, genes A, B, C and D cluster tightly in the corresponding QTL interaction map. In this example, analysis of the gene expression cluster map alone suggest that genes A, B, and C form a candidate pathway group. However, analysis of both the QTL interaction map and the gene expression cluster map suggest that the candidate pathway group comprises genes A, B, C, and D.

Once candidate pathway groups, have been identified, multivariate statistical techniques can be used to determine whether each of the genes in the candidate pathway group affect a particular trait, such as a complex disease trait. The form of multivariate statistical analysis used in some embodiments of the present invention is dependent upon on the type of genotype and/or pedigree data that is available.

Typically, more pedigree data is available in cases where the population to be studied is plants or animals. In such instances, the multivariate statistical models such as those of Jiang and Zeng, 1995, Nature Genetics 140, pp. 1111-1127, as well as the techniques implemented in QTL Cartographer (Basten and Zeng, 1994, Zmap-a QTL cartographer, Proceedings of the 5th World Congress on Genetics Applied to Livestock Production: Computing Strategies and Software 22, Smith et al. eds., pp. 65-66, The Organizing Committee, 5th World Congress on Genetics Applied to Livestock Production, Guelph, Ontario, Canada; Basten et al., 2001, QTL Cartographer, Version 1.15, Department of Statistics, North Carolina State University, Raleigh, N.C. In addition, marker regression (joint mapping, marker-difference regression, MDR), interval mapping with marked cofactors, and composite interval mapping can be used. See, for example, Lynch & Walsh, 1998, Genetics and Analysis of Quantitative Traits, Sinauer Associates, Inc., Sunderland, Mass.

Jiang and Zeng have developed a multiple-trait extension to composite interval mapping (CIM). See, for example, Jiang and Zeng, 1995, Genetics 140, p. 1111. CIM refers to the general approach of adding marker cofactors to an otherwise standard interval analysis (e.g., QTL detection using linear models or via maximum likelihood). CIM handles multiple QTLs by incorporating mutlilocus marker information from organisms by modifying standard interval mapping to include additional markers as cofactors for analysis. See, for example, Jansen, 1993, Genetics 135, p. 205; Zeng, 1994, Genetics 136, p. 1457. The multiple-trait extension to CIM developed by Jiang and Zeng provides a framework for testing the candidate pathway groups that are constructed using the methods of the present invention in cases where the genes in these candidate pathway groups link to the same genetic region. The methods of Jiang and Zeng allow for the determination as to whether expression values (for the genes in the candidate pathway group) linking to the same region are controlled by a single gene pleiotropy) or by two closely linked genes. If the methods of Jiang and Zeng suggest that multiple genes are actually controlled by closely linked loci (closely linked genes), then there is not support that the genes linking to the same region are in the same pathway. Moreover, the components (hierarchy) of a pathway can be deduced by testing subsets of the pathway group to see which genes have an underlying pleiotropic relationship with respect to other genes. Further, the definition of the candidate pathway group can be refined by eliminating specific genes in the candidate pathway group that do not have a pleiotropic relationship with other genes in the candidate pathway group. The idea is to determine which of the genes linking to given region, have other genes linking to their physical location, indicating the order for hierarchy and control.

Presently, the practical limits are that no more than ten genes can be handled at once using multivariate methods such as the Jiang and Zeng methods. Theoretically, the number of genes is limited by the amount of data available to fit the model, but the particular limitation is that the optimization techniques are not effective for greater than 10 dimensions. However, in some embodiments, more than 10 genes can be handled at once by implementing dimensionality reductions techniques (like principal components).

For human genotype and pedigree data, methods described in Allison, 1998, Multiple Phenotype Modeling in Gene-Mapping Studies of Quantitative Traits: Power Advantages, Am J. Hum. Genetics 63, pp. 1190-1201, are used, including, but not limited to, those of Amos et al., 1990, Am J. Hum. Genetics 47, pp. 247-254.

In some embodiments, gene expression data 44 is collected for multiple tissue types. In such instances, multivariate analysis can be used to determine the true nature of a complex disease. Multivariate techniques used in this embodiment of the invention are described, in part, in Williams et al., 1999, Am J Hum Genet 65(4): 113447; Amos et al., 1990, Am J Hum Genet 47(2):.247-54, and Jiang and Zeng, 1995, Nature Genetics 140:1111-1127.

Asthma provides one example of a complex disease that can be studied using expression data from multiple tissue types. Asthma is expected to, in part, be influenced by immune system response not only in lungs but also in blood. By measuring expression of genes in the lung and in blood, the following model could be used to dissect the shared genetic effect in a model system, e.g. an F2 mouse cross:

$${y}_{{j}_{1}} = {α}_{1} + {b}_{1} {x}_{j} + {d}_{1} {z}_{j} + {e}_{{j}_{1}}$$

$${y}_{{j}_{2}} = {α}_{2} + {b}_{2} {x}_{j} + {d}_{2} {z}_{j} + {e}_{{j}_{2}}$$

$$⋮$$

$${y}_{{j}_{m}} = {α}_{m} + {b}_{m} {x}_{j} + {d}_{m} {z}_{j} + {e}_{{j}_{m}}$$

where, for individual j and a putative QTL:

yⱼₗ, . . . , yⱼₘ consists of asthma relevant phenotypes, expression data for gene expression in the lung and expression data for gene expression in blood;

xⱼ is the number of QTL alleles from a specific parental line;

zⱼ is 1 if the individual is heterozygous for the QTL and 0 otherwise;

aᵢ represents the mean for phenotype i;

bᵢ and dᵢ represent the additive and dominance effects of the QTL on phenotype i; and

eⱼᵢ is the residual error for individual j and phenotype i.

It is typically assumed that the residuals are uncorrelated between individuals, and the correlation between residuals within an individual are modeled as Cov(eⱼₖ, eⱼₗ)=ρₖₗσₖσₗ. Assuming a multivariate normal distribution for the residuals, likelihood analysis can be used to test for joint linkage of a QTL to the trait vector and to test for pleiotropic effects versus close linkage. With such information, it would be possible to detect a QTL that influences susceptibility to asthma through causing changes in gene expression for a set of genes expressed in blood and for a set of, potentially overlapping, genes expressed in lung. Such multivariate analyses in accordance with the present invention, combined with high quality phenotypic data that includes expression data across multiple tissues, allows for improved detection of those genes truly influencing susceptibility to complex diseases.

### 5.7. Analytic Kit Implementation

In a preferred embodiment, the methods of this invention can be implemented by use of kits for determining the responses or state of a biological sample. Such kits contain microarrays, such as those described in Subsections below. The microarrays contained in such kits comprise a solid phase, e.g., a surface, to which probes are hybridized or bound at a known location of the solid phase. Preferably, these probes consist of nucleic acids of known, different sequence, with each nucleic acid being capable of hybridizing to an RNA species or to a cDNA species derived therefrom. In a particular embodiment, the probes contained in the kits of this invention are nucleic acids capable of hybridizing specifically to nucleic acid sequences derived from RNA species in cells collected from an organism of interest.

In a preferred embodiment, a kit of the invention also contains one or more databases described above and in FIG. 1, encoded on computer readable medium, and/or an access authorization to use the databases described above from a remote networked computer.

In another preferred embodiment, a kit of the invention further contains software capable of being loaded into the memory of a computer system such as the one described supra, and illustrated in FIG. 1. The software contained in the kit of this invention, is essentially identical to the software described above in conjunction with FIG. 1.

Alternative kits for implementing the analytic methods of this invention will be apparent to one of skill in the art and are intended to be comprehended within the accompanying claims.

### 5.8. Transcriptional State Measurements

This section provides some exemplary methods for measuring the expression level of genes, which are one type of cellular constituent. One of skill in the art will appreciate that this invention is not limited to the following specific methods for measuring the expression level of genes in each organism in a plurality of organisms.

### 5.8.1. Transcript Assay Using Microarrays

The techniques described in this section are particularly useful for the determination of the expression state or the transcriptional state of a cell or cell type or any other cell sample by monitoring expression profiles. These techniques include the provision of polynucleotide probe arrays that may be used to provide simultaneous determination of the expression levels of a plurality of genes. These technique further provide methods for designing and making such polynucleotide probe arrays.

The expression level of a nucleotide sequence in a gene can be measured by any high throughput techniques. However measured, the result is either the absolute or relative amounts of transcripts or response data, including but not limited to values representing abundances or abundance rations. Preferably, measurement of the expression profile is made by hybridization to transcript arrays, which are described in this subsection. In one embodiment, “transcript arrays” or “profiling arrays” are used. Transcript arrays can be employed for analyzing the expression profile in a cell sample and especially for measuring the expression profile of a cell sample of a particular tissue type or developmental state or exposed to a drug of interest.

In one embodiment, an expression profile is obtained by hybridizing detectably labeled polynucleotides representing the nucleotide sequences in mRNA transcripts present in a cell (e.g., fluorescently labeled cDNA synthesized from total cell mRNA) to a microarray. A microarray is an array of positionally-addressable binding (e.g., hybridization) sites on a support for representing-many of the nucleotide sequences in the genome of a cell or organism, preferably most or almost all of the genes. Each of such binding sites consists of polynucleotide probes bound to the predetermined region on the support. Microarrays can be made in a number of ways, of which several are described herein below. However produced, microarrays share certain characteristics. The arrays are reproducible, allowing multiple copies of a given array to be produced and easily compared with each other. Preferably, the microarrays are made from materials that are stable under binding (e.g., nucleic acid hybridization) conditions. Microarrays are preferably small, e.g., between 1 cm² and 25 cm², preferably 1 to 3 cm². However, both larger and smaller arrays are also contemplated and may be preferable, e.g., for simultaneously evaluating a very large number or very small number of different probes.

Preferably, a given binding site or unique set of binding sites in the microarray will specifically bind (e.g., hybridize) to a nucleotide sequence in a single gene from a cell or organism (e.g., to exon of a specific mRNA or a specific cDNA derived therefrom).

The microarrays used can include one or more test probes, each of which has a polynucleotide sequence that is complementary to a subsequence of RNA or DNA to be detected. Each probe typically has a different nucleic acid sequence, and the position of each probe on the solid surface of the array is usually known. Indeed, the microarrays are preferably addressable arrays, more preferably positionally addressable arrays. Each probe of the array is preferably located at a known, predetermined position on the solid support so that the identity (i.e., the sequence) of each probe can be determined from its position on the array (i.e., on the support or surface). In some embodiments, the arrays are ordered arrays.

Preferably, the density of probes on a microarray or a set of microarrays is 100 different (e.g., non-identical) probes per 1 cm² or higher. More preferably, a microarray used in the methods of the invention will-have at least 550 probes per 1 cm², at least 1,000 probes per 1 cm², at least 1,500 probes per 1 cm² or at least 2,000 probes per 1 cm². In a particularly preferred embodiment, the microarray is a high density array, preferably having a density of at least 2,500 different probes per 1 cm². The microarrays used in the invention therefore preferably contain at least 2,500, at least 5,000, at least 10,000, at least 15,000, at least 20,000, at least 25,000, at least 50,000 or at least 55,000 different (i.e., non-identical) probes.

In one embodiment, the microarray is an array (e.g., a matrix) in which each position represents a discrete binding site for a nucleotide sequence of a transcript encoded by a gene (e.g., for an exon of an mRNA or a cDNA derived therefrom). The collection of binding sites on a microarray contains sets of binding sites for a plurality of genes. For example, in various embodiments, the microarrays of the invention can comprise binding sites for products encoded by fewer than 50% of the genes in the genome of an organist Alternatively, the microarrays of the invention can have binding sites for the products encoded by at least 50%, at least 75%, at least 85%, at least 90%, at least 95%, at least 99% or 100% of the genes in the genome of an organism. la other embodiments, the microarrays of the invention can having binding sites for products encoded by fewer than 50%, by at least 50%, by at least 75%, by at least 85%, by at least 90%, by at least 95%, by at least 99% or by 100% of the genes expressed by a cell of an organism. The binding site can be a DNA or DNA analog to which a particular RNA can specifically hybridize. The DNA or DNA analog can be, e.g., a synthetic oligomer or a gene fragment, e.g. corresponding to an exon.

In some embodiments of the present invention, a gene or an exon in a gene is represented in the profiling arrays by a set of binding sites comprising probes with different polynucleotides that are complementary to different sequence segments of the gene or the exon. Such polynucleotides are preferably of the length of 15 to 200 bases, more preferably of the length of 20 to 100 bases, most preferably 40-60 bases. Each probe sequence may also comprise linker sequences in addition to the sequence that is complementary to its target sequence. As used herein, a linker sequence is a sequence between the sequence that is complementary to its target sequence and the surface of support. For example, in preferred embodiments, the profiling arrays of the invention comprise one probe specific to each target gene or exon. However, if desired, the profiling arrays may contain at least 2, 5, 10, 100, or 1000 or more probes specific to some target genes or exons. For example, the array may contain probes tiled across the sequence of the longest mRNA isoform of a gene at single base steps.

In specific embodiments of the invention, when an exon has alternative spliced variants, a set of polynucleotide probes of successive overlapping sequences, i.e., tiled sequences, across the genomic region containing the longest variant of an exon can be included in the exon profiling arrays. The set of polynucleotide probes can comprise successive overlapping sequences at steps of a predetermined base intervals, e.g. at steps of 1, 5, or 10 base intervals, span, or are tiled across, the mRNA containing the longest variant. Such sets of probes therefore can be used to scan the genomic region containing all variants of an exon to determine the expressed variant or variants of the exon to determine the expressed variant or variants of the exon. Alternatively or additionally, a set of polynucleotide probes comprising exon specific probes and/or variant junction probes can be included in the exon profiling array. As used herein, a variant junction probe refers to a probe specific to the junction region of the particular exon variant and the neighboring exon. In some cases, the probe set contains variant junction probes specifically hybridizable to each of all different splice junction sequences of the exon. In other cases, the probe set contains exon specific probes specifically hybridizable to the common sequences in all different variants of the exon, and/or variant junction probes specifically hybridizable to the different splice junction sequences of the exon.

In some cases, an exon is represented in the exon profiling arrays by a probe comprising a polynucleotide that is complementary to the full length exon. In such instances, an exon is represented by a single binding site on the profiling arrays. In some preferred cases, an exon is represented by one or more binding sites on the profiling arrays, each of the binding sites comprising a probe with a polynucleotide sequence that is complementary to an RNA fragment that is a substantial portion of the target exon. The lengths of such probes are normally between 15-600 bases, preferably between 20-200 bases, more preferably between 30-100 bases, and most preferably between 40-80 bases. The average length of an exon is 200 bases (see, e.g., Lewin, Genes V, Oxford University Press, Oxford, 1994). A probe of length of 40-80 allows more specific binding of the exon than a probe of shorter length, thereby increasing the specificity of the probe to the target exon. For certain genes, one or more targeted exons may have sequence lengths less than 40-80 bases. In such cases, if probes with sequences longer than the target exons are to be used, it may be desirable to design probes comprising sequences that include the entire target exon flanked by sequences from the adjacent constitutively splice exon or exons such that the probe sequences are complementary to the corresponding sequence segments in the mRNAs. Using flanking sequence from adjacent constitutively spliced exon or exons rather than the genomic flanking sequences, i.e., intron sequences, permits comparable hybridization stringency with other probes of the same length. Preferably the flanking sequence used are from the adjacent constitutively spliced exon or exons that are not involved in any alternative pathways. More preferably the flanking sequences used do not comprise a significant portion of the sequence of the adjacent exon or exons so that cross-hybridization can be minimized. In some embodiments, when a target exon that is shorter than the desired probe length is involved in alternative splicing, probes comprising flanking sequences in different alternatively spliced mRNAs are designed so that expression level of the exon expressed in different alternatively spliced mRNAs can be measured.

In some instances, when alternative splicing pathways and/or exon duplication in separate genes are to be distinguished, the DNA array or set of arrays can also comprise probes that are complementary to sequences spanning the junction regions of two adjacent exons. Preferably, such probes comprise sequences from the two exons which are not substantially overlapped with probes for each individual exons so that cross hybridization can be minimized. Probes that comprise sequences from more than one exons are useful in distinguishing alternative splicing pathways and/or expression of duplicated exons in separate genes if the exons occurs in one or more alternative spliced mRNAs and/or one or more separated genes that contain the duplicated exons but not in other alternatively spliced mRNAs and/or other genes that contain the duplicated exons. Alternatively, for duplicate exons in separate genes, if the exons from different genes show substantial difference in sequence homology, it is preferable to include probes that are different so that the exons from different genes can be distinguished.

It will be apparent to one skilled in the art that any of the probe schemes, supra, can be combined on the same profiling array and/or on different arrays within the same set of profiling arrays so that a more accurate determination of the expression profile for a plurality of genes can be accomplished. It will also be apparent to one skilled in the art that the different probe schemes can also be used for different levels of accuracies in profiling. For example, a profiling array or array set comprising a small set of probes for each exon may be used to determine the relevant genes and/or RNA splicing pathways under certain specific conditions. An array or array set comprising larger sets of probes for the exons that are of interest is then used to more accurately determine the exon expression profile under such specific conditions. Other DNA array strategies that allow more advantageous use of different probe schemes are also encompassed.

Preferably, the microarrays used in the invention have binding sites (i.e., probes) for sets of exons for one or more genes relevant to the action of a drug of interest or in a biological pathway of interest. As discussed above, a “gene” is identified as a portion of DNA that is transcribed by RNA polymerase, which may include a 5′ untranslated region (“UTR”), introns, exons and a 3′ UTR. The number of genes in a genome can be estimated from the number of mRNAs expressed by the cell or organism, or by extrapolation of a well characterized portion of the genome. When the genome of the organism of interest has been sequenced, the number of ORFs can be determined and mRNA coding regions identified by analysis of the DNA sequence. For example, the genome of Saccharomyces cerevisiae has been completely sequenced and is reported to have approximately 6275 ORFs encoding sequences longer the 99 amino acid residues in length. Analysis of these ORFs indicates that there are 5,885 ORFs that are likely to encode protein products (Goffeau et al., 1996, Science 274: 546-567). In contrast, the human genome is estimated to contain approximately 30,000 to 130,000 genes (see Crollius et al., 2000, Nature Genetics 25:235-238; Ewing et al., 2000, Nature Genetics 25:232-234). Genome sequences for other organisms, including but not limited to Drosophila, C. elegans, plants, e.g., rice and Arabidopsis, and mammals, e.g., mouse and human, are also completed or nearly completed. Thus, in preferred embodiments of the invention, an array set comprising in total probes for all known or predicted exons in the genome of an organism is provided. As a non-limiting example, the present invention provides an array set comprising one or two probes for each known or predicted exon in the human genome.

It will be appreciated that when cDNA complementary to the RNA of a cell is made and hybridized to a microarray under suitable hybridization conditions, the level of hybridization to the site in the array corresponding to an exon of any particular gene will reflect the prevalence in the cell of mRNA or mRNAs containing the exon transcribed from that gene. For example, when detectably labeled (e.g., with a fluorophore) cDNA complementary to the total cellular mRNA is hybridized to a microarray, the site on the array corresponding to an exon of a gene (i.e., capable of specifically binding the product or products of the gene expressing) that is not transcribed or is removed during RNA splicing in the cell will have little or no signal (e.g., fluorescent signal), and an exon of a gene for which the encoded mRNA expressing the exon is prevalent will have a relatively strong signal. The relative abundance of different mRNAs produced from the same gene by alternative splicing is then determined by the signal strength pattern across the whole set of exons monitored for the gene.

In one embodiment, cDNAs from cell samples from two different conditions are hybridized to the binding sites of the microarray using a two-color protocol. In the case of drug responses one cell sample is exposed to a drug and another cell sample of the same type is not exposed to the drug. In the case of pathway responses one cell is exposed to a pathway perturbation and another cell of the same type is not exposed to the pathway perturbation. The cDNA derived from each of the two cell types are differently labeled (e.g., with Cy3 and Cy5) so that they can be distinguished. In one embodiment, for example, cDNA from a cell treated with a drug (or exposed to a pathway perturbation) is synthesized using a fluorescein-labeled dNTP, and cDNA from a second cell not drug-exposed, is synthesized using a rhodamine-labeled dNTP. When the two cDNAs are mixed and hybridized to the microarray, the relative intensity of signal from each cDNA set is determined for each site on the array, and any relative difference in abundance of a particular exon detected.

In the example described above, the cDNA from the drug-treated (or pathway perturbed) cell will fluoresce green when the fluorophore is stimulated and the cDNA from the untreated cell will fluoresce red. As a result, when the drug treatment has no effect, either directly or indirectly, on the transcription and/or post-transcriptional splicing of a particular gene in a cell, the exon expression patterns will be indistinguishable in both cells and, upon reverse transcription, red-labeled and green-labeled cDNA will be equally prevalent. When hybridized to the microarray, the binding site(s) for that species of RNA will emit wavelengths characteristic of both fluorophores. In contrast, when the drug-exposed cell is treated with a drug that, directly or indirectly, change the transcription and/or post-transcriptional splicing of a particular gene in the cell, the exon expression pattern as represented by ratio of green to red fluorescence for each exon binding site will change. When the drug increases the prevalence of an mRNA, the ratios for each exon expressed in the mRNA will increase, whereas when the drug decreases the prevalence of an mRNA, the ratio for each exons expressed in the mRNA will decrease.

The use of a two-color fluorescence labeling and detection scheme to define alterations in gene expression has been described in connection with detection of mRNAs, e.g., in Shena et al., 1995, Quantitative monitoring of gene expression patterns with a complementary DNA microarray, Science 270:467-470, which is incorporated by reference in its entirety for all purposes. The scheme is equally applicable to labeling and detection of exons. An advantage of using cDNA labeled with two different fluorophores is that a direct and internally controlled comparison of the mRNA or exon expression levels corresponding to each arrayed gene in two cell states can be made, and variations due to minor differences in experimental conditions (e.g., hybridization conditions) will not affect subsequent analyses. However, it will be recognized that it is also possible to use cDNA from a single cell, and compare, for example, the absolute amount of a particular exon in, e.g., a drug-treated or pathway-perturbed cell and an untreated cell. Furthermore, labeling with more than two colors is also contemplated in the present invention. In some embodiments of the invention, at least 5, 10, 20, or 100 dyes of different colors can be used for labeling. Such labeling permits simultaneous hybridizing of the distinguishably labeled cDNA populations to the same array, and thus measuring, and optionally comparing the expression levels of, mRNA molecules derived from more than two samples. Dyes that can be used include, but are not limited to, fluorescein and its derivatives, rhodamine and its derivatives, texas red, 5′carboxy-fluorescein (“FMA”), 2′,7′-dimethoxy-4′,5′-dichloro-6-carboxy-fluorescein (“JOE”), N,N,N′,N′-tetramethyl-6-carboxy-rhodamine (“TAMRA”), 6′carboxy-X-rhodamine (“ROX”), HEX, TET, IRD40, and IRD41, cyamine dyes, including but are not limited to Cy3, Cy3.5 and Cy5; BODIPY dyes including but are not limited to BODIPY-FL, BODIPY-TR, BODIPY-TMR, BODIPY-630/650, and BODIPY-650/670; and ALEXA dyes, including but are not limited to ALEXA-488, ALEXA-532, ALEXA-546, ALEXA-568, and ALEXA-594; as well as other fluorescent dyes which will be known to those who are skilled in the art.

In some embodiments of the invention, hybridization data are measured at a plurality of different hybridization times so that the evolution of hybridization levels to equilibrium can be determined. In such embodiments, hybridization levels are most preferably measured at hybridization times spanning the range from 0 to in excess of what is required for sampling of the bound polynucleotides (i.e., the probe or probes) by the labeled polynucleotides so that the mixture is close to or substantially reached equilibrium, and duplexes are at concentrations dependent on affinity and abundance rather than diffusion. However, the hybridization times are preferably short enough that irreversible binding interactions between the labeled polynucleotide and the probes and/or the surface do not occur, or are at least limited. For example, in embodiments wherein polynucleotide arrays are used to probe a complex mixture of fragmented polynucleotides, typical hybridization times may be approximately 0-72 hours. Appropriate hybridization times for other embodiments will depend on the particular polynucleotide sequences and probes used, and may be determined by those skilled in the art (see, e.g., Sambrook et al., Eds., 1989, Molecular Cloning: A Laboratory Manual, 2nd ed., Vol. 1-3, Cold Spring Harbor Laboratory, Cold Spring Harbor, N.Y.).

In one embodiment, hybridization levels at different hybridization times are measured separately on different, identical microarrays. For each such measurement, at hybridization time when hybridization level is measured, the microarray is washed briefly, preferably in room temperature in an aqueous solution of high to moderate salt concentration (e.g., 0.5 to 3 M salt concentration) under conditions which retain all bound or hybridized polynucleotides while removing all unbound polynucleotides. The detectable label on the remaining, hybridized polynucleotide molecules on each probe is then measured by a method which is appropriate to the particular labeling method used. The resulted hybridization levels are then combined to form a hybridization curve. In another embodiment, hybridization levels are measured in real time using a single microarray. In this embodiment, the microarray is allowed to hybridize to the sample without interruption and the microarray is interrogated at each hybridization time in a non-invasive manner. In still another embodiment, one can use one array, hybridize for a short time, wash and measure the hybridization level, put back to the same sample, hybridize for another period of time, wash and measure again to get the hybridization time curve.

Preferably, at least two hybridization levels at two different hybridization times are measured, a first one at a hybridization time that is close to the time scale of cross-hybridization equilibrium and a second one measured at a hybridization time that is longer than the first one. The time scale of cross-hybridization equilibrium depends, inter alia, on sample composition and probe sequence and may be determined by one skilled in he art. In preferred embodiments, the first hybridization level is measured at between 1 to 10 hours, whereas the second hybridization time is measured at 2, 4, 6, 10, 12, 16, 18, 48 or 72 times as long as the first hybridization time.

### 5.8.1.1. Preparing Probes for Microarrays

As noted above, the “probe” to which a particular polynucleotide molecule, such as an exon, specifically hybridizes according to the invention is a complementary polynucleotide sequence. Preferably one or more probes are selected for each target exon. For example, when a minimum number of probes are to be used for the detection of an exon, the probes normally comprise nucleotide sequences greater than 40 bases in length. Alternatively, when a large set of redundant probes is to be used for an exon, the probes normally comprise nucleotide sequences of 40-60 bases. The probes can also comprise sequences complementary to full length exons. The lengths of exons can range from less than 50 bases to more than 200 bases. Therefore, when a probe length longer than exon is to be used, it is preferable to augment the exon sequence with adjacent constitutively spliced exon sequences such that the probe sequence is complementary to the continuous mRNA fragment that contains the target exon. This will allow comparable hybridization stringency among the probes of an exon profiling array. It will be understood that each probe sequence may also comprise linker sequences in addition to the sequence that is complementary to its target sequence.

The probes may comprise DNA or DNA “mimics” (e.g., derivatives and analogues) corresponding to a portion of each exon of each gene in an organism's genome. In one embodiment, the probes of the microarray are complementary RNA or RNA mimics. DNA mimics are polymers composed of subunits capable of specific, Watson-Crick-like hybridization with DNA, or of specific hybridization with RNA. The nucleic acids can be modified at the base moiety, at the sugar moiety, or at the phosphate backbone. Exemplary DNA mimics include, e.g. phosphorothioates. DNA can be obtained, e.g., by polymerase chain reaction (PCR) amplification of exon segments from genomic DNA, cDNA (e.g., by RT-PCR), or cloned sequences. PCR primers are preferably chosen based on known sequence of the exons or cDNA that result in amplification of unique fragments (i.e., fragments that do not share more than 10 bases of contiguous identical sequence with any other fragment on the microarray). Computer programs that are well known in the art are useful in the design of primers with the required specificity and optimal amplification properties, such as Oligo version 5.0 (National Biosciences). Typically each probe on the microarray will be between 20 bases and 600 bases, and usually between 30 and 200 bases in length. PCR methods are well known in the art, and are described, for example, in Innis et al., eds., 1990, PCR Protocols: A Guide to Methods and Applications, Academic Press Inc., San Diego, Calif. It will be apparent to one skilled in the art that controlled robotic systems are useful for isolating and amplifying nucleic acids.

An alternative, preferred means for generating the polynucleotide probes of the microarray is by synthesis of synthetic polynucleotides or oligonucleotides, e.g., using N-phosphonate or phosphoramidite chemistries (Froehler et al., 1986, Nucleic Acid Res. 14:5399-5407; McBride et al., 1983, Tetrahedron Lett. 24:246-248). Synthetic sequences are typically between 15 and 600 bases in length, more typically between 20 and 100 bases, most preferably between 40 and 70 bases in length. In some embodiments, synthetic nucleic acids include non-natural bases, such as, but by no means limited to, inosine. As noted above, nucleic acid analogues may be used as binding sites for hybridization. An example of a suitable nucleic acid analogue is peptide nucleic acid (see, e.g., Egholm et al., 1993, Nature 363:566-568; and U.S. Pat. No. 5,539,083).

In alternative embodiments, the hybridization sites (i.e., the probes) are made from plasmid or phage clones of genes, cDNAs (e.g., expressed sequence tags), or inserts therefrom (Nguyen et al., 1995, Genomics 29:207-209).

### 5.8.1.2. Attaching Nucleic Acids to the Solid Surface

Preformed polynucleotide probes can be deposited on a support to form the array. Alternatively, polynucleotide probes can be synthesized directly on the support to form the array. The probes are attached to a solid support or surface, which may be made, e.g., from glass, plastic (e.g., polypropylene, nylon), polyacrylamide, nitrocellulose, gel, or other porous or nonporous material.

A preferred method for attaching the nucleic acids to a surface is by printing on glass plates, as is described generally by Schena et al, 1995, Science 270:467-470. This method is especially useful for preparing microarrays of cDNA (See also, DeRisi et al, 1996, Nature Genetics 14:457-460; Shalon et al., 1996, Genome Res. 6:639-645; and Schena et al., 1995, Proc. Natl. Acad. Sci. U.S.A. 93:10539-11286).

A second preferred method for making microarrays is by making high-density polynucleotide arrays. Techniques are known for producing arrays containing thousands of oligonucleotides complementary to defined sequences, at defined locations on a surface using photolithographic techniques for synthesis in situ (see, Fodor et al., 1991, Science 251:767-773; Pease et al., 1994, Proc. Natl. Acad. Sci. U.S.A. 91:5022-5026; Lockhart et al., 1996, Nature Biotechnology 14:1675; U.S. Pat. Nos. 5,578,832; 5,556,752; and 5,510,270) or other methods for rapid synthesis and deposition of defined oligonucleotides (Blanchard et al., Biosensors & Bioelectronics 11:687-690). When these methods are used, oligonucleotides (e.g., 60-mers) of known sequence are synthesized directly on a surface such as a derivatized glass slide. The array produced can be redundant, with several polynucleotide molecules per exon.

Other methods for making microarrays, e.g., by masking (Maskos and Southern, 1992, Nucl. Acids. Res. 20:1679-1684), may also be used. In principle, and as noted supra, any type of array, for example, dot blots on a nylon hybridization membrane (see Sambrook et al., supra) could be used. However, as will be recognized by those skilled in the art, very small arrays will frequently be preferred because hybridization volumes will be smaller.

In a particularly preferred embodiment, microarrays of the invention are manufactured by means of an ink jet printing device for oligonucleotide synthesis, e.g., using the methods and systems described by Blanchard in International Patent Publication No. WO 98/41531, published Sep. 24, 1998; Blanchard et al., 1996, Biosensors and Bioelectronics 11:687-690; Blanchard, 1998, in Synthetic DNA Arrays in Genetic Engineering, Vol. 20, J. K. Setlow, Ed., Plenum Press, New York at pages 111-123; and U.S. Pat. No. 6,028,189 to Blanchard. Specifically, the polynucleotide probes in such microarrays are preferably synthesized in arrays, e.g., on a glass slide, by serially depositing individual nucleotide bases in “microdroplets” of a high surface tension solvent such as propylene carbonate. The microdroplets have small volumes (e.g., 100 pL or less, more preferably 50 pL or less) and are separated from each other on the microarray (e.g., by hydrophobic domains) to form circular surface tension wells which define the locations of the array elements (i.e., the different probes). Polynucleotide probes are normally attached to the surface covalently at the 3′ end of the polynucleotide. Alternatively, polynucleotide probes can be attached to the surface covalently at the 5′ end of the polynucleotide (see for example, Blanchard, 1998, in Synthetic DNA Arrays in Genetic Engineering, Vol. 20, J. K. Setlow, Ed., Plenum Press, New York at pages 111-123).

### 5.8.1.3. Target Polynucleotide Molecules

Target polynucleotides that can be analyzed by the methods and compositions of the invention include RNA molecules such as, but by no means limited to, messenger RNA (mRNA) molecules, ribosomal RNA (rRNA) molecules, cRNA molecules (i.e., RNA molecules prepared from cDNA molecules that are transcribed in vivo) and fragments thereof. Target polynucleotides which may also be analyzed by the methods and compositions of the present invention include, but are not limited to DNA molecules such as genomic DNA molecules, cDNA molecules, and fragments thereof including oligonucleotides, ESTs, STSs, etc.

The target polynucleotides can be from any source. For example, the target polynucleotide molecules may be naturally occurring nucleic acid molecules such as genomic or extragenomic DNA molecules isolated from an organism, or RNA molecules, such as mRNA molecules, isolated from an organism. Alternatively, the polynucleotide molecules may be synthesized, including, e.g., nucleic acid molecules synthesized enzymatically in vivo or in vitro, such as cDNA molecules, or polynucleotide molecules synthesized by PCR, RNA molecules synthesized by in vitro transcription, etc. The sample of target polynucleotides can comprise, e.g., molecules of DNA, RNA, or copolymers of DNA and RNA. In preferred embodiments, the target polynucleotides of the invention will correspond to particular genes or to particular gene transcripts (e.g., to particular mRNA sequences expressed in cells or to particular cDNA sequences derived from such mRNA sequences). However, in many embodiments, particularly those embodiments wherein the polynucleotide molecules are derived from mammalian cells, the target polynucleotides may correspond to particular fragments of a gene transcript. For example, the target polynucleotides may correspond to different exons of the same gene, e.g., so that different splice variants of that gene may be detected and/or analyzed.

In preferred embodiments, the target polynucleotides to be analyzed are prepared in vitro from nucleic acids extracted from cells. For example, in one embodiment, RNA is extracted from cells (e.g., total cellular RNA, poly(A)⁺ messenger RNA, fraction thereof) and messenger RNA is purified from the total extracted RNA Methods for preparing total and poly(A)⁺ RNA are well known in the art, and are described generally, e.g., in Sambrook et al., supra. In one embodiment, RNA is extracted from cells of the various types of interest in this invention using guanidinium thiocyanate lysis followed by CsCl centrifugation and an oligo dT purification (Chirgwin et al., 1979, Biochemistry 18:5294-5299). In another embodiment, RNA is extracted from cells using guanidinium thiocyanate lysis followed by purification on RNeasy columns (Qiagen). cDNA is then synthesized from the purified mRNA using, e.g. oligo-dT or random primers. In preferred embodiments, the target polynucleotides are cRNA prepared from purified messenger RNA extracted from cells. As used herein, cRNA is defined here as RNA complementary to the source RNA. The extracted RNAs are amplified using a process in which doubled-stranded cDNAs are synthesized from the RNAs using a primer linked to an RNA polymerase promoter in a direction capable of directing transcription of anti-sense RNA. Anti-sense RNAs or cRNAs are then transcribed from the second strand of the double-stranded cDNAs using an RNA polymerase (see, e.g. U.S. Pat. Nos. 5,891,636, 5,716,785; 5,545,522 and 6,132,997; see also, U.S. Pat. No. 6,271,002, and U.S. Provisional Patent Application Ser. No. 60/253,641, filed on Nov. 28, 2000, by Ziman et al.). Both oligo-dT primers (U.S. Pat. Nos. 5,545,522 and 6,132,997) or random primers (U.S. Provisional Patent Application Ser. No. 60/253,641, filed on Nov. 28, 2000, by Ziman et al.) that contain an RNA polymerase promoter or complement thereof can be used. Preferably, the target polynucleotides are short and/or fragmented polynucleotide molecules which are representative of the original nucleic acid population of the cell.

The target polynucleotides to be analyzed by the methods and compositions of the invention are preferably detectably labeled. For example, cDNA can be labeled directly, e.g., with nucleotide analogs, or indirectly, e.g., by making a second, labeled cDNA strand using the first strand as a template. Alternatively, the double-stranded cDNA can be transcribed into cRNA and labeled.

Preferably, the detectable label is a fluorescent label, e.g. by incorporation of nucleotide analogs. Other labels suitable for use in the present invention include, but are not limited to, biotin, imminobiotin, antigens, cofactors, dinitrophenol, lipoic acid, olefinic compounds, detectable polypeptides, electron rich molecules, enzymes capable of generating a detectable signal by action upon a substrate, and radioactive isotopes. Preferred radioactive isotopes include ³²P, ³⁵S, ¹⁴C, ¹⁵N and ¹²⁵I. Fluorescent molecules suitable for the present invention include, but are not limited to, fluorescein and its derivatives, rhodamine and its derivatives, texas red, 5′carboxy-fluorescein (“FMA”), 2′,7′-dimethoxy-4′,5′-dichloro-6-carboxy-fluorescein (“JOE”), N,N,N′,N′-tetramethyl-6-carboxy-rhodamine (“TAMRA”), 6′carboxy-X-rhodamine (“ROX”), HEX TET, IRD40, and IRD41. Fluroescent molecules that are suitable for the invention further include: cyamine dyes, including by not limited to Cy3, Cy3.5 and Cy5; BODIPY dyes including but not limited to BODIPY-FL, BODIPY-TR, BODIPY-TMR, BODIPY-630/650, and BODIPY-650/670; and ALEXA dyes, including but not limited to ALEXA-488, ALEXA-532, ALEXA-546, ALEXA-568, and ALEXA-594; as well as other fluorescent dyes which will be known to those who are skilled in the art. Electron rich indicator molecules suitable for the present invention include, but are not limited to, ferritin, hemocyanin, and colloidal gold. Alternatively, in less preferred embodiments the target polynucleotides may be labeled by specifically complexing a first group to the polynucleotide. A second group, covalently linked to an indicator molecules and which has an affinity for the first group, can be used to indirectly detect the target polynucleotide. In such an embodiment, compounds suitable for use as a first group include, but are not limited to, biotin and imminobiotin. Compounds suitable for use as a second group include, but are not limited to, avidin and streptavidin.

### 5.8.1.4. Hybridization to Microarrays

As described supra, nucleic acid hybridization and wash conditions are chosen so that the polynucleotide molecules to be analyzed by the invention (referred to herein as the “target polynucleotide molecules) specifically bind or specifically hybridize to the complementary polynucleotide sequences of the array, preferably to a specific array site, wherein its complementary DNA is located.

Arrays containing double-stranded probe DNA situated thereon are preferably subjected to denaturing conditions to render the DNA single-stranded prior to contacting with the target polynucleotide molecules. Arrays containing single-stranded probe DNA (e.g., synthetic oligodeoxyribonucleic acids) may need to be denatured prior to contacting with the target polynucleotide molecules, e.g. to remove hairpins or dimers which form due to self complementary sequences.

Optimal hybridization conditions will depend on the length (e.g., oligomer versus polynucleotide greater than 200 bases) and type (e.g., RNA, or DNA) of probe and target nucleic acids. General parameters for specific (i.e., stringent) hybridization conditions for nucleic acids are described in Sambrook et al., (supra), and in Ausubel et al., 1987, Current Protocols in Molecular Biology, Greene Publishing and Wiley-Interscience, New York. When the cDNA microarrays of Schena et al. are used, typical hybridization conditions are hybridization in 5×SSC plus 0.2% SDS at 65° C. for four hours, followed by washes at 25° C. in low stringency wash buffer (1×SSC plus 0.2% SDS), followed by 10 minutes at 25° C. in higher stringency wash buffer (0.1×SSC plus 0.2% SDS) (Shena et al., 1996, Proc. Natl. Acad. Sci. U.S.A. 93:10614). Useful hybridization conditions are also provided in, e.g., Tijessen, 1993, Hybridization With Nucleic Acid Probes, Elsevier Science Publishers B.V. and Kricka, 1992, Nonisotopic DNA Probe Techniques, Academic Press, San Diego, Calif.

Particularly preferred hybridization conditions for use with the screening and/or signaling chips of the present invention include hybridization at a temperature at or near the mean melting temperature of the probes (e.g., within 5° C., more preferably within 2° C.) in 1 M NaCl, 50 mM MES buffer (pH 6.5), 0.5% sodium Sarcosine and 30% formamide.

### 5.8.1.5. Signal Detection and Data Analysis

It will be appreciated that when target sequences, e.g., cDNA or cRNA, complementary to the RNA of a cell is made and hybridized to a microarray under suitable hybridization conditions, the level of hybridization to the site in the array corresponding to an exon of any particular gene will reflect the prevalence in the cell of mRNA or mRNAs containing the exon transcribed from that gene. For example, when detectably labeled (e.g., with a fluorophore) cDNA complementary to the total cellular mRNA is hybridized to a microarray, the site on the array corresponding to an exon of a gene (i.e., capable of specifically binding the product or products of the gene expressing) that is not transcribed or is removed during RNA splicing in the cell will have little or no signal (e.g., fluorescent signal), and an exon of a gene for which the encoded mRNA expressing the exon is prevalent will have a relatively strong signal. The relative abundance of different mRNAs produced from the same gene by alternative splicing is then determined by the signal strength pattern across the whole set of exons monitored for the gene.

In preferred embodiments, target sequences, e.g., cDNAs or cRNAs, from two different cells are hybridized to the binding sites of the microarray. In the case of drug responses one cell sample is exposed to a drug and another cell sample of the same type is not exposed to the drug. In the case of pathway responses one cell is exposed to a pathway perturbation and another cell of the same type is not exposed to the pathway perturbation. The cDNA or cRNA derived from each of the two cell types are differently labeled so that they can be distinguished. In one embodiment, for example, cDNA from a cell treated with a drug (or exposed to a pathway perturbation) is synthesized using a fluorescein-labeled dNTP, and cDNA from a second cell, not drug-exposed, is synthesized using a rhodamine-labeled dNTP. When the two cDNAS are mixed and hybridized to the microarray, the relative intensity of signal from each cDNA set is determined for each site on the array, and any relative difference in abundance of a particular exon detected.

In the example described above, the cDNA from the drug-treated (or pathway perturbed) cell will fluoresce green when the fluorophore is stimulated and the cDNA from the untreated cell will fluoresce red. As a result, when the drug treatment has no effect, either directly or indirectly, on the transcription and/or post-transcriptional splicing of a particular gene in a cell, the exon expression patterns will be indistinguishable in both cells and, upon reverse transcription, red-labeled and green-labeled cDNA will be equally prevalent. When hybridized to the microarray, the binding site(s) for that species of RNA will emit wavelengths characteristic of both fluorophores. In contrast, when the drug-exposed cell is treated with a drug that, directly or indirectly, changes the transcription and/or post-transcriptional splicing of a particular gene in the cell, the exon expression pattern as represented by ratio of green to red fluorescence for each exon binding site will change. When the drug increases the prevalence of an mRNA, the ratios for each exon expressed in the mRNA will increase, whereas when the drug decreases the prevalence of an mRNA, the ratio for each exons expressed in the mRNA will decrease.

The use of a two-color fluorescence labeling and detection scheme to define alterations in gene expression has been described in connection with detection of mRNAs, e.g., in Shena et al., 1995, Science 270:467-470, which is incorporated by reference in its entirety for all purposes. The scheme is equally applicable to labeling and detection of exons. An advantage of using target sequences, e.g., cDNAs or cRNAs, labeled with two different fluorophores is that a direct and internally controlled comparison of the mRNA or exon expression levels corresponding to each arrayed gene in two cell states can be made, and variations due to minor differences in experimental conditions (e.g., hybridization conditions) will not affect subsequent analyses. However, it will be recognized that it is also possible to use cDNA from a single cell, and compare, for example, the absolute amount of a particular exon in, e.g., a drug-treated or pathway-perturbed cell and an untreated cell.

When fluorescently labeled probes are used, the fluorescence emissions at each site of a transcript array can be, preferably, detected by scanning confocal laser microscopy. In one embodiment, a separate scan, using the appropriate excitation line, is carried out for each of the two fluorophores used. Alternatively, a laser can be used that allows simultaneous specimen illumination at wavelengths specific to the two fluorophores and emissions from the two fluorophores can be analyzed simultaneously (see Shalon et al., 1996, Genome Res. 6:639-645). In a preferred embodiment, the arrays are scanned with a laser fluorescence scanner with a computer controlled X-Y stage and a microscope objective. Sequential excitation of the two fluorophores is achieved with a multi-line, mixed gas laser, and the emitted light is split by wavelength and detected with two photomultiplier tubes. Such fluorescence laser scanning devices are described, e.g., in Schena et al., 1996, Genome Res. 6:639-645. Alternatively, the fiber-optic bundle described by Ferguson et al., 1996, Nature Biotech. 14:1681-1684, may be used to monitor mRNA abundance levels at a large number of sites simultaneously.

Signals are recorded and, in a preferred embodiment, analyzed by computer, e.g., using a 12 bit analog to digital board. In one embodiment, the scanned image is despeckled using a graphics program (e.g., Hijaak Graphics Suite) and then analyzed using an image gridding program that creates a spreadsheet of the average hybridization at each wavelength at each site. If necessary, an experimentally determined correction for “cross talk” (or overlap) between the channels for the two fluors may be made. For any particular hybridization site on the transcript array, a ratio of the emission of the two fluorophores can be calculated. The ratio is independent of the absolute expression level of the cognate gene, but is useful for genes whose expression is significantly modulated by drug administration, gene deletion, or any other tested event.

According to the method of the invention, the relative abundance of an mRNA and/or an exon expressed in an mRNA in two cells or cell lines is scored as perturbed (i.e., the abundance is different in the two sources of mRNA tested) or as not perturbed (i.e., the relative abundance is the same). As used herein, a difference between the two sources of RNA of at least a factor of 25% (e.g., RNA is 25% more abundant in one source than in the other source), more usually 50%, even more often by a factor of 2 (e.g., twice as abundant), 3 (three times as abundant), or 5 (five times as abundant) is scored as perturbation. Present detection methods allow reliable detection of differences of an order of 1.5 fold to 3-fold.

It is, however, also advantageous to determine the magnitude of the relative difference in abundances for an mRNA and/or an exon expressed in an mRNA in two cells or in two cell lines. This can be carried out, as noted above, by calculating the ratio of the emission of the two fluorophores used for differential labeling, or by analogous methods that will be readily apparent to those of skill in the art.

### 5.8.2. Other Methods of Transcriptional State Measurement

The transcriptional state of a cell may be measured by other gene expression technologies known in the art Several such technologies produce pools of restriction fragments of limited complexity for electrophoretic analysis, such as methods combining double restriction enzyme digestion with phasing primers (see, e.g., European Patent 0 534858 A1, filed Sep. 24, 1992, by Zabeau et al.), or methods selecting restriction fragments with sites closest to a defined mRNA end (see, e.g., Prashar et al., 1996, Proc. Natl. Acad Sci. USA 93:659-663). Other methods statistically sample cDNA pools, such as by sequencing sufficient bases (e.g., 20-50 bases) in each of multiple cDNAs to identify each cDNA, or by sequencing short tags (e.g., 9-10 bases) that are generated at known positions relative to a defined mRNA end (see, e.g., Velculescu, 1995, Science 270:484-487).

### 5.9. Measurement of Other Aspects of the Biological State

In various embodiments of the present invention, aspects of the biological state other than the transcriptional state, such as the translational state, the activity state, or mixed aspects can be measured. Thus, in such embodiments, gene expression data can include translational state measurements or even protein expression measurements. In fact, in some embodiments, rather than using gene expression interaction maps based on gene expression, protein expression interaction maps based on protein expression maps are used. Details of embodiments in which aspects of the biological state other than the transcriptional state are described it this section.

### 5.10. Translational State Measurements

Measurement of the translational state may be performed according to several methods. For example, whole genome monitoring of protein (e.g., the “proteome,”) can be carried out by constructing a microarray in which binding sites comprise immobilized, preferably monoclonal, antibodies specific to a plurality of protein species encoded by the cell genome. Preferably, antibodies are present for a substantial fraction of the encoded proteins, or at least for those proteins relevant to the action of a drug of interest. Methods for making monoclonal antibodies are well known (see, e.g., Harlow and Lane, 1988, Antibodies: A Laboratory Manual, Cold Spring Harbor, N.Y., which is incorporated in its entirety for all purposes). In one embodiment, monoclonal antibodies are raised against synthetic peptide fragments designed based on genomic sequence of the cell. With such an antibody array, proteins from the cell are contacted to the array and their binding is assayed with assays known in the art.

Alternatively, proteins can be separated by two-dimensional gel electrophoresis systems. Two-dimensional gel electrophoresis is well-known in the art and typically involves iso-electric focusing along a first dimension followed by SDS-PAGE electrophoresis along a second dimension. See, e.g., Hames et al., 1990, Gel Electrophoresis of Proteins: A Practical Approach, IRL Press, New York; Shevchenko et al., 1996, Proc. Natl. Acad. Sci. USA 93:1440-1445; Sagliocco et al., 1996, Yeast 12:1519-1533; Lander, 1996, Science 274:536-539. The resulting electropherograms can be analyzed by numerous techniques, including mass spectrometric techniques, Western blotting and immunoblot analysis using polyclonal and monoclonal antibodies, and internal and N-terminal micro-sequencing. Using these techniques, it is possible to identify a substantial fraction of all the proteins produced under given physiological conditions, including in cells (e.g., in yeast) exposed to a drug, or in cells modified by, e.g., deletion or over-expression of a specific gene.

### 5.11. Measuring Other Aspects of the Biological State

The methods of the invention are applicable to any cellular constituent that can be monitored. For example, where activities of proteins can be measured, embodiments of this invention can use such measurements. Activity measurements can be performed by any functional, biochemical, or physical means appropriate to the particular activity being characterized. Where the activity involves a chemical transformation, the cellular protein can be contacted with the natural substrate(s), and the rate of transformation measured. Where the activity involves association in multimeric units, for example association of an activated DNA binding complex with DNA, the amount of associated protein or secondary consequences of the association, such as amounts of mRNA transcribed, can be measured. Also, where only a functional activity is known, for example, as in cell cycle control, performance of the function can be observed. However known and measured, the changes in protein activities form the response data analyzed by the foregoing methods of this invention.

In some embodiments of the present invention, cellular constituent measurements are derived from cellular phenotypic techniques. One such cellular phenotypic technique uses cell respiration as a universal reporter. In one embodiment, 96-well microtiter plate, in which each well contains its own unique chemistry is provided. Each unique chemistry is designed to test a particular phenotype. Cells from the organism of interest are pipetted into each well. If the cells exhibits the appropriate phenotype, they will respire and actively reduce a tetrazolium dye, forming a strong purple color. A weak phenotype results in a lighter color. No color means that the cells don't have the specific phenotype. Color changes can be recorded as often as several times each hour. During one incubation, more than 5,000 phenotypes can be tested. See, for example, Bochner et al., 2001, Genome Research 11, p. 1246.

In some embodiments of the present invention, cellular constituent measurements are derived from cellular phenotypic techniques. One such cellular phenotypic technique uses cell respiration as a universal reporter. In one embodiment, 96-well microtiter plates, in which each well contains its own unique chemistry is provided. Each unique chemistry is designed to test a particular phenotype. Cells from the organism 46 (FIG. 1) of interest are pipetted into each well. If the cells exhibit the appropriate phenotype, they will respire and actively reduce a tetrazolium dye, forming a strong purple color. A weak phenotype results in a lighter color. No color means that the cells don't have the specific phenotype. Color changes may be recorded as often as several times each hour. During one incubation, more than 5,000 phenotypes can be tested. See, for example, Bochner et al., 2001, Genome Research 11, 1246-55.

In some embodiments of the present invention, the cellular constituents that are measured are metabolites. Metabolites include, but are not limited to, amino acids, metals, soluble sugars, sugar phosphates, and complex carbohydrates. Such metabolites can be measured, for example, at the whole-cell level using methods such as pyrolysis mass spectrometry (Irwin, 1982, Analytical Pyrolysis: A Comprehensive Guide, Marcel Dekker, New York; Meuzelaar et al., 1982, Pyrolysis Mass Spectrometry of Recent and Fossil Biomaterials, Elsevier, Amsterdam), fourier-transform infrared spectrometry (Griffiths and de Haseth, 1986, Fourier transform infrared spectrometry, John Wiley, New York; Helm et al., 1991, J. Gen. Microbiol. 137, 69-79; Naumann et al., 1991, Nature 351, 81-82; Naumann et al., 1991, In: Modern techniques for rapid microbiological analysis, 43-96, Nelson, W. H., ed., VCH Publishers, New York), Raman spectrometry, gas chromatography-mass spectroscopy (GC-MS) (Fiehn et al., 2000, Nature Biotechnology 18, 1157-1161, capillary electrophoresis (CE)/MS, high pressure liquid chromatography/mass spectroscopy (HPLC/MS), as well as liquid chromatography (LC)-Electrospray and cap-LC-tandem-electrospray mass spectrometries. Such methods can be combined with established chemometric methods that make use of artificial neural networks and genetic programming in order to discriminate between closely related samples.

### 5.12. Exemplary Diseases

As discussed supra, the present invention provides an apparatus and method for associating a gene with a trait exhibited by one or more organisms in a plurality of organisms of a single species. In some instances, the gene is associated with the trait by identifying a biological pathway in which the gene product participates. In some embodiments of the present invention, the trait of interest is a complex trait, such as a disease, e.g., a human disease. Exemplary diseases include asthma, ataxia telangiectasia (Jaspers and Bootsma, 1982, Proc. Natl. Acad. Sci. U.S.A. 79: 2641), bipolar disorder, common cancers, common late-onset Alzheimer's disease, diabetes, heart disease, hereditary early-onset Alzheimer's disease (George-Hyslop et al., 1990, Nature 347: 194), hereditary nonpolyposis colon cancer, hypertension, infection, maturity-onset diabetes of the young (Barbosa et al., 1976, Diabete Metab. 2: 160), mellitus, migraine, nonalcoholic fatty liver (NAFL) (Younossi, et al., 2002, Hepatology 35, 746-752), nonalcoholic steatohepatitis (NASH) (James & Day, 1998, J. Hepatol. 29: 495-501), non-insulin-dependent diabetes mellitus, obesity, polycystic kidney disease (Reeders et al., 1987, Human Genetics 76: 348), psoriases, schizophrenia, steatohepatitis and xeroderma pigmentosum (De Weerd-Kastelein, Nat. New Biol. 238: 80). Genetic heterogeneity hampers genetic mapping, because a chromosomal region may cosegregate with a disease in some families but not in others.

### 5.13. Linkage Analysis

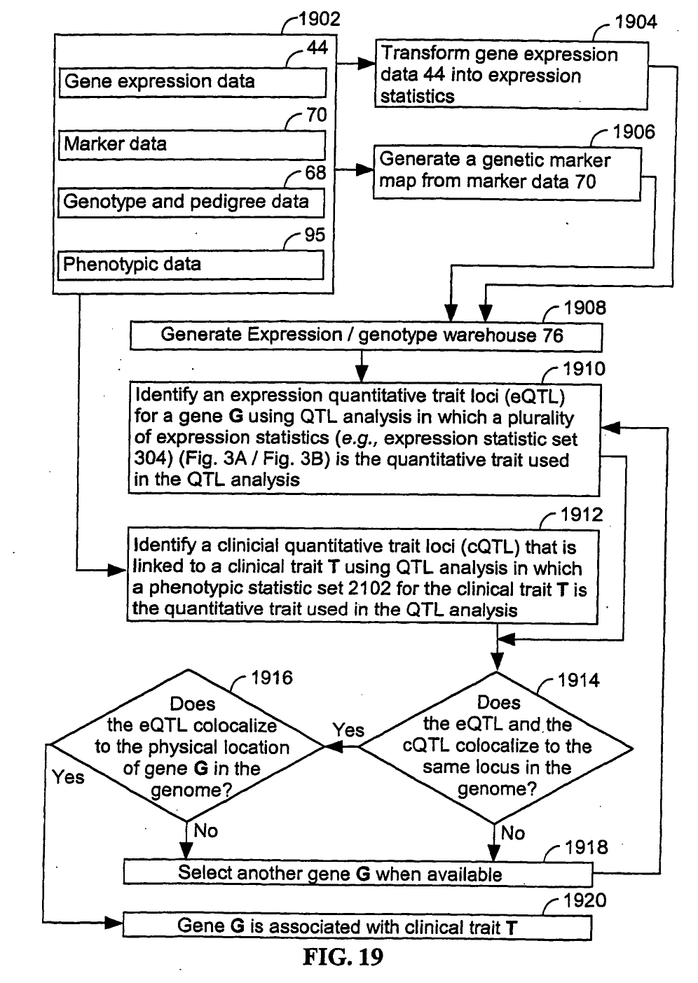

This section describes a number of standard quantitative trait locus (QTL) linkage analysis algorithms that can be used in various embodiments of processing step 210 (FIG. 2) and/or processing step 1910 (FIG. 19). Such linkage analysis is also sometimes referred to as QTL analysis. See, for example, Lynch and Walsch, 1998, Genetics and Analysis of Quantitative Traits, Sinauer Associates, Sunderland, Mass. The primary aim of linkage analysis is to determine whether there exist pieces of the genome that are passed down through each of several families with multiple afflicted organisms in a pattern that is consistent with a particular inheritance model and that is unlikely to occur by chance alone. In other words, the purpose of these algorithms is to identify a loci (e.g. a QTL) for a phenotypic trait exhibited by one or more organisms. A QTL is a region of a genome of a species that is responsible for a percentage of variation in a phenotypic trait in the species under study.

The recombination fraction can be denoted by 8 and is bounded between 0 and 0.5. If θ=0.5 for two loci, then alleles at the two loci are transmitted independently with half of the gametes being recombinant, for the two loci, and half parental. In this case, the loci are unlinked. If θ<0.5, then alleles are not transmitted independently, and the two loci are linked. The extreme scenario is when θ=0, so that the two loci are completely linked, and there will be no recombination between the two loci during meiosis, i.e. all gametes are parental. Linkage analysis tests whether a marker locus, of known location, is linked to a locus of unknown location, that influences the phenotype under study. In other words, a QTL is identified by comparing genotypes of organisms in a group to a phenotype exhibited by the group using pedigree data. The genotype of each organism at each marker in a plurality of markers in a genetic map is compared to a given phenotype of each organism. The genetic map is created by placing genetic markers in genetic (linear) map order so that the positional relationships between markers are understood. The information gained from knowing the relationships between markers that is provided by a marker map provides the setting for addressing the relationship between QTL effect and QTL location.

In some embodiments of the present invention, linkage analysis is based on any of the QTL detection methods disclosed or referenced in Lynch and Walsch, 1998, Genetics and Analyis of Quantitative Traits, Sinauer Associates, Inc., Sunderland, Mass.

### 5.13.1. Phenotypic Data Used

It will be appreciated that the present invention provides no limitation on the type of phenotypic data that can be used to perform QTL analysis. The phenotypic data can, for example, represent a series of measurements for a quantifiable phenotypic trait in a collection of organisms. Such quantifiable phenotypic traits can include, for example, tail length, life span, eye color, size and weight. Alternatively, the phenotypic data can be in a binary form that tracks the absence or presence of some phenotypic trait. As an example, a “1” can indicate that a particular species of the organism of interest possesses a given phenotypic trait and a “0” can indicate that a particular species of the organism of interest lacks the phenotypic trait. The phenotypic trait can be any form of biological data that is representative of the phenotype of each organism in the population under study. In some embodiments, the phenotypic traits are quantified and are often referred to as quantitative phenotypes.

### 5.13.2. Genotypic Data Used

In order to provide the necessary genotypic data for linkage analysis, the genotype of a plurality of markers is determined for each organism in a population under study. Genotypic information is obtained from polymorphisms at each marker in the genetic map. Such polymorphisms include, but are not limited to, single nucleotide polymorphisms, microsatellite markers, restriction fragment length polymorphisms, short tandem repeats, sequence length polymorphisms, and DNA methylation patterns. This data is combined with data, such as pedigree data, to form a genetic map.

Linkage analyses use the genetic map as the framework for location of QTL for any given quantitative trait In some embodiments, the intervals that are defined by ordered pairs of markers are searched in increments (for example, 2 cM), and statistical methods are used to test whether a QTL is likely to be present at the location within the interval. In one embodiment, linkage analysis statistically tests for a single QTL at each increment across the ordered markers in a genetic map. The results of the tests are expressed as lod scores, which compares the evaluation of the likelihood function under a null hypothesis (no QTL) with the alternative hypothesis (QTL at the testing position) for the purpose of locating probable QTL. More details on lod scores are found in Section 5.4, as well as in Lander and Schork, 1994, Science 265, p. 2037-2048. Interval mapping searches through the ordered genetic markers in a systematic, linear (one-dimensional) fashion, testing the same null hypothesis and using the same form of likelihood at each increment.

### 5.13.3. Pedigree Data Used

Linkage analysis requires pedigree data for organisms in the population under study in order to statistically model the segregation of markers. The various forms of linkage analysis can be categorized by the type of population used to generate the pedigree data (inbred versus outbred).

Some forms of linkage analysis use pedigree data for populations that originate from inbred parental lines. The resulting F₁ lines will tend to be heterozygous at all markers and QTL. From the F₁ population, crosses are made. Exemplary crosses include backcrosses, F₂ intercrosses, Fₜ populations (formed by randomly mating F₁s for t-1 generations), F_{2:3} design (F₂ individuals are genotyped and then selfed), Design III (F₂ from two inbred lines are backcrossed to both parental lines). Thus, in some embodiments of the present invention, organisms represent a population, such as an F₂ population, and pedigree data for the F₂ population is known This pedigree data is used to compute logarithm of the odds (lod) scores, as discussed in further detail below.

For many organisms, including humans, manipulatable inbred lines are not available and outbred populations must be used to perform linkage analysis. Linkage analysis using outbred populations detect QTLs responsible for within-population variation whereas linkage analysis using inbred populations detect QTLs responsible for fixed differences between lines, or even different species. Using within-population variation (outbred population), as opposed to fixed differences between populations (inbred population) results in decreased power in QTL detection. With inbred lines, all F₁ parents have identical genotypes (including the same linkage phase), so all individuals are informative, and linkage disequilibrium is maximized. As with inbred lines, a variety of designs have been proposed for obtaining samples with linkage disequilibrium required for linkage analysis. Typically, collections of relatives are relied upon.

The major difference between QTL analysis using inbred-line crosses versus outbred populations is that while the parents in the former are genetically uniform, parents in the latter are genetically variable. This distinction has several consequences. First, only a fraction of the parents from an outbred population are informative. For a parent to provide linkage information, it must be heterozygous at both a marker and a linked QTL, as only in this situation can a marker-trait association be generated in the progeny. Only a fraction of random parents from an outbred population are such double heterozygotes. With inbred lines, F₁'s are heterozygous at all loci that differ between the crossed lines, so that all parents are fully informative. Second, there are only two alleles segregating at any locus in an inbred-line cross design, while outbred populations can be segregating any number of alleles. Finally, in an outbred population, individuals can differ in marker-QTL linkage phase, so that an M-bearing gamete might by associated with QTL allele Q in one parent, and with q in another. Thus, with outbred populations, marker-trait associations might be examined separately for each parent. With inbred-line crosses, all F₁ parents have identical genotypes (including linkage phase), so one can average marker-trait associations over all off-spring, regardless of their parents. See Lynch and Walsh, Genetics and Analysis of Quantitative Traits, Sinauer Associates, Sunderland, Mass.

### 5.13.4. Model Free Versus Model Based Linkage Analysis

Linkage analyses can generally be divided into two classes: model-based linkage analysis and model-free linkage analysis. Model-based linkage analysis assumes a model for the mode of inheritance whereas model-free linkage analysis does not assume a mode of inheritance. Model-free linkage analyses are also known as allele-sharing methods and non-parametric linkage methods. Model-based linkage analyses are also known as “maximum likelihood” and “lod score” methods. Either form of linkage analysis can be used in the present invention.

Model-based linkage analysis is most often used for dichotomous traits and requires assumptions for the trait model. These assumptions include the disease allele frequency and penetrance function. For a disease trait particularly those of interest to public health, the true underlying model is complex and unknown, so that these procedures are not applicable. The other form of linkage analysis (model-free linkage analysis) makes use of allele-sharing. Allele-sharing methods rely on the idea that relatives with similar phenotypes should have similar genotypes at a marker locus if and only if the marker is linked to the locus of interest. Linkage analyses are able to localize the locus of interest to a specific region of a chromosome, and the scope of resolution is typically limited to no less than 5 cM or roughly 5000 kb. For more information on model-based and model-free linkage analysis, see Olson et al., 1999, Statistics in Medicine 18, p. 2961-2981; Lander and Schork 1994, Science 265, p. 2037; and Elston, 1998, Genetic Epidemiology 15, p. 565, as well as the sections below.

### 5.13.5. Known Programs for Performing Linkage Analysis

Many known programs can be used to perform linkage analysis in accordance with this aspect of the invention. One such program is MapMaker/QTL, which is the companion program to MapMaker and is the original QTL mapping software. MapMaker/QTL analyzes F₂ or backcross data using standard interval mapping. Another such program is QTL Cartographer, which performs single-marker regression, interval mapping (Lander and Botstein, Id.), multiple interval mapping and composite interval mapping (Zeng, 1993, PNAS 90: 10972-10976; and Zeng, 1994, Genetics 136: 1457-1468). QTL Cartographer permits analysis from F₂ or backcross populations. QTL Cartographer is available from http://statgen.ncsu.edu/qtlcart/cartographer.html (North Carolina State University). Another program that can be used by processing step 114 is Qgene, which performs QTL mapping by either single-marker regression or interval regression (Martinez and Curnow 1994 Heredity 73:198-206). Using Qgene, eleven different population types (all derived from inbreeding) can be analyzed. Qgene is available from http.//www.qgene.org/. Yet another program is MapQTL, which conducts standard interval mapping (Lander and Botstein, Id.), multiple QTL mapping (MQM) (Jansen, 1993, Genetics 135: 205-211; Jansen, 1994, Genetics 138: 871-881), and nonparametric mapping (Kruskal-Wallis rank sum test). MapQTL can analyze a variety of pedigree types including outbred pedigrees (cross pollinators). MapQTL is available from Plant Research International, Plant Research International, P.O. Box 16, 6700 AA Wageningen, The Netherlands; http://www.plant.wageningen-ur.nl/default.asp?section=:products). Yet another program that may be used in some embodiments of processing step 210 is Map Manager QT, which is a QTL mapping program (Manly and Olson, 1999, Mamm Genome 10: 327-334). Map Manager QT conducts single-marker regression analysis, regression-based simple interval mapping (Haley and Knott, 1992, Heredity 69, 315-324), composite interval mapping (Zeng 1993, PNAS 90: 10972-10976), and permutation tests. A description of Map Manager QT is provided by the reference Manly and Olson, 1999, Overview of QTL mapping software and introduction to Map Manager QT, Mammalian Genome 10: 327-334.

Yet another program that can be used to perform linkage analysis is MultiCross QTL, which maps QTL from crosses originating from inbred lines. MultiCross QTL uses a linear regression-model approach and handles different methods such as interval mapping, all-marker mapping, and multiple QTL mapping with cofactors. The program can handle a wide variety of simple mapping populations for inbred and outbred species. MultiCross QTL is available from Unite de Biométrie et Intelligence Artificielle, INRA, 31326 Castanet Tolosan, France.

Still another program that can be used to perform linkage analysis is QTL Café. The program can analyze most populations derived from pure line crosses such as F₂ crosses, backcrosses, recombinant inbred lines, and doubled haploid lines. QTL Café incorporates a Java implementation of Haley & Knotts' flanking marker regression as well as Marker regression, and can handle multiple QTLs. The program allows three types of QTL analysis single marker ANOVA, marker regression (Kearsey and Hyne, 1994, Theor. Appl. Genet., 89: 698-702), and interval mapping by regression, (Haley and Knott, 1992, Heredity 69: 315-324). QTL Café is available from http://web.bham.ac.uk/g.g.seaton/.

Yet another program that can be used to perform linkage analysis is MAPL, which performs QTL analysis by either interval mapping (Hayashi and Ukai, 1994, Theor. Appl.

Genet. 87:1021-1027) or analysis of variance. Different population types including F₂, back-cross, recombinant inbreds derived from F₂ or back-cross after a given generations of selfing can be analyzed. Automatic grouping and ordering of numerous markers by metric multidimensional scaling is possible. MAPL is available from the Institute of Statistical Genetics on Internet (ISGI), Yasuo, UKAI, http://web.bham.ac.uk/g.g.seaton/.

Another program that can be used for linkage analysis is R/qtl. This program provides an interactive environment for mapping QTLs in experimental crosses. R/qtl makes uses of the hidden Markov model (HMM) technology for dealing with missing genotype data R/qtl has implemented many HMM algorithms, with allowance for the presence of genotyping errors, for backcrosses, intercrosses, and phase-known four-way crosses. R/qtl includes facilities for estimating genetic maps, identifying genotyping errors, and performing single-QTL genome scans and two-QTL, two-dimensional genome scans, by interval mapping with Haley-Knott regression, and multiple imputation. R/qtl is available from Karl W. Broman, Johns Hopkins University, http://biosun01.biostat.jhsph.edu/˜kbroman/qtl/.

Those of skill in the art will appreciate that there are several other programs and algorithms that can be used in the steps of the methods of the present invention where quantitative genetic analysis is needed, and all such programs and algorithms are within the scope of the present invention.

### 5.13.6. Model-Based Parametric Linkage Analysis

In model-based linkage analysis, (also termed “lod score” methods or parametric methods), the details of a traits mode of inheritance is being modeled. Typically, particular values of the allele frequencies and the penetrance function are specified.

### 5.13.6.1. Interval Mapping via Maximum Likelihood/Inbred Population

In one embodiment of the present invention, linkage analysis comprises QTL interval mapping in accordance with algorithms derived from those first proposed by Lander and Botstein, 1989, “Mapping Mendelian factors underlying quantitative traits using RFLP linkage maps,” Genetics 121: 185-199. The principle behind interval mapping is to test a model for the presence of a QTL at many positions between two mapped marker loci. The model is fit, and its goodness is tested using a technique such as the maximum likelihood method. Maximum likelihood theory assumes that when a QTL is located between two biallelic markers, the genotypes (i.e. AABB, AAbb, aaBB, aabb for doubled haploid progeny) each contain mixtures of quantitative trait locus (QTL) genotypes. Maximum likelihood involves searching for QTL parameters that give the best approximation for quantitative trait distributions that are observed for each marker class. Models are evaluated by computing the likelihood of the observed distributions with and without fitting a QTL effect.

In some embodiments of the present invention, linkage analysis is performed using the algorithm of Lander, as implemented in programs such as GeneHunter. See, for example, Kruglyak et al., 1996, Parametric and Nonparametric Linkage Analysis: A Unified Multipoint Approach, American Journal of Human Genetics 58:1347-1363, Kruglyak and Lander, 1998, Journal of Computational Biology 5:1-7; Kruglyak, 1996, American Journal of Human Genetics 58, 1347-1363. In such embodiments, unlimited markers may be used but pedigree size is constrained due to computational limitations. In other embodiments, the MENDEL software package is used. (See http://bimas.dcrt.nih.gov/linkage/ltools.html). In such embodiments, the size of the pedigree can be unlimited but the number of markers that can be used in constrained due to computational limitations. The techniques described in this Section typically require an inbred population.

### 5.13.6.2. Interval Mapping Using Linear Regression/Inbred Population

In some embodiments of the present invention, interval mapping is based on regression methodology and gives estimates of QTL position and effect that are similar to those given by the maximum likelihood method. Since the QTL genotypes are unknown in mapping based on regression methodology, genotypes are replaced by probabilities estimated using genotypes at the nearest flanking markers or for all linked markers. See, e.g., Haley and Knott, 1992, Heredity 69, 315-324; and Jiang and Zeng, 1997, Genetica 101:47-58. The techniques described in this Section typically require an inbred population.

### 5.13.7. Model-Free Nonparametric Linkage Analysis

Model-based linkage analysis (classical linkage analysis) calculates a lod score that represents the chance that a given loci in the genome is genetically linked to a trait, assuming a specific mode of inheritance for the trait Namely the allele frequencies and penetrance values are included as parameters and are subsequently estimated. In the case of complex diseases, it is often difficult to model with any certainty all the causes of familial aggregation. In other words, when the trait exhibits non-Mendelian segregation it can be difficult to obtain reliable estimates of penetrance values, including phenocopy risks, and the allele frequency of the disease mutation. Indeed it can be the case that different mutations at different loci have different kinds of effect on susceptibility, some major and some minor, some dominant and some recessive. If different modes of transmission are operative in different families, or if different loci interact in the same family, then no one transmission model may be appropriate. It is conceivable that if the transmission model for a linkage analysis is specified incorrectly the results produced from it will not be valid nor interpretable.

As a result of the difficulties described above, a variety of methods have been developed to test for linkage without the need to specify values for the parameters defining the transmission model, and these methods are termed model-free linkage analyses (meaning that they can be applied without regard to the true transmission model). Such methods are based on the premise that relatives who are similar with respect to the phenotype of interest will be similar at a marker locus, sharing identical marker alleles, only if a locus underlying the phenotype is linked to the marker.

Model-free linkage analyses (allele-sharing methods) are not based on constructing a model, but rather on rejecting a model. Specifically, one tries to prove that the inheritance pattern of a chromosomal region is not consistent with random Mendelian segregation by showing that affected relatives inherit identical copies of the region more often then expected by chance. Affected relatives should show excess allele sharing in regions linked to the QTL even in the presence of incomplete penetrance, phenocopy, genetic heterogeneity, and high-frequency disease alleles.

### 5.13.7.1. Identical by Descent—Affected Pedigree Member (IBD-APM) Analysis/Outbred Population

In one embodiment, nonparametric linkage analysis involves studying affected relatives 246 (FIG. 1) in a pedigree 310 to see how often a particular copy of a chromosomal region is shared identical-by descent (IBD), that is, is inherited from a common ancestor within the pedigree. The frequency of IBD sharing at a locus can then be compared with random expectation. An identity-by-descent affected-pedigree-member (ID-APM) statistic can be defined as:

$$T ( s ) = {\sum }_{i , j} xij ( s ) .$$

where xᵢⱼ(s) is the number of copies shared IBD at position s along a chromosome, and where the sum is taken over all distinct pairs (ij) of affected relatives 246 in a pedigree 310. The results from multiple families can be combined in a weighted sum T(s). Assuming random segregation, T(s) tends to a normal distribution with a mean μ and a variance σ that can be calculated on the basis of the kinship coefficients of the relatives compared. See, for example, Blackwelder and Elston, 1985, Genet. Epidemiol. 2, p. 85; Whittemore and Halpern, 1994, Biometrics 50, p. 118; Weeks and Lange, 1988, Am. J. Hum. Genet. 42, p. 315; and Elston, 1998, Genetic Epidemiology 15, p. 565. Deviation from random segregation is detected when the statistic (T−μ)/σ exceeds a critical threshold The techniques in this section typically use an outbred population.

### 5.13.7.2. Affected SIB Pair Analysis/Outbred Population

Affected sib pair analysis is one form of IBD-APM analysis (Section 5.13.7.1). For example, two sibs can show IBD sharing for zero, one, or two copies of any locus (with a 25%-50%-25% distribution expected under random segregation). If both parents are available, the data can be partitioned into separate MBD sharing for the maternal and paternal chromosome (zero or one copy, with a 50%-50% distribution expected under random segregation). In either case, excess allele sharing can be measured with a x test. ID the ASP approach, a large number of small pedigrees (affected siblings and their parents) are used. DNA samples are collected from each organism and genotyped using a large collection of markers (e.g., microsatellites, SNPs). Then a check for fictional polymorphism is performed. See, for example, Suarez et al., 1978, Ann. Hum. Genet. 42, p. 87; Weitkamp, 1981, N. Engl. J. Med. 305, p. 1301; Knapp et al., 1994, Hum. Hered. 44, p. 37; Holmans, 1993, Am. J. Hum. Genet. 52, p. 362; Rich et al., 1991, Diabetologica 34, p. 350; Owerbach and Gabbay, 1994, Am. J. Hum. Genet. 54, p. 909; and Berrettini et al., Proc. Natl. Acad. Sci. USA 91, p. 5918. For more information on Sib pair analysis, see Hamer et al., 1993, Science 261, p. 321.

In some embodiments, ASP statistics that test whether affected siblings pairs have a mean proportion of marker genes identical-by-descent that is >0.50 were computed. See, for example, Blackwelder and Elston, 1985, Genet. Epidemiol. 2, p. 85. In some embodiments, such statistics are computed using the SIBPAL program of the SAGE package. See, for example, Tran et al. 1991, (SIB-PAL) Sib-pair linkage program (Elston, New Orleans), Version 2.5. These statistics are computed on all possible affected pairs. In some embodiments the number of degrees of freedom of the t test is set at the number of independent affected pairs (defined per sibship as the number of affected individuals minus 1) in the sample instead of the number of all possible pairs. See, for example, Suarez and Eerdewegh, 1984, Am. J. Med. Genet. 18, p. 135. The techniques in this section typically use an outbred population.

### 5.13.7.3. Identical by State—Affected Pedigree Member (IBS-APM) Analysis/Outbred Population

In some instances, it is not possible to tell whether two relatives inherited a chromosomal region IBD, but only whether they have the same alleles at genetic markers in the region, that is, are identical by state (IBS). IBD can be inferred from IBS when a dense collection of highly polymorphic markers has been examined, but the early stages of genetic analysis can involve sparser maps with less informative markers so that IBD status can not be determined exactly. Various methods are available to handle situations in which IBD cannot be inferred from IBS. One method infers IBD sharing on the basis of the marker data (expected identity by descent affected-pedigree-member; IBD-APM). See, for example, Suarez et al., 1978, Ann Hum. Genet. 42, p. 87; and Amos et al., 1990, Am J. Hum. Genet. 47, p. 842. Another method uses a statistic that is based explicitly on IBS sharing (an IBS-APM method). See, for example, Weeks and Lange, 1988, Am J. Hum. Genet. 42, p. 315; Lange, 1986, Am. J. Hum. Genet. 39, p. 148; Jeunemaitre et al., 1992, Cell 71, p. 169; and Pericak-Vance et al., 1991, Am. J. Hum. Genet. 48, p. 1034.

In one embodiment the E3S-APM techniques of Weeks and Lange, 1988, Am J. Hum. Genet. 42, p. 315; and Weeks and Lange, 1992, Am. J. Hum. Genet. 50, p. 859 are used. Such techniques use marker information of affected individuals to test whether the affected persons within a pedigree are more similar to each other at the marker locus than would be expected by chance. In some embodiments, the marker similarity is measured in terms of identity by state. In some embodiments, the APM method uses a marker allele frequency weighting function, ƒ(p), where p is the allele frequency, and the APM test statistics are presented separately for each of three different weighting functions, ƒ(p)=1, ƒ(p)=1/\sqrt{p}, and ƒ(p)=1/p. Whereas the second and third functions render the sharing of a rare allele among affected persons a more significant event, the first weighting function uses the allele frequencies only in calculation of the expected degree of marker allele sharing. The third function, ƒ(p)=1/p, can lead (more frequently than the first two) to a non-normal distribution of the test statistic. The second function is a reasonable compromise for generating a normal distribution of the test statistic while incorporating an allele frequency function. In some instances, the APM test statistics are sensitive to marker locus and allele frequency misspecification. See, for example, Babron, et al, 1993, Genet. Epidemiol. 10, p. 389. In some embodiments, allele frequencies are estimated from the pedigree data using the method of Boehnke, 1991, Am J. Hum. Genet. 48, p. 22, or by studying alleles. See, also, for example, Berrettini et at., 1994, Proc. Natl. Acad. Sci. USA 91, p. 5918.

In some embodiments,-the significance of the APM test statistics is calculated from the theoretical (normal) distribution of the statistic. In addition, numerous replicates (e.g., 10,000) of these data, assuming independent inheritance of marker alleles and disease (i.e., no linkage), are simulated to assess the probability of observing the actual results (or a more extreme statistic) by chance. This probability is the empirical P value. Each replicate is generated by simulating an unlinked marker segregating through the actual pedigrees. An APM statistic is generated by analyzing the simulated dat set exactly as the actual data set is analyzed. The rank of the observed statistic in the distribution of the simulated statistics determines the empirical P value. The techniques in this section typically use an outbred population.

### 5.13.7.4. Quantitative Traits

Model-free linkage analysis can also be applied to quantitative traits. An approach proposed by Haseman and Elston, 1972, Behav. Genet 2, p. 3, is based on the notion that the phenotypic similarity between two relatives should be correlated with the number of alleles shared at a trait-causing locus. Formally, one performs regression analysis of the squared difference Δ² in a trait between two relatives and the number x of alleles shared IBD at a locus. The approach can be suitably generalized to other relatives (Blackwelder and Elston, 1982, Commun Stat. Theor. Methods 11, p. 449) and multivariate phenotypes (Amos et al., 1986, Genet. Epidemiol. 3, p. 255). See also, Marsh et al., 1994, Science 264, p. 1152, and Morrison et al., 1994, Nature 367, p. 284; Amos, 1994, Am. J. Hum Genet. 54, p. 535; and Elston, Am J. Hun Genet. 63, p. 931.

### 5.14. Association Analysis

This section describes a number of association tests that can be used in the present invention. Association studies can be done with samples of pedigrees or samples of unrelated individuals. Further, association studies can be done for a dichotomous trait (e.g., disease) or a quantitative trait. See, for example, Nepom and Ehrlich, 1991, Annu. Rev. Immunol. 9, p. 493; Strittmatter and Roses, 1996, Annu. Rev. Neurosci. 19, p. 53; Vooberg et al., 1994, Lancet 343, p. 1535; Zoller et al., Lancet 343, p. 1536; Bennet et al., 1995, Nature Genet. 9, p. 284; Grant et al., 1996, Nature Genet. 14, p. 205; and Smith et al., 1997, Science 277, p. 959. As such, association studies test whether a disease and an allele show correlated occurrence across the population, whereas linkage studies determine whether there is correlated transmission within pedigrees.

Whereas linkage analysis involves the pattern of transmission of gametes from one generation to the next, association is a property of the population of gametes. Association exists between alleles at two loci if the frequency, with which they occur within the same gamete, is different from the product of the allele frequencies. If this association occurs between two linked loci, then utilizing the association will allow for fine localization, since the strength of association is in large part due to historical recombinations rather than recombination within a few generations of a family. In the simplest scenario, association arises when a mutation, which causes disease, occurs at a locus at some time, to. At that time, the disease mutation occurs on a specific genetic background composed of the alleles at all other loci; thus, the disease mutation is completely associated with the alleles of this background. As time progresses, recombination occurs between the disease locus and all other loci, causing the association to diminish Loci that are closer to the disease locus will generally have higher levels of association, with association rapidly dropping off for markers further away. The reliance of association on evolutionary history can provide localization to a region as small as 50-75 kb. Association is also called linkage disequilibrium. Association (linkage disequilibrium) can exist between alleles at two loci without the loci being linked.

Two forms of association analysis are discussed in the sections below, population based association analysis and family based association analysis. More generally, those of skill in the art with appreciate that there are several different forms of association analysis, and all such forms of association analysis can be used in steps of the present invention that require the use of quantitative genetic analysis.

In some embodiments, whole genome association studies are performed in accordance with the present invention. Two methods can be used to perform whole-genome association studies, the “direct-study” approach and the “indirect-study” approach. In the direct-study approach, all common functional variants of a given gene are catalogued and tested directly to determine whether there is an increased prevalence (association) of a particular functional variant in affected individuals within the coding region of the given gene. The “indirect-study” approach uses a very dense marker map that is arrayed across both coding and noncoding regions. A dense panel of polymorphisms (e.g., SNPs) from such a map can be tested in controls to identify associations that narrowly locate the neighborhood of a susceptibility or resistance gene. This strategy is based on the hypothesis that each sequence variant that causes disease must have arisen in a particular individual at some time in the past, so the specific alleles for polymorphisms (haplotype) in the neighborhood of the altered gene in that individual can be inherited in all of his or her descendants. The presence of a recognizable ancestral haplotype therefore becomes an indicator of the disease-associated polymorphism. In actuality, some of the alleles will be in association while others will not due to recombination occurring between the mutation and other polymorphisms.

### 5.14.1. Population-Based (Model-Free) Association Analysis

In population-based (model-free) association studies, allele frequencies in afflicted organisms are contrasted with allele frequencies in control organisms in order to determine if there is an association between a particular allele and a complex trait. Population-based association studies for dichotomous traits are also referred to as case-control studies. A case-control study is based on the comparison of unrelated affected and unaffected individuals from a population. An allele A at a gene of interest is said to be associated with the phenotype if it occurs at significantly higher frequency among affected compared with control individuals. Statistical significance can be tested by a number a methods, including, but not limited to, logistic regression. Association studies are discussed in Lander, 1996, Science 274, 536; Lander and Schork, 1994, Science 265, 2037; Risch and Merikangas, 1996, Science 273, 1516; and Collins et al., 1997, Science 278, 1533.

As is true for case-control studies generally, confounding is a problem for inferring a causal relationship between a disease and a measured risk factor using population-based association analysis. One approach to deal with confounding is the matched case-control design, where individual controls are matched to cases on potential confounding factors (for example, age and sex) and the matched pairs are then examined individually for the risk factor to see if it occurs more frequently in the case than in its matched control. In some embodiments, cases and controls are ethnically comparable. In other words, homogeneous and randomly mating populations are used in the association analysis. In some embodiments, the family-based association studies described below are used to minimize the effects of confounding due to genetically heterogeneous populations. See, for example, Risch, 2000, Nature 405, p. 847.

### 5.14.2. Family-Based Association Analysis

Family-based association analysis is used in some embodiments of the invention In some embodiments, each affected organism is matched with one or more unaffected siblings (see, for example, Curtis, 1997, Ann. Hum. Genet. 61, p. 319) or cousins (see, for example, Witte, et al., 1999, Am J. Epidemiol. 149, p. 693) and analytical techniques for matched case-control studies is used to estimate effects and to test a hypotheses. See, for example, Breslow and Day, 1989, Statistical methods in cancer research I, The analysis of case-control studies 32, Lyon: IARC Scientific Publications. The following subsections describe some forms of family-based association studies. Those of skill in the art will recognize that there are numerous forms of family-based association studies and all such methodologies can be used in the present invention.

### 5.14.2.1. Haplotype Relative Risk Test

In some embodiments, the haplotype relative risk test is used. In the haplotype relative risk method, all marker alleles compared arise from the same person. The marker alleles that parents transmit to an affected offspring (case alleles) are compared with those that they do not transmit to such an offspring (control alleles). One can also compare transmitted and nontransmitted genotypes. Consider the 2n parents of n affected persons. This population can be classified into a fourfold table according to whether the transmitted allele is a marker allele (M) or some other allele \overline{M} and according to whether the nontransmitted allele is similarly M or \overline{M}:

| | Nontransmitted allele | | |
|---|---|---|---|
| Transmitted allele | M | \overline{M} | Total |
| M | a | b | a + b |
| \overline{M} | c | d | c + d |
| | a + c | b + d | 2n = a + b + c + d |

To test for association, a determination is made as to whether the proportion of M alleles that are transmitted, a/(a+b), differs significantly from the proportion of M alleles that are nontransmitted, a/(a+c). One appropriate statistical test for this determination is comparison of (b−c)²/(b+c) to a chi-square distribution with one degree of freedom when the sample is large.

The row totals for the table above are the numbers of transmitted alleles that are M and \overline{M}, while the column totals are the numbers of nontransmitted alleles that are M and \overline{M}. These four totals can be put into a fourfold table that classifies the 4n parental alleles, rather than the 2n parents:

| Marker allele | Transmitted | Non-transmitted | Total |
|---|---|---|---|
| M | a + b | a + c | 2a + b + c |
| \overline{M} | c + d | b + d | b + c + 2d |
| Total | 2n | 2n | 4n |

The haplotype relative risk ratio is defined as (a+b)(c+d)/(a+c)(c+d). A chi-square distribution using one degree of freedom can be used to determine whether the haplotype relative risk ratio differs significantly from one. See, for example, Rudorfer, et al., 1984, Br. J. Clin. Pharmacol. 17, 433; Mueller and Young, 1997, Emery's Elements of Medical Genetics, Kalow ed., p. 169-175, Churchill Livingstone, Edinburgh; and Roses, 2000, Nature 405, p. 857, Elson, 1998, Genetic Epidemilogy, 15, p. 565.

### 5.14.2.2. Transmission Equilibrium Test

In some embodiments, the transmission equilibrium test (TDT) is used. TDT considers parents who are heterozygous for an allele and evaluates the frequency with which that allele is transmitted to affected offspring. By restriction to heterozygous parents, the TDT differs from other model-free tests for association between specific alleles of a polymorphic marker and a disease locus. The parameters of that locus, genotypes of sampled individuals, linkage phase, and recombination frequency are not specified. Nevertheless, by considering only heterozygous parents, the TDT is specific for association between linked loci.

TDT is a test of linkage and association that is valid in heterogeneous populations. It was originally proposed for data consisting of families ascertained due to the presence of a diseased child. The genetic data consists of the marker genotypes for the parents and child. The TDT is based on transmissions, to the diseased child, from heterozygous parents, or parents whose genotypes consist of different alleles. In particular, consider a biallelic marker with alleles M₁ and M₂. The TDT counts the number of times, n₁₂, that M₁M₂ parents transmit marker allele M₁ to the diseased child and the number of times, n₂₁, that M₂ is transmitted. If the marker is not linked to the disease locus, i.e. θ=0.5, or if there is no association between M₁ and the disease mutation, then conditional on the number of heterozygous parents, and in the absence of segregation distortion, n₁₂ is distributed binomially: B(n₁₂+n₂₁, 0.5). The null hypothesis of no linkage or no association can be tested with the statistic

$${T}_{TDT} = \frac{{( {n}_{12} - {n}_{21} )}^{2}}{{n}_{12} + {n}_{21}}$$

with statistical significance level approximated using the χ2 distribution with one df or computed exactly with the binomial distribution. When transmissions from more than one diseased child per family are included in the TDT statistic, the test is valid only as a test of linkage.

Several extensions of the TDT test have been proposed and all such extensions are within the scope of the present invention. See, for example, Mortin and Collins, 1998, Proc. Natl. Acad. Sci. USA 95, p. 11389; Terwilliger, 1995, Am J Hum Genet 56, p. 777. See also, for example, Mueller and Young, 1997, Emery's Elements of Medical Genetics, Kalow ed., p. 169-175, Churchill Livingstone, Edinburgh; Zhao et al., 1998, Am. J. Hum. Genet. 63, p. 225; Roses, 2000, Nature 405, p. 857; Spielman et al., 1993, Am J. Hum. Genet. 52, p. 506; and Ewens and Spielman; Am. H. Hum. Genet. 57, p. 455.

### 5.14.2.3. Sibship-Based Test

In some embodiments, the sibship-based test is used. See, for example, Wiley, 1998, Cur. Pharmaceut. Des. 4, p. 417; Blackstock and Weir, 1999, Trends Biotechnol. 17, p. 121; Kozian and Kirschbaum, 1999, Trends Biotechnol. 17, p. 73; Rockett et al., Xenobiotica 29, p. 655; Roses, 1994, J. Neuropathol. Exp. Neurol 53, p. 429; and Roses, 2000, Nature 405, p. 857.

### 5.15. Complex Traits

In some embodiments of the present invention, the term “complex trait” refers to any clinical trait T that does not exhibit classic Mendelian inheritance. In some embodiments, the term “complex trait” refers to a trait that is affected by two or more gene loci. In some embodiments, the term “complex trait” refers to a trait that is affected by two or more gene loci in addition to one or more factors including, but not limited to, age, sex, habits, and environment. See, for example, Lander and Schork, 1994, Science 265: 2037. Such “complex” traits include, but are not limited to, susceptibilities to heart disease, hypertension, diabetes; obesity, cancer, and infection. Complex traits arise when the simple correspondence between genotype and phenotype breaks down, either because the same genotype can result in different phenotypes (due to the effect of chance, environment, or interaction with other genes) or different genotypes can result in the same phenotype.

In some embodiments, a complex trait is one in which there exists no genetic marker that shows perfect cosegregation with the trait due to incomplete penetrance, phenocopy, and/or nongenetic factors (e.g., age, sex, environment, and affect or other genes). Incomplete penetrance means that some individuals who inherit a predisposing allele may not manifest the disease. Phenocopy means that some individuals who inherit no predisposing allele may nonetheless get the disease as a result of environmental or random causes. Thus, the genotype at a given locus may affect the probability of disease, but not fully determine the outcome. The penetrance function ƒ(G), specifying the probability of disease for each genotype G, may also depend on nongenetic factors such as age, sex, environment, and other genes. For example, the risk of breast cancer by ages 40, 55, and 80 is 37%, 66%, and 85% in a woman carrying a mutation at the BCRA1 locus as compared with 0.4%, 3%, and 8% in a noncarer (Easton et al., 1993, Cancer Surv. 18: 1995; Ford et al., 1994, Lancet 343: 692). In such cases, genetic mapping is hampered by the fact that a predisposing allele may be present in some unaffected individuals or absent in some affected individuals.

In some embodiments a complex trait arises because any one of several genes may result in identical phenotypes (genetic heterogeneity). In cases where there is genetic heterogeneity, it may be difficult to determine whether two patients suffer from the same disease for different genetic reasons until the genes are mapped. Examples of complex diseases that arise due to genetic heterogeneity in humans include polycystic kidney disease (Reeders et al., 1987, Human Genetics 76: 348), early-onset Alzheimer's disease (George-Hyslop et al., 1990, Nature 347: 194), maturity-onset diabetes of the young (Barbosa et al., 1976, Diabete Metab. 2: 160), hereditary nonpolyposis colon cancer (Fishel et al., 1993, Cell 75: 1027) ataxia telangiectasia (Jaspers and Bootsma, 1982, Proc. Natl. Acad. Sci. U.S.A. 79: 2641), obesity, nonalcoholic steatohepatitis (NASH) (James & Day, 1998, J. Hepatol. 29: 495-501), nonalcoholic fatty liver (NAFL) (Younossi, et al., 2002, Hepatology 35, 746-752), and xeroderma pigmentosum (e Weerd-Kastelein, Nat. New Biol. 238: 80). Genetic heterogeneity hampers genetic mapping, because a chromosomal region may cosegregate with a disease in some families but not in others.

In still other embodiments, a complex trait arises due to the phenomenon of polygenic inheritance. Polygenic inheritance arises when a trait requires the simultaneous presence of mutations in multiple genes. An example of polygenic inheritance in humans is one form of retinitis pigmentosa, which requires the presence of heterozygous mutations at the perpherin/RDS and ROM1 genes (Kajiwara et al., 1994, Science 264: 1604). It is believed that the proteins coded by RDS and ROM1 are thought to interact in the photoreceptor outer pigment disc membranes. Polygenic inheritance complicates genetic mapping, because no single locus is strictly required to produce a discrete trait or a high value of a quantitative trait.

In yet other embodiments, a complex trait arises due to a high frequency of disease-causing allele “D”. A high frequency of disease-causing allele will cause difficulties in mapping even a simple trait if the disease-causing allele occurs at high frequency in the population. That is because the expected Mendelian inheritance pattern of disease will be confounded by the problem that multiple independent copies of D may be segregating in the pedigree and that some individuals may be homozygous for D, in which case one will not observe linkage between D and a specific allele at a nearby genetic marker, because either of the two homologous chromosomes could be passed to an affected offspring. Late-onset Alzheimer's disease provides one example of the problems raised by high frequency disease-causing alleles. Initial linkage studies found weak evidence of linkage to chromosome 19q, but they were dismissed by many observers because the lod score (logarithm of the likelihood ratio for linkage) remained relatively low, and it was difficult to pinpoint the linkage with any precision (Pericak-Vance et al., 1991, Am J. Hum. Genet. 48: 1034). The confusion was finally resolved with the discovery that the apolipoprotein E type 4 allele appears to be the major causative factor on chromosome 19. The high frequency of the allele (16% in most populations) had interfered with the traditional linkage analysis (Corder et al., 1993, Science 261: 921). High frequency of disease-causing alleles becomes an even greater problem if genetic heterogeneity is present.

### 5.16. Algorithms for Elucidating Genes that Affect a Complex-Trait

The present invention provides additional methods for associating a gene with a complex trait. FIG. 19, discloses one such method.

Step 1902. Referring to FIG. 19, the first step is to assemble starting data (step 1902). The starting data includes the gene expression data 44, marker data 70, and genotype and pedigree data 68 as described in Section 5.1 in conjunction with FIG. 1. In some embodiments, rather than using gene expression data 44, data such as protein expression levels, or some other cellular constituent levels, in a plurality of organisms under study is used. In some embodiments, gene expression data 44 is collected from multiple different tissue types. In addition, in some embodiments, phenotypic data is gathered in step 1902. The phenotypic data 95 differs from gene expression data 44 in the sense that phenotypic data 95 includes quantitative measurements of traits other than cellular constituent quantities (e.g., classical phenotypes). Thus in mice, for example, phenotypic data 95 can include data for clinical traits such as subcutaneous fat pad mass, perimetrial fat pad mass, omental fat pad mass, and adopisity. In plants, for example, phenotypic data 95 can include data for clinical traits such as barren plants, brittle stalks, yield, disease resistance, drydown, early growth, growing degree units (GDU), GDU to physical maturity, GDU to shed, GDU to silk, harvest moisture, plant height, protein rating, root lodging, seedling vigor, grain composition amino acids, and grain composition carbohydrates. These clinical traits are defined in U.S. Pat. No. 6,368,806 to Openshaw et al. Those of skill in the art will appreciate that there are a large number of other possible clinical traits and all such traits are within the scope of the present invention. Such clinical traits can include, but are not limited to, measurements such as life span, presence or absence of a particular disease (e.g. a disease associated with a complex trait), bone density, cholesterol level, obesity, blood sugar level, eye color, blood type, coordination.

Step 1904. Once starting data are assembled, gene expression data 44 is transformed into a plurality of expression statistics (e.g. expression statistic set 304, FIGS. 3A, 3B) for gene G. Exemplary expression statistics include, but are not limited to, the mean log ratio, log intensity, or background-corrected intensity for gene G. Each expression statistic (e.g. expression statistic 308, FIG. 3A) represents an expression value for a gene G. In one embodiment, each expression value is a normalized expression level measurement for gene G in an organism in a plurality of organisms under study. In one embodiment, normalization module 72 (FIG. 1) is used to normalize the expression level measurement for gene G. In some embodiments, each expression level measurement is determined by measuring an amount of a cellular constituent encoded by the gene G in one or more cells from an organism in the plurality of organisms. In one embodiment, the amount of the cellular constituent comprises an abundance of an RNA present in one or more cells of the organism. In one embodiment, the abundance of RNA is measured by a method comprising contacting a gene transcript array with the RNA from one or more cells of the organism, or with a nucleic acid derived from the RNA. The gene transcript array comprises a positionally addressable surface with attached nucleic acids or nucleic acid mimics. The nucleic acid mimics are capable of hybridizing with the RNA species or with nucleic acid derived from the RNA species.

In embodiments where the expression level measurement is normalized, any normalization routine may be used Representative normalization routines include, but are not limited to, Z-score of intensity, median intensity, log median intensity, Z-score standard deviation log of intensity, Z-score mean absolute deviation of log intensity calibration DNA gene set, user normalization gene set, ratio median intensity correction, and intensity background correction. Furthermore, combinations of normalization routines may be run. Exemplary normalization routines in accordance with the present invention are disclosed in more detail in Section 5.3, infra.

Step 1906. In addition to the generation of expression statistics from gene expression data 44, a genetic map 78 is generated from marker data 70 (FIG. 1; FIG. 19, step 1906). Typically, genetic map 78 is built from the marker data using genotype probability distributions for the organisms under study. Genotype probability distributions take into account information such as marker information of parents, known genetic distances between markers, and estimated genetic distances between the markers. In one embodiment of the present invention, a genetic map is created using genetic map construction module 74 (FIG. 1).

Generally, a genetic map is constructed from marker data 70 associated with a plurality of organisms 46 of the species under study, genotype probability distributions obtained from pedigree data 68, and genotype data 68. Marker data 70 can comprise single nucleotide polymorphisms (SNPs), microsatellite markers, restriction fragment length polymorphisms, short tandem repeats, DNA methylation markers, sequence length polymorphisms, random amplified polymorphic DNA, amplified fragment length polymorphisms, simple sequence repeats, or any combination thereof. Genotype data comprises knowledge of which alleles, for each marker considered in marker data 70, is present in each organism in the plurality of organisms under study. Pedigree data shows one or more relationships between organisms in the plurality of organisms under study. In some embodiments, the plurality of organisms under study comprises an F2 population and the one or more relationships between organisms in the plurality of organisms indicates which organisms in the plurality of organisms are members of the F2 population. However, pedigree data can be obtain for outbred populations as well.

Step 1908. Once the expression data has been transformed into corresponding expression statistics and genetic map 78 has been constructed, the data is transformed into a structure that associates all marker, genotype and expression data for input into QTL analysis software. This structure is stored in expression/genotype warehouse 76 (FIG. 1; FIG. 19, step 1908). FIG. 3C illustrates an expression/genotype warehouse 76 that is used in some embodiments where gene expression/cellular constituent data 44 was measured from multiple tissue types.

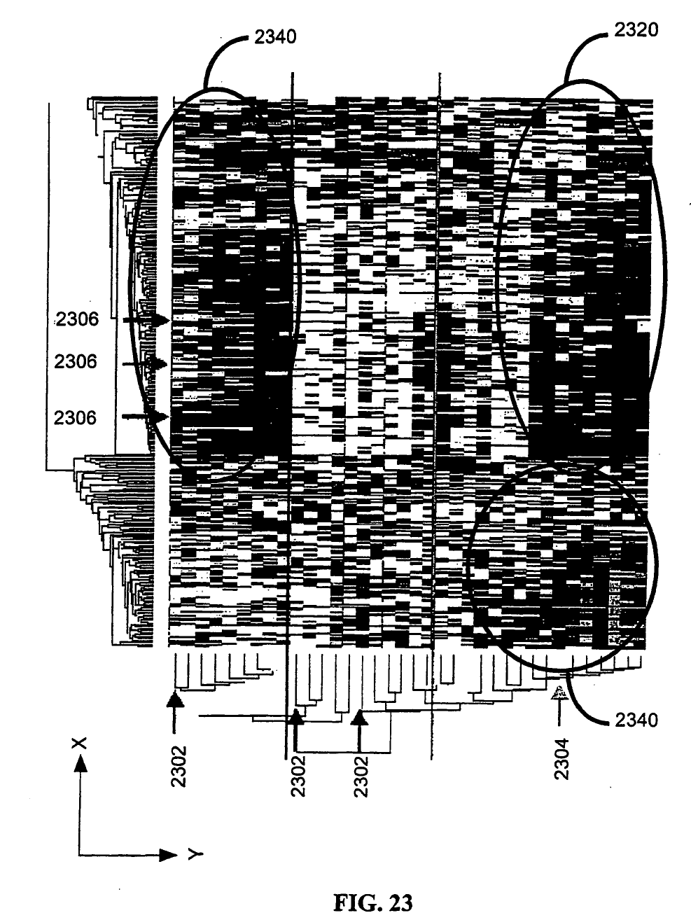

Step 1910. A quantitative trait locus (QTL) analysis is performed using data corresponding to a gene G as a quantitative trait (FIG. 19, step 1910). In some embodiments of the present invention, step 1910 is performed by an embodiment of expression quantitative trait loci (eQTL) identification module 2202 (FIG. 22), which is resident in memory 24 of computer 20 in system 10 (FIG. 1). In one embodiment, this QTL analysis is performed by QTL analysis module 80 (FIG. 1). In one example, the QTL analysis steps through a genetic map 78 that represents the genome of the species under study. Linkages to gene G are tested at each step or location along the genetic map. In such embodiments, each step or location along the length of the genetic map can be at regularly defined intervals. In some embodiments, these regularly defined intervals are defined in Morgans or, more typically, centiMorgans (cM). In some embodiments, each regularly defined interval is less than 100 cM. In other embodiments, each regularly defined interval is less than 10 cM, less than 5 cM, or less than 2.5 cM.

In the QTL analysis of step 1910, data corresponding to gene G is used as a quantitative trait. More specifically, the quantitative trait used in the QTL analysis is an expression statistic set, such as set 304 (FIG. 3A), that corresponds to gene G. That is, the expression statistic set 304 comprises the expression statistic 308 for gene G from each organism 306 in the population under study. FIG. 3B illustrates an exemplary expression statistic set 304 in accordance with one embodiment of the present invention. Exemplary expression statistic set 304 includes the expression level 308 of gene G from each organism in a plurality of organisms. For example, consider the case where there are ten organisms in the plurality of organisms, and each of the ten organisms expresses gene G. In this case, expression statistic set 304 includes ten entries, each entry corresponding to a different one of the ten organisms in the plurality of organisms. Further, each entry represents the expression level of gene G in the organism represented by the entry. So, entry “1” (308-G-1) corresponds to the expression level of gene G in organism 1, entry “2” (308-G-2) corresponds to the expression level of gene G in organism 2, and so forth. Expression statistic set 304 comprises a plurality of expression statistics 308 for gene G. In some embodiments, the population under study is subdivided using the techniques disclosed in Section 5.20 and only expression values from a subpopulation of the organisms under study are used in the expression statistic for gene G.

In one embodiment of the present invention, the QTL analysis (FIG. 19, step 1910) comprises: (i) testing for linkage between (a) the genotype of the plurality of organisms at a position in the genome of the single species and (b) the plurality of expression statistics for gene G (e.g., expression statistic set 304), (ii) advancing the position in the genome by an amount, and (iii) repeating steps (i) and (ii) until all or a portion of the genome has been tested. In some embodiments, the amount advanced in each instance of (ii) is less than 100 centiMorgans, less than 10 centiMorgans, less than 5 centiMorgans, or less than 2.5 centiMorgans. In some embodiments, the testing comprises performing linkage analysis (Section 5.13) or association analysis (Section 5.14) that generates a statistical score for the position in the genome of the single species. As detailed below, in some embodiments, the testing is linkage analysis and the statistical score is a logarithm of the odds (lod) score. Thus, in some embodiments, an eQTL identified in processing step 1910 is represented by a lod score that is greater than 2.0, greater than 3.0, greater than 4.0, or greater than 5.0.

In situations where pedigree data is not available, genotype data from each of the organisms 46 (FIG. 1) for each marker in marker data 70 can be compared to each quantitative trait (expression statistic set 304 ) using allelic association analysis, as described in Section 5.14, supra, in order to identify QTL that are linked to each expression statistic set 304. In one form of association analysis, an affected population is compared to a control population. In particular, haplotype or allelic frequencies in the affected population are compared to haplotype or allelic frequencies in a control population in order to determine whether particular haplotypes or alleles occur at significantly higher frequency amongst affected compared with control samples. Statistical tests such as a chi-square test can be used to determine whether there are differences in allele or genotype distributions.

In some embodiments, testing for linkage between a given position in the chromosome and the expression statistic set 304 comprises correlating differences in the expression levels found in the expression level statistic with differences in the genotype at the given position using single marker tests (for example using t-tests, analysis of variance, or simple linear regression statistics). See, e.g., Statistical Methods, Snedecor and Cochran, Iowa State University Press, Ames, Iowa (1985). However, there are many other methods for testing for linkage between expression statistic set 304 and a given position in the chromosome. In particular, if expression statistic set 304 is treated as the phenotype (in this case, a quantitative phenotype), then methods such as those disclosed in Doerge, 2002, Mapping and analysis of quantitative trait loci in experimental populations, Nature Reviews: Genetics 3:43-62, may be used. Concerning steps (i) through (iii) above, if the genetic length of the genome is N cM and 1 cM steps are used, then N different tests for linkage are performed on the given chromosome. Furthermore, multiple QTLs can be considered simultaneously in step 1910. For example, marker-difference regression techniques or composite interval mapping can be used. See, for example, Chapters 15 and 16 of Lynch & Walsh, 1998, Genetics and Analysis of Quantitative Traits, Sinauer Associates, Inc., Sunderland, Mass.

In some embodiments, the QTL data produced from QTL analysis 1910 comprises a logarithm of the odds score (lod) computed at each position tested in the genome under study. A lod score is a statistical estimate of whether two loci are likely to lie near each other on a chromosome and are therefore likely to be genetically linked. In the present case, a lod score is a statistical estimate of whether a given position in the genome under study is linked to the quantitative trait corresponding to a given gene. Lod scores are further described in Section 5.4, supra. A lod score of three or more is generally taken to indicate that two loci are genetically linked. The generation of lod scores requires pedigree data. Accordingly, in embodiments in which a lod score is generated, processing step 1910 is essentially a linkage analysis, as described in Section 5.13, with the exception that the quantitative trait under study is derived from data, such as cellular constituent expression statistics, rather than classical phenotypes such as eye color. In situations where pedigree data is not available, genotype data from each of the organisms 46 (FIG. 1) for each marker in genetic map 78 can be compared to each quantitative trait (e.g., expression statistic set 304) using association analysis, as described in Section 5.14, supra, in order to identify QTL that are linked to the quantitative trait.

In some embodiments, processing step 1910 yields a data structure that includes all positions 86 (FIG. 1) in the genome of the organisms 46 that were tested for linkage to the expression statistic set 304 (quantitative trait 84) in step 1910. In one embodiment, this data structure is an entry in data structure 82 (FIG. 1). Positions 86 are obtained from genetic map 78. For each position 86, genotype data 68 provides the genotype at position 86 for each organism in the plurality of organisms under study. For each such position 86 analyzed by QTL analysis 1910, a statistical measure (e.g., statistical score 88), such as the maximum lod score between the position and the expression statistic set, is provided by processing step 1910. Thus, processing step 1910 yields all the positions in the genome of the organism of interest that are linked to the expression statistic set 304 tested in step 1910. Such positions are referred to as the eQTL for the linked gene G tested in step 1910.

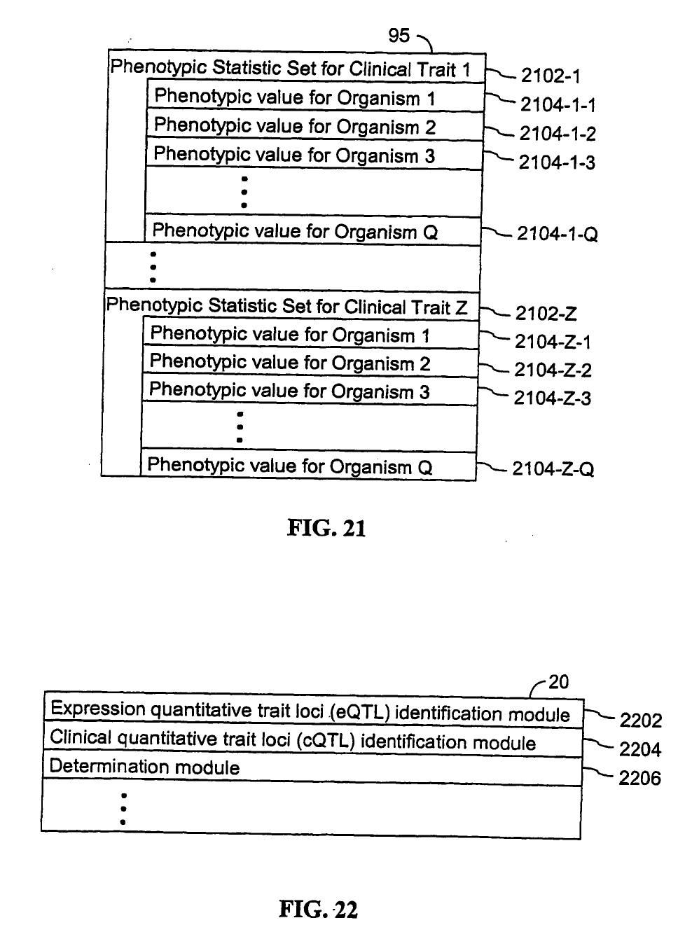

Step 1912. In processing step 1912, a clinical quantitative trait loci (cQTL) that is linked to a clinical trait T is identified using QTL analysis. In some embodiments of the present invention, step 1912 is performed by an embodiment of clinical quantitative trait loci (cQTL) identification module 2204 (FIG. 22). In some embodiments, a phenotypic statistic set 2102 for the clinical trait T serves as the clinical trait used in the QTL analysis. FIG. 21 illustrates exemplary phenotypic statistic sets 2102 that are stored as phenotypic data 95 in memory 24 within system 10 (FIG. 1). In FIG. 21, each phenotypic statistic set 2102 includes the phenotypic value for a different organism in a plurality of organisms under study. As used herein, a phenotypic value is any form of measurement of a phenotypic trait. For example, if the phenotypic trait is cholesterol level in the organism, the phenotypic value can be milligrams of cholesterol per liter of blood.

In one embodiment, processing step 1912 comprises a classical form of QTL analysis in which a phenotypic trait is quantified. In some embodiments, processing step 1912 employs a whole genome search of genetic markers using genetic map 78. For each such position 86 in the genome that is analyzed by QTL analysis 1912, processing step 1912 provides a statistical measure (e.g., statistical score 88), such as the maximum lod score between the position and the phenotypic statistic set 2102. Thus, processing step 1912 yields all the positions in the genome of the organism of interest that are linked to the expression statistic set 304 tested in step 1912. Such embodiments of processing step were first described by Lander and Botstein in Genetics 121, 174-179 (1989). They are also described in International Application WO 90/04651, International Application WO 99/13107, Lander and Schork, Science 265, 2037-2048 (1994), and Doerge, Nature Reviews Genetics 3, 43-62, (2002). In other embodiments of processing step 1912, association analysis, as described in Section 5.14 is used rather than linkage analysis.

In one embodiment of the present invention, the QTL analysis (FIG. 19, step 1912) comprises: (i) testing for linkage between (a) the genotype of a plurality of organisms at a position in the genome of a single species and (b) the phenotypic statistic set 2102 (e.g., plurality of phenotypic values), (ii) advancing the position in the genome by an amount, and (iii) repeating steps (i) and (ii) until all or a portion of the genome has been tested. In some embodiments, the amount advanced in each instance of (ii) is less than 100 centiMorgans, less than 10 centiMorgans, less than 5 centiMorgans, or less than 2.5 centiMorgans. In some embodiments, the testing comprises performing linkage analysis (Section 5.13) or association analysis (Section 5.14) that generates a statistical score for the position in the genome of the single species. In some embodiments, the testing is linkage analysis and the statistical score is a logarithm of the odds (lod) score (Section 5.4). Thus, in some embodiments, an eQTL identified in processing step 1912 is represented by a lod score that is greater than 2.0, greater than 3.0, greater than 4.0, or greater than 5.0.

Step 1914. Processing step 1910 identifies any number of expression quantitative trait loci (eQTL) for a gene G whereas processing step 1912 identifies any number of clinical quantative trait loci (cQTL) for a clinical trait T. In processing step 1914, a determination is made as to whether an eQTL from processing step 1910 colocalizes with a cQTL from processing step 1912 (do an eQTL and cQTL fall onto the same point in the genome of the species). In some embodiments of the present invention, processing step 1914 is performed by an embodiment of determination module 2206 (FIG. 22). In some embodiments, an eQTL and a cQTL are considered colocalized if they fall within 50 centiMorgans (cM) of each other within the genome of the species under study. In some S embodiments, an eQTL and cQTL are considered colocalized if they fall within 40 cM, 30 cM, 20 cM, 15 cM or 10 cM of each other within the genome of the species under study. In some embodiments, an eQTL and cQTL are considered colocalized if they fall within 8 cM, 6 cM, 4 cM, or 2 cM of each other within the genome of the species under study.

In some embodiments of step 1914, an eQTL/cQTL are not considered to be colocalized, no matter how close the eQTL and cQTL are unless the QTL (the position of the eQTL/cQTL overlap) is truly common to the clinical and expression trait (pleiotropic effect) rather than simply representing two closely linked QTL (linkage disequilibrium). Thus, in some embodiments of step 1914, in order to achieve the result 1914—Yes, the subject eQTL and cQTL must pass a pleiotropy test. In one embodiment of the present invention, the test pleiotropy test operates by testing the positions between the eQTL and the cQTL to determine whether the positions are statistically indistinguishable.

In considering a test for pleiotropy, let Y₁ and Y₂ represent quantitative trait random variables, with QTL Q₁ and Q₂ at positions p₁ and p₂, respectively. It is of interest to determine whether p₁=p₂, indicating a pleiotropic effect at the QTL for traits Y₁ and Y₂. Jiang and Zeng, 1995, Genetics 140, 1111, devised statistical tests to assess whether the positions are equal. In some embodiments of step 1914, a generalization of this test is implemented. Since the positions under consideration usually will be relatively close together on a given chromosome (e.g., within 20 cM), it is expected that Y₁ and Y₂ will be correlated, and so the most basic model for these traits under the control of a single, common QTL is formed as:

$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} \\ {β}_{2}\end{matrix} ) Q + ( \begin{matrix}{ɛ}_{1} \\ {ɛ}_{2}\end{matrix} ) ,$$

where Q is a categorical random variable indicating the genotypes at the position of interest,

$$( \begin{matrix}{ɛ}_{1} \\ {ɛ}_{2}\end{matrix} )$$

is distributed as a bivariate normal random variable with mean

$$( \begin{matrix}0 \\ 0\end{matrix} )$$

and covariance matrix

$$( \begin{matrix}{σ}_{1}^{2} & {σ}_{1} {σ}_{2} \\ {σ}_{2} {σ}_{1} & {σ}_{2}^{2}\end{matrix} )$$

and μᵢ and βᵢ are model parameters. This case, where p₁=p₂ (pleiotropy), represents the null hypothesis of pleiotropy. The aim is to test this null hypothesis against a more general alternative hypothesis that indicates p₁≠p₂ (no pleiotropy). The alternative hypotheses of interest can be captured by the following model:

$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} & {β}_{2} \\ {β}_{3} & {β}_{4}\end{matrix} ) ( \begin{matrix}{Q}_{1} \\ {Q}_{2}\end{matrix} ) + ( \begin{matrix}{ɛ}_{1} \\ {ɛ}_{2}\end{matrix} ) ,$$

where Q₁ and Q₂ are categorical random variables indicating the genotypes at the position of the eQTL and the cQTL, respectively, in the plurality of organisms;

$$( \begin{matrix}{ɛ}_{1} \\ {ɛ}_{2}\end{matrix} )$$

is distributed as for the pleiotropy model; and μᵢ and βᵢ are model parameters. There are several alternative hypotheses that can be tested in this setting including:
H_{A}:β₁≠0,β₄≠0,β₂=0,β₃=0, 1.
indicating closely linked QTL with no pleiotropic effects,
H_{A}:β₁≠0,β₄≠0,β₂≠0,β₃=0, 2.
indicating closely linked QTL with pleiotropic effects at the first position,
H_{A}:β₁≠0,β₄≠0,β₂=0,β₃≠0, 3.
indicating closely linked QTL with pleiotropic effects at the second position, and
H_{A}:β₁≠0,β₄≠0,β₂≠0,β₃≠0, 4.
indicating closely linked QTL with pleiotropic effects at both positions. Other null hypotheses and corresponding alternative hypotheses naturally follow from the general models presented here.

In some embodiments, negative log likelihoods to the null hypothesis and the alternative hypothesis are minimized with respect to the model parameters (μᵢ, βⱼ, and σₖ) using maximum likelihood analysis. The likelihood ratio test statistic can be formed from these likelihoods to assess whether the alternative hypothesis (no pleiotropy) is preferred over the null hypothesis (1914—No). If the null hypothesis is preferred (1914—Yes), then test 1916 is considered.

Step 1916. In some embodiments of the present invention, when an eQTL for gene G colocalizes with a cQTL for a clinical trait T (1914—Yes), gene G is associated with the clinical trait T (step 1920). If this condition is not satisfied (1914—No), then another gene G in the genome of the species under study is selected and process control returns to step 1910 (FIG. 19). In other embodiments, the condition is imposed that the eQTL for gene G colocalizes to the physical location of gene G in the genome (1916—Yes) before gene G is associated with the clinical trait T (step 1920) (the eQTL must be a cis-acting QLT). In other words, the eQTL must correspond to the physical location of gene G in the genome of the single species in order for the gene to be linked to a clinical trait T. In some embodiments, an eQTL corresponds to the physical location of gene G if the eQTL and G colocalize within 5 cM, 4 cM, 3 cM, 2 cM, 1 cM, or less in the genome of said single species. In embodiments where condition 1916 is imposed, when the condition is not satisfied (1916—No), another gene G in the genome of the species under study is selected and process control returns to step 1910.

In some embodiments of the present invention, genes that are associated with a clinical trait T are further validated by determining whether the cQTL and eQTL genetically interact with each other. Genetic interaction between cQTL and eQTL can be tested in a number of different ways. For example, marker-difference regression, composite interval mapping, or the multiple-trait extension of composite interval mapping given by Jiang and Zeng, Genetics 140, p. 1111, can be used for inbred populations. Genetic interaction between cQTL and eQTL is tested because, if a cQTL and eQTL are controlled by the same locus, not only will they be colocalized, but they should be correlated in the genetic sense. In other words, the variation of the gene expression (eQTL) and clinical traits (cQTL) will be correlated with genotype within the species in the same way.

### 5.17. Integrating Clinical, Genetic, Genomic and Molecular Phenotype Data Target Discovery

The methods of the present invention can be utilized in order to significantly impact target discovery and target validation, as well as improve prioritization of targets for entry into the validation and lead development pipeline. In Section 5.16, an embodiment of the present invention in which eQTL that co-localize with clinical trait QTL (cQTL) and with the physical location of the gene whose transcription gives rise to the eQTL was identified. In cases where the gene underlying a cQTL controls the variation of that trait through variation in transcription associated with DNA polymorphisms in the gene itself, the expression of that gene treated as a quantitative trait should give rise to an eQTL coincident with the cQTL. Depending on the degree of heritability of the clinical and expression traits, and the percentage of variation of the trait explained by the cQTL, it is not necessarily expected that the clinical trait values and expression trait values would be significantly correlated, even if variation in transcription of the gene causes variation in the clinical trait. However, significant genetic correlation between clinical and gene expression traits is expected in such cases. Therefore, the methods of the present invention test for interaction between the clinical trait QTL (cQTL) and gene expression QTL (eQTL) as described in Section 5.16, above. In this way, candidate genes underlying the cQTL for a clinical trait of interest are identified. The examples provided in Section 6, below, illustrate how the methods of the present invention were used to identify candidate genes for the fat pad mass trait in mice. One of the advantages in the application of the methods of the present invention is that the candidate genes are identified in a completely objective manner, by making full use of the genotype, expression and clinical data.

The methods of the present invention reduce the number of genes that must be considered in identifying genes for complex traits. The QTL analysis alone (FIG. 19, step 1910, FIG. 2, step 210) reduces the number of genes to consider from all genes in the genome to those genes residing in QTL support intervals. In some embodiments, QTL support intervals are determined by the point on each side of the significance peak (the QTL) at which the lod score is 1.0 unit less than the peak lod score. In other words, the QTL analysis applied in step 1910 (FIG. 19) or step 210 (FIG. 2) identifies certain QTL (loci) and only those genes in the region of these QTL (loci) need to be considered. Genes that do not fall within a QTL (within the QTL support interval) do not need to be considered. Of course, when association studies are used in step 1910 (FIG. 19) or step 210 (FIG. 2), loci rather that QTL are identified. However, for simplification of terminology, the terms QTL and loci are used interchangeably herein.

After quantitative genetic analysis (or some other form of genetic analysis), the methods of the present invention rule out additional genes by requiring that candidate genes must reside in a QTL support interval and be (1) under the control of a cis-acting eQTL and (2) have significant interaction between the eQTL and cQTL. In practice, condition (1) excludes all genes except those genes in eQTL that co-localize with a cQTL for the trait under study. Further, the requirement for cis-acting eQTL in condition (1) limits the study to those genes whose physical location colocalizes with the eQTL generated from their expression values.

Condition (2) is used to add another layer of confidence to the genes satisfying condition (1). According to the hypothesis of one embodiment of the present invention, if the cQTL and eQTL are controlled by the same locus, not only will they be colocalized, but they will be correlated in the genetic sense. In other words, the variation of the gene expression and clinical traits will be correlated with genotype in the same way. Genetic interaction between cQTL and eQTL can be tested using techniques that simultaneously analyze multiple QTLs. Such techniques include marker-difference regression (also known as marker regression or joint mapping). See, for example, Kearsey and Hyne, 1994, Theor. Appl. Genet. 89, p. 698; Wu and Li, 1994, Theor. Appl. Genet. 89, p. 535. Such techniques further include interval mapping with marker cofactors. See, for example, Jansen, 1992, Theor. Appl. Genet. 85, p. 252; Jansen, 1993, Genetics 135, p. 205; Zeng, 1993, Proc. Natl. Acad. Sci. USA 90, p. 10972; Zeng, 1994, Genetics 136; p. 1457; Stam, 1991, Proceedings of the Eight Meeting of the Eucarpia Section Biometrics on Plant Breeding, Brno, Czechoslovakia, pp. 24-32; Jansen, 1995, Theor. Appl. Genet. 91, p. 33; van Ooijen, 1994, in van Ooijen and Jansen (eds.), Biometrics in plant breeding: applications of molecular markers, pp. 205-212, CPRO-DLO, Netherlands; and Utz and Melchinger, 1994, in van Ooijen and Jansen (eds.), Biometrics in plant breeding: applications of molecular markers, pp. 195-204, CPRO-DLO, Netherlands. Such techniques farther include multiple-trait extensions to composite interval mapping given by Jiang and Zeng.

While the approaches outlined in this section are restricted to those clinical trait QTL that are associated with polymorphic transcription in the gene underlying the QTL, it is expected that most complex traits under the control of many loci (say, under the control of greater than five loci) will have at least one QTL that is controlled by polymorphic transcription. Further, even in cases where the DNA polymorphism driving the cQTL leads to functional changes in the protein, it can still be possible to observe polymorphic transcription behavior.

### 5.18. Target Validation

The methods of the present invention can be used to associate a gene with a complex trait This section discloses techniques that can be used to validate such genes identified using the techniques of the present invention. In some embodiments, gene knock-out/knock-in mice or transgenic mice are employed for such validation. In some embodiments, in vivo siRNA is used to validate such genes. See, for example, Cohen et al., 1997, J. Clin. Invest. 99, p. 1906. Regardless of the validation technique used, the goal is to identify an expression signature associated with a clinical trait, identify the causative loci driving the expression pattern, and then perturb the expression of the candidate causative genes to determine if genes associated with the expression of the causative gene are changed in a like manner.

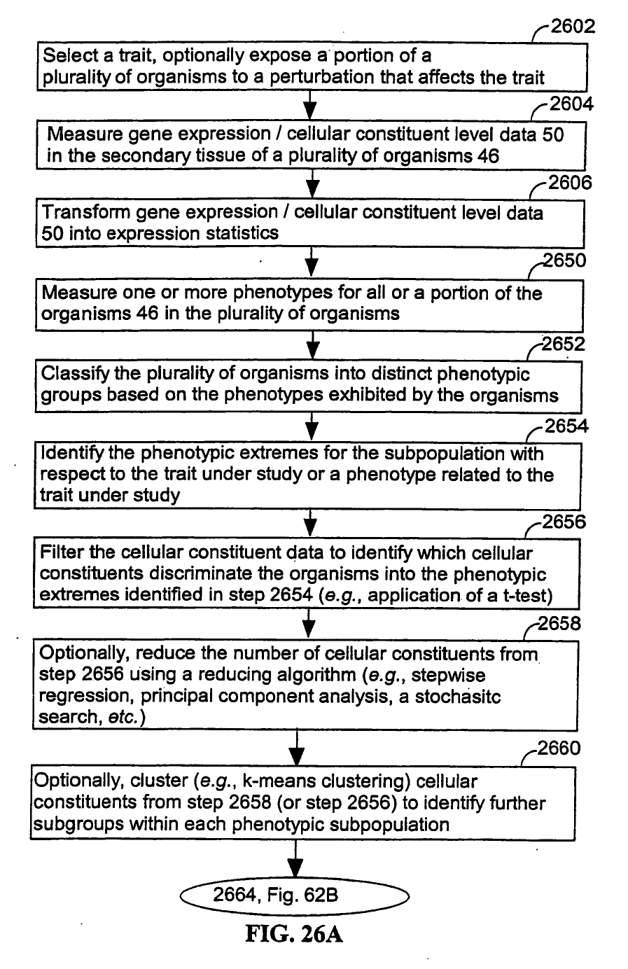

FIG. 25 provides a hypothetical example of a validation strategy in accordance with one embodiment of the present invention. In this example, genes Y1 through Y4 are genes that are part of an expression pattern associated with a complex trait of interest. The upper panel plots the lod score curves for the four genes for a particular chromosome, where the cluster of eQTL depicted are coincident with a cQTL for the complex trait. By examining genes that physically reside in the QTL support interval, those genes that have cis-acting eQTL that are significantly genetically interacting with the other eQTL/cQTL are identified. These genes represent the potential causative genes underlying the cQTL/eQTL. Gene X in FIG. 25 highlights one such example. By knocking gene X out using in vivo small interfering RNA (siRNA) methods, the siRNA knock-out animals can be profiled and the genetic signatures of the original genes making up the eQTL cluster examined. Various siRNA knock-out techniques (also referred to as RNA interference or post-transcriptional gene silencing) are disclosed, for example, in Xia, et al., 2002, Nature Biotechnology 20, p. 1006; Hannon, 2002, Nature 418, p. 244; Carthew, 2001, Current Opinion in Cell Biology 13, p. 244; Paddison, 2002, Genes & Development 16, p. 948; Paddison & Hannon, 2002, Cancer Cell 2, p. 17; Jang et al., 2002, Proceedings National Academy of Science 99, p. 1984; Martinez et al., 2002, Proceedings National Academy of Science 99, p. 14849.

The lower panel in FIG. 25 highlights what is expected if gene X were in fact driving the eQTL cluster shown in the upper panel. That is, the disappearance of the eQTL cluster would validate gene X's role as the causal factor underlying the expression pattern associated with the complex trait, and thus, would solidify its role as a key driver for the corresponding complex trait. If the complex trait were a disease like obesity, then validating a gene for the obesity trait directly would require the construction of, say, a knock out animal for that gene, which is a lengthy process. However, by defining the complex trait in terms of expression patterns, the candidate gene can be perturbed in more specialized ways and the effects on the expression pattern observed, which can happen in a much shorter time frame.

Finally, it is noted that even before a putative target is biologically validated in mice, association studies can be carried out in human populations to provide a source of validation in humans. Associating a gene in a human population with a clinical trait, where the gene in mouse 1) was physically co-localized with a cQTL for the corresponding clinical trait in a segregating mouse population, 2) gave rise to a cis-acting QTL with respect to its transcription, and 3) was significantly genetically interacting with the clinical trait QTL, is itself a very powerful validation of a gene's role in the complex trait of interest. See, also, U.S. Provisional Patent Application 60/436,684 filed Dec. 27, 2002. The combined validation in mouse and human provides all that is necessary to move a target forward in a discovery program. Even in cases where the causal gene is not itself druggable, druggable targets driven by the causal gene can be identified by examining those targets that have eQTL that co-localize and are interacting with eQTL for the causative gene. This speaks to the more general use of the combined genetics/gene expression approach to reconstruct genetic networks.

### 5.19. Determining the Topology of a Biological Pathway that Affects a Complex Trait

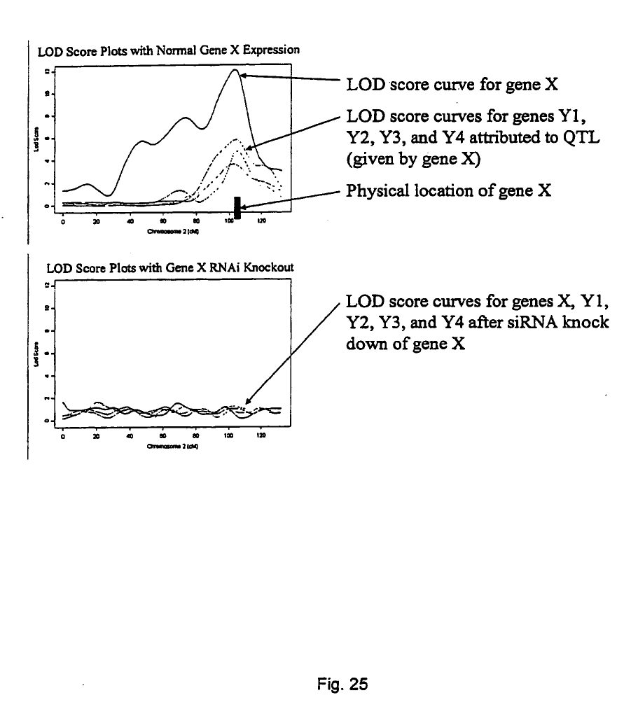

The processing steps disclosed in FIG. 19 and described in Section 5.16, above, are used to identify the genes associated with a complex trait (e.g., the genes that affect a complex trait). This section describes how the data obtained in Section 5.16, above, can also be used to deduce the topology of a biological pathway that affects a complex trait. In particular, using FIG. 24 as an illustration, cQTL and eQTL data is analyzed in order to deduce the topology of such a biological pathway.

In step 1912, the cQTL for clinical traits 1 through 4 are localized on a representative molecular map 2402 for the population under study. For example, in cases where the population under study is human, representative molecular map 2402 is, for example, a map of the human genome. In some embodiments, molecular map 2402 (FIG. 24) is a marker map, such as one stored as marker data 70 in system 10 (FIG. 1). In some embodiments, molecular map 2402 includes the nucleotide sequence of a portion of the genome (e.g., genomic map) of the population under study.

Step 1912 of FIG. 24 (illustrated as downward arrow in the upper left side of FIG. 24) corresponds to step 1912 of FIG. 19. In step 1912 of FIG. 24, a clinical quantitative trait loci (cQTL) that is linked to a clinical trait T is identified on map 2402 with a QTL analysis that uses the phenotypic statistic set 2102 as the clinical trait T. In some embodiments, these QTL analyses are performed by an embodiment of clinical quantitative trait (cQTL) identification module 2204 (FIG. 22). Referring to FIG. 24, four phenotypic statistics sets 2102 are shown Each set 2102 corresponds to one of four clinical traits under study. It will be appreciated that any number of clinical traits may be analyzed and that the four traits illustrated in FIG. 24 are merely exemplary. For example, at least 3, 5, 8, 12, 20, 30, or 40 clinical traits could be analyzed using the methods disclosed in FIG. 24.

In one embodiment, the complex trait under study is obesity. In one example of this embodiment, clinical trait 1 is a body mass index (e.g. weight/height²), clinical trait 2 is subcutaneous fat pad mass, clinical trait 3 is insulin level in the blood, and clinical trait 4 is leptin levels. Accordingly, cQTL1 is a QTL that is linked to body mass index. cQTL2 is a QTL that is linked to subcutaneous fat pad mass, clinical trait 3 is a QTL that is linked to insulin level in the blood, and cQTL 4 is a QTL that is linked to leptin levels. Further, cQTL1 through cQTL4 are determined using the QTL analysis of step 1912 (FIG. 19) as described in detail in Section 5.16, above.

In addition to the identification of four cQTL in map 2402, which respectively correspond to four clinical traits associated with obesity, FIG. 24 discloses the results of a number of eQTL analyses. The computation of these eQTL analyses will now be described. In FIG. 24, four expression statistics sets 304 (FIG. 3) are illustrated. Each expression statistic set corresponds to a different gene G in the genome of the population under study. As described in detail in previous sections, each expression value in the expression statistic set is a measurement of a cellular constituent corresponding to a particular gene G in an organism in a population of organisms under study. The cellular constituent may be, for example, mRNA levels for the corresponding gene, protein levels for the corresponding gene, or a metabolite level that is directly regulated by the corresponding gene. It will be appreciated that any number of genes may be analyzed and that the four genes illustrated in FIG. 24 are merely exemplary. For example, at least 3, 5, 8, 12, 20, 30, or 40 genes could be analyzed using the methods disclosed in FIG. 24.

Each expression statistic set 304 is used as the quantitative trait in a QTL analysis in accordance with processing step 1910 (FIG. 19). QTL analysis, such as those performed in processing step 1910, are described in detail in Section 5.16, above. A separate QTL analysis is performed for each of the four expression statistics sets 304 illustrated in FIG. 24. In some embodiments, these QTL analyses are performed by an embodiment of expression quantitative trait loci (eQTL) identification module 2202 (FIG. 22). Each expression statistic set 304 generates eQTL that are linked to the expression statistic set. Expression statistic set 304-Gene1, which is the expression statistic set for gene 1, yields four eQTL (eQTL1-1*, eQTL1-2, eQTL1-3, and eQTL1-4). These four eQTL map to four different locations on map 2402. It will be appreciated that eQTL will map to various locations on map 2402 and that not all eQTL will colocalize with a cQTL. However, for the ease of illustration of this example, eQTL1-1*, eQTL1-2, eQTL1-3, and eQTL1-4 respectively co-localize with cQTL1, cQTL2, cQTL3, and cQTL4. Only one of the eQTL can correspond to the physical location of the gene G that forms the basis of the expression set 304 was used to compute the eQTL. For set 304-Gene1, the eQTL denoted eQTL1-1* maps to the physical location of gene 1 in map 2402. For this reason, eQTL1-1 is marked with an asterisk. For the set 304-Gene4, the eQTL denoted eQTL4-1* maps to the physical location of gene 4.

The physical location of each eQTL for each of genes 1 through 4 is shown in FIG. 24. Analysis of the eQTL and the cQTL allow for the determination of which of the four genes is the furthest upstream in a biological pathway that affects the complex trait T under study. FIG. 24 discloses the following eQTL/cQTL relationships:

| | | Physical Location of the |
|---|---|---|
| | | Gene (expressed in terms |
| | cQTL that colocalize | of cQTL and eQTL that |
| Gene | with an eQTL for | colocalize to the |
| Number | this Gene | location on map 2402) |
| 1 | cQTL1, cQTL2, cQTL3, | cQTL1/eQTL1-1 |
| | cQTL4 | |
| 2 | cQTL2, cQTL3, cQTL4 | cQTL2/eQTL2-1 |
| 3 | cQTL3, cQTL4 | cQTL3/eQTL3-1 |
| 4 | cQTL4 | cQTL4/eQTL4-1 |

Referring to FIG. 24, it is seen that cQTL4 colocalizes with an eQTL for each of the four genes under study. In some embodiments, an eQTL and a cQTL are considered colocalized if they fall within 25 centiMorgans (cM) of each other on map 2402. In some embodiments, an eQTL and cQTL are considered colocalized if they fall within 10 cM, within 5 cM, within 1 cM, within 0.5 cM, or within 0.1 cM of each other on map 2402. In some embodiments, an eQTL and cQTL are considered colocalized if they fall within 100 kilobases, 50 kilobase, 25 kilobases,10 kilobases, 1000 bases, or 500 bases of each other on map 2402. None of the other cQTL colocalize with an eQTL for each of the four genes under study. For example, cQTL2 only colocalizes with an eQTL for two of the genes under study, gene 1 and gene 2. The data shown in FIG. 24 suggests that a gene at position cQTL4 in map 2402 is the further upstream position in a biological pathway. The observation that the eQTL for gene 4 only colocalizes with cQTL4 and none of the other cQTL suggests that the identity of the upstream gene in a biological pathway affecting obesity is, in fact, gene 4.

FIG. 24 further suggests which gene comes after gene 4 in a biological pathway that affects obesity. CQTL3 colocalized with three eQTL, eQTL1-3, eQTL2-2, and eQTL3-1*. These eQTL are respectively linked with gene 1, gene 2, and gene 3. This suggests that there exists a gene that colocalizes with cQTL3 that affects at least two other genes. It is noted that the physical location of gene 3 is cQTL3. Further, the only other eQTL linked to gene 3 that colocalizes with a cQTL on map 2402 is eQTL3-2. But eQTL3-2 colocalizes with cQTL4, a position that has already been determined to colocalize with the most upstream gene in the pathway identified by the data in FIG. 24. Thus, taken together, the data suggests that gene 3 is downstream from gene 4 in a biological pathway that affects obesity. The data further suggests that gene 3 is upstream from genes 1 and 2.

Analysis of the data is completed upon consideration of the eQTL colocalized to cQTL1 and cQTL2. Taken together, the data illustrated in FIG. 24 suggests the following topology for a biological pathway:
Gene4→Gene3→Gene2→Gene1.
In some embodiments, the analysis of data such as that disclosed in FIG. 24 is performed by an embodiment of determination module 2206 (FIG. 22). The biological pathway deduced in this example can be validated using techniques such as multivariate analysis. In addition, the biological pathway deduced in this example can be validated using techniques such as gene knock out studies. Those of skill in the art will recognize numerous other methods for validating the proposed topology for the biological pathway affecting the complex trait, and all such methods are within the scope of the present invention.

While the complex trait analyzed in this hypothetical example is obesity, it will be appreciated that the techniques disclosed in this section can be used to help determine the topology of biological pathways that affect any complex trait of interest. Such determines are facilitated by the choosing to analyze clinical traits that are affected or influenced by the complex trait (e.g., complex disease) under study.

The example in this section can be described as a method for determining the topology of a biological pathway that affects a complex trait. The method has the step of (A), identifying one or more expression quantitative trait loci (eQTL) for a gene in a plurality of genes using a first quantitative trait loci (QTL) analysis. This first QTL analysis uses a plurality of expression statistics for the gene as a quantitative trait. Each expression statistic in the plurality of expression statistics represents an expression value for the gene in an organism in a plurality of organisms of a single species. The method further comprises the step of (B), repeating step (A) a first number of times, wherein each repetition of step (A) uses a different gene in the plurality of genes. In some embodiments, step (A) is repeated three or more times. In some embodiments, step (A) is repeated 5 or more times, 8 or more times, 12 or more times, 20 or more times, or 100 or more times. At least some of the genes -selected in iterations of step (A) are in the biological pathway that affects a complex trait. An advantage of the present invention is that genes that are not in the biological pathway can be selected in step (A) without failure of the method provided that some of the genes selected in iterations of step (A) are in the pathway.

The method further comprises the step of (C), identifying a clinical quantitative trait loci (cQTL) that is linked to a clinical trait in a plurality of clinical traits using a second QTL analysis. The second QTL analysis uses a plurality of phenotypic values as a quantitative trait. Each phenotypic value in the plurality of phenotypic values represents a phenotypic value for the clinical trait in the plurality of clinical traits in an organism in the plurality of organisms. The method further comprises the step of A)), repeating step (C) a second number of times. Each repetition of step (C) uses a different clinical trait in a plurality of clinical traits. In some embodiments, step (C) is repeated 3 or more times. In some embodiments, step (C) is repeated 5 or more times, 8 or more times, 12 or more times, 20 or more times, or 100 or more times. An advantage of the present invention is that clinical traits that are not in fact associated with the complex trait of interest may be selected in instances of step (A) without failure of the method provided that some of the clinical traits selected in iterations of step (C) are in fact indicative of (associated with) the complex trait.

Finally, the method comprises the step of (E), using (i) the identity of each eQTL, identified in an iteration of step (A), that colocalizes with a cQTL, identified in an iteration of step (C), and (ii) a physical location of each gene in the plurality of genes on a molecular map for the single species, in order to determine the topology of the biological pathway that affects the complex trait. In one embodiment, step (E) is performed by identifying a first eQTL. In general, this first eQTL has the property of colocalizing with a first cQTL identified in step (C). Furthermore, this first eQTL has the property that the gene used to generate the eQTL colocalizes with the physical location of the first cQTL. In the case where each eQTL identified in step (A) colocalizes with more than one cQTL, then preferably an eQTL that colocalizes with the small number of cQTL (among the eQTL identified in step A) is identified. In such instances, the cQTL in the small number of cQTL that actually colocalizes with the gene used to generate the first eQTL is denoted as the first cQTL. Once the first cQTL has been identified, a determination is made as to whether eQTL from other genes in the plurality of genes also colocalize with the first cQTL. When this is the case, the hypothesis is drawn that the gene used to generate the first eQTL is further upstream in a biological pathway affecting a complex trait than each of the genes that generate eQTL colocalizing with the first cQTL. This gene is therefore designated as the first gene. When this is not the case a different first eQTL is identified using the method described above.

The method continues by examining each of the genes that generate eQTL that colocalize with the first cQTL in order to determine their topological order in a biological pathway. This analysis proceeds in the same manner used to identify the first cQTL. For example, a second gene that generates an eQTL that colocalizes with both the first cQTL and a second cQTL is sought. If the physical location of the second gene colocalizes with the second cQTL, then the second gene is considered a downstream candidate in the biological pathway. If the second gene does not colocalize with the second cQTL, then a different second gene is identified or step (E) can recommence. Various checks can be performed on the second gene. First, a determination can be made as to whether eQTL from other genes also colocalize with the second cQTL and, if so, whether they are the same genes that generated eQTL that colocalize with the first cQTL. In cases where the same genes are generating eQTL that colocalize with both the first cQTL and the second cQTL, the suggestion is raised that such genes are downstream members of a biological pathway that starts with the first gene and continues with the second gene. Each of these downstream genes can be further examined using the same techniques used to identify the first and second genes, in order to further describe the topology of the biological pathway that affects a complex trait.

### 5.20. Determining the Topolgy of a Biological Pathway that Affects a Complex Trait

This section describes an approach to subdividing a population into subpopulations.

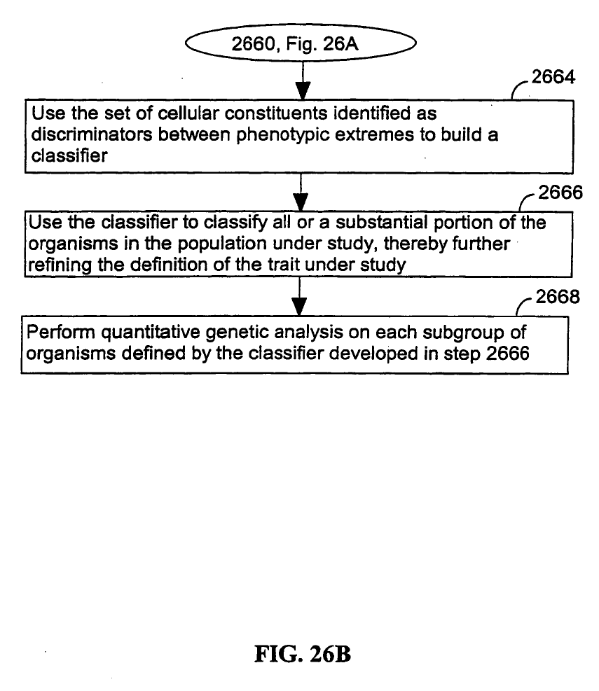

Step 2602. In step 2602 (FIG. 26A), a trait is selected for study in a species. In some embodiments, the trait is a complex trait. The species can be a plant, animal, human, or bacterial. In some embodiments, the species is human, cat, dog, mouse, rat, monkey, pigs, Drosophila, or corn. In some embodiments, a plurality of organisms representing the species are studied. The number of organism in the species can be any number. In some embodiments, the plurality of organisms studied is between 5 and 100, between 50 and 200, between 100 and 500, or more than 500.

In some embodiments, a portion of the organisms under study are subjected to a perturbation that affects the trait. The perturbation can be environmental or genetic. Examples of environmental perturbations include, but are not limited to, exposure of an organism to a test compound, an allergen, pain, hot or cold temperatures. Additional examples of environmental perturbations include diet (e.g. a high fat diet or low fat diet), sleep deprivation, isolation, and quantifying a natural environmental influences (e.g., smoking, diet, exercise). Examples of genetic perturbations include, but are not limited to, the use of gene knockouts, introduction of an inhibitor of a predetermined gene or gene product, N-Ethyl-N-nitrosourea (ENU) mutagenesis, siRNA knockdown of a gene, or quantifying a trait exhibited by a plurality of organisms of a species.

The perturbation optionally used in step 2602 is selected because of some relationship between the perturbation and the trait. For example, the perturbation could be the siRNA knockdown of a gene that is thought to influence the trait under study. Examples of traits that can be studied in the systems and methods of the present invention are disclosed in Section 5.12.

Step 2604. In step 2604 (FIG. 26A), the levels of cellular constituents are measured from the plurality of organisms 46 in order to derive gene expression/cellular constituent data 44. The identity of the tissue from which such measurements are made will depend on what is known about the trait under study. In some embodiments, cellular constituent measurements are made from several different tissues.

Generally, the plurality of organisms 46 exhibit a genetic variance with respect to the trait. In some embodiments, the trait is quantifiable. For example, in instances where the trait is a disease, the trait can be quantified in a binary form (e.g., “1” if the organism has contracted the disease and “0” if the organism has not contracted the disease). In some embodiments, the trait can be quantified as a spectrum of values and the plurality of organisms 46 will represent several different values in such a spectrum. In some embodiments, the plurality of organisms 46 comprise an untreated (e.g. unexposed, wild type, etc.) population and a treated population (e.g., exposed, genetically altered, etc.). In some embodiments, for example, the untreated population is not subjected to a perturbation whereas the treated population is subjected to a perturbation. In some embodiments, the secondary tissue that is measured in step 2604 is blood, white adipose tissue, or some other tissue that is easily obtained from organisms 46.

In varying embodiments, the levels of between 5 cellular constituents and 100 cellular constituents, between 50 cellular constituents and 100 cellular constituents, between 300 and 1000 cellular constituents, between 800 and 5000 cellular constituents, between 4000 and 15,000 cellular constituents, between 10,000 and 40,000 cellular constituents, or more than 40,000 cellular constituents are measured.

In one embodiment, gene expression/cellular constituent data 44 comprises the processed microarray images for each individual (organism) 46 in a population under study. In some embodiments, such data comprises, for each individual 46, intensity information 50 for each gene/cellular constituent 48 represented on the microarray. In some embodiments, cellular constituent data 44 is, in fact, protein expression levels for various proteins in a particular tissue in organisms 46 under study.

In one aspect of the present invention, cellular constituent levels are determined in step 2604 by measuring an amount of the cellular constituent in a predetermined tissue of the organism. As used herein, the term “cellular constituent” comprises individual genes, proteins, mRNA expressing genes, metabolites and/or any other cellular components that can affect the trait under study. The level of a cellular constituent can be measured in a wide variety of methods. Cellular constituent levels, for example, can be amounts or concentrations in the secondary tissue, their activities, their states of modification (e.g., phosphorylation), or other measurements relevant to the trait under study.

In one embodiment, step 2604 comprises measuring the transcriptional state of cellular constituents 48 in tissues of organisms 46. The transcriptional state includes the identities and abundances of the constituent RNA species, especially mRNAs, in the tissue. In this case, the cellular constituents are RNA, cRNA, cDNA, or the like. The transcriptional state of the cellular constituents can be measured by techniques of hybridization to arrays of nucleic acid or nucleic acid mimic probes, or by other gene expression technologies. Transcript arrays are discussed in Section 5.8.

In another embodiment, step 2604 comprises measuring the translational state of cellular constituents 48. In this case, the cellular constituents are proteins. The translational state includes the identities and abundances of the proteins in the organisms 46. In one embodiment, whole genome monitoring of protein (i.e., the “proteome,” Goffeau et al., 1996, Science 274, p. 546) can be carried out by constructing a microarray in which binding sites comprise immobilized, preferably monoclonal, antibodies specific to a plurality of protein species encoded by the secondary tissue. Preferably, antibodies are present for a substantial fraction of the encoded proteins. Methods for making monoclonal antibodies are well known. See, for example, Harlow and Lane, 1998, Antibodies: A Laboratory Manual, Cold Spring Harbor, N.Y. In one embodiment, monoclonal antibodies are raised against synthetic peptide fragments designed based on genomic sequences. With such an antibody array, proteins from the organism are contacted with the array and their binding is assayed with assays known in the art. In some embodiments, antibody arrays for high-throughput screening of antibody-antigen interactions are used. See, for example, Wildt et al., Nature Biotechnology 18, p. 989.

Alternatively, large scale quantitative protein expression analysis can be performed using radioactive (e.g., Gygi et al, 1999, Mol. Cell. Biol 19, p. 1720) and/or stable iostope (¹⁵N) metabolic labeling (e.g., Oda et al. Proc. Natl. Acad. Sci. USA 96, p. 6591) followed by two-dimensional (2D) gel separation and quantitative analysis of separated proteins by scintillation counting or mass spectrometry. Two-dimensional gel electrophoresis is well-known in the art and typically involves focusing along a first dimension followed by SDS-PAGE electrophoresis along a second dimension. See, e.g., Hames et al., 1990, Gel Electrophoresis of Proteins: A Practical Approach, IRL Press, New York; Shevchenko et al., 1996, Proc Nat'l Acad. Sci. USA 93, p. 1440; Sagliocco et al., 1996, Yeast 12, p. 1519; Lander 1996, Science 274, p. 536; and Naaby-Haansen et al., 2001, TRENDS in Pharmacological Science 22, p. 376. Electropherograms can be analyzed by numerous techniques, including mass spectrometric techniques, western blotting and immunoblot analysis using polyclonal and monoclonal antibodies, and internal and N-terminal micro-sequencing. See, for example, Gygi, et al., 1999, Nature Biotechnology 17, p. 994. In some embodiments, fluorescence two-dimensional difference gel electrophoresis (DIGE) is used. See, for example, Beaumont et al., Life Science News 7, 2001. In some embodiments, quantities of proteins in the secondary tissue of organisms 46 are determined using isotope-coded affinity tags (ICATs) followed by tandem mass spectrometry. See, for example, Gygi et al., 1999, Nature Biotech 17, p. 994. Using such techniques, it is possible to identify a substantial fraction of the proteins expressed in a predetermined secondary tissue in organisms 46.

In other embodiments, step 2604 comprises measuring the activity or post-translational modifications of the cellular constituents in the plurality of organisms 46. See for example, Zhu and Snyder, Curr. Opin. Chem. Biol 5, p. 40; Martzen et al., 1999, Science 286, p. 1153; Zhu et al., 2000, Nature Genet. 26, p. 283; and Caveman, 2000, J. Cell. Sci. 113, p. 3543. In some embodiments, measurement of the activity of the cellular constituents is facilitated using techniques such as protein microarrays. See, for example, MacBeath and Schreiber, 2000, Science 289, p. 1760; and Zhu et al., 2001, Science 293, p.2101. In some embodiments, post-translation modifications or other aspects of the state of cellular constituents are analyzed using mass spectrometry. See, for example, Aebersold and Goodlett, 2001, Chem Rev 101, p. 269; Petricoin III, 2002, The Lancet 359, p. 572.

In some embodiments, the proteome of organisms 46 under study is analyzed in step 2604. The analysis of the proteome (e.g., the quantification of all proteins and the determination of their post-translational modifications) typically involves the use of high-throughput protein analysis methods such as microarray technology. See, for example, Templin et al., 2002, TRENDS in Biotechnology 20, p. 160; Albala and Humphrey-Smith, 1999, Curr. Opin. Mol. Ther. 1, p. 680; Cahill, 2000, Proteomics: A Trends Guide, p. 47-51; Emili and Cagney, 2000, Nat. Biotechnol., 18, p. 393; and Mitchell, Nature Biotechnology 20, p. 225.

In still other embodiments, “mixed” aspects of the amounts cellular constituents are measured in step 2604. In one example, the amounts or concentrations of one set of cellular constituents in the organisms 46 under study are combined with measurements of the activities of certain other cellular constituents in such organisms.

In some embodiments, different allelic forms of a cellular constituent in a given organism are detected and measured in step 2604. For example, in a diploid organism, there are two copies of any given gene, one descending from the “father” and the other from the “mother.” In some instances, it is possible that each copy of the given gene is expressed at different levels. This is of significant interest since this type of allelic differential expression could associate with the trait under study, particularly in instances where the trait under study is complex.

Step 2606. Once gene expression/cellular constituent data 44 has been obtained, the data is transformed (FIG. 26A, step 2606) into expression statistics. In some embodiments, cellular constituent data 44 (FIG. 1) comprises transcriptional data, translational data, activity data, and/or metabolite abundances for a plurality of cellular constituents. In one embodiment, the plurality of cellular constituents comprises at least five cellular constituents. In another embodiment, the plurality of cellular constituents comprises at least one hundred cellular constituents, at least one thousand cellular constituents, at least twenty thousand cellular constituents, or more than thirty thousand cellular constituents.

The expression statistics commonly used as quantitative traits in the analyses in one embodiment of the present invention include, but are not limited to, the mean log ratio, log intensity, and background-corrected intensity derived from transcriptional data In other embodiments, other types of expression statistics are used as quantitative traits.

In one embodiment, this transformation (FIG. 26A, step 2606) is performed using normalization module (not shown). In such embodiments, the expression level of each of a plurality of genes in each organism under study is normalized. Any normalization routine can be used by the normalization module. Representative normalization routines include, but are not limited to, Z-score of intensity, median intensity, log median intensity, Z-score standard deviation log of intensity, Z-score mean absolute deviation of log intensity calibration DNA gene set, user normalization gene set, ratio median intensity correction, and intensity background correction. Furthermore, combinations of normalization routines can be run. Exemplary normalization routines in accordance with the present invention are disclosed in more detail in Section 5.3.

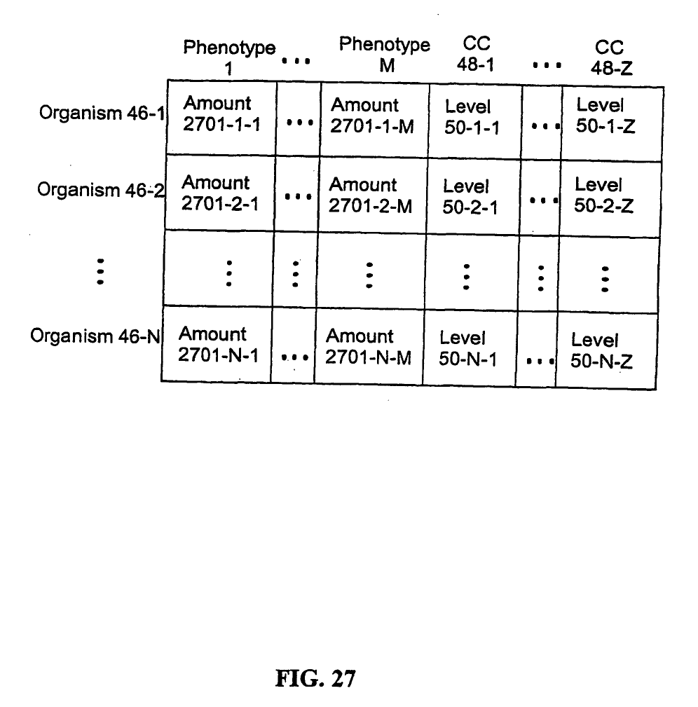

Step 2650. In the preceding steps, a trait is identified, cellular constituent level data is measured, and the cellular constituent data is transformed into expression statistics. In step 2650 (FIG. 26A), one or more phenotypes are measured for each organism 46 in the population under study. FIG. 27 summarizes the data that is measured as a result of steps 2602-2606 and 2650. For each organism 46 in the population under study there are at least two classes of data collected. The first class of data collected is phenotypic information 2701. Phenotypic information 2701 can be anything related to the trait under study. For example, phenotypic information 2701 can be a binary event, such as whether or not a particular organism exhibits the phenotype (±). The phenotypic information can be some quantity, such as the results of an obesity measurement for the respective organism 46. As illustrated in FIG. 27, there can be more than one phenotypic measurement made per organism 46.

The second class of data collected for each organism 46 in the population under study is cellular constituent levels 50 (e.g., amounts, abundances) for a plurality of cellular constituents (steps 1204-1206, FIG. 26A). Although not illustrated in FIG. 27, there can be several sets of cellular constituent measurements for each organism. Each of these sets could represent cellular constituent measurements measured in the respective organism 46 after the organism has been subjected to a perturbation that affects the trait under study. Representative perturbations include, but are not limited to, exposing the organism 46 to an amount of a compound. Further, each set of cellular constituents for a respective organism 46 could represent measurements taken from a different tissue in the organisms. For example, one set of cellular constituent measurements could be from a blood sample taken from the respective organism while another set of cellular constituent measurements could be from fat tissue from the respective organism.

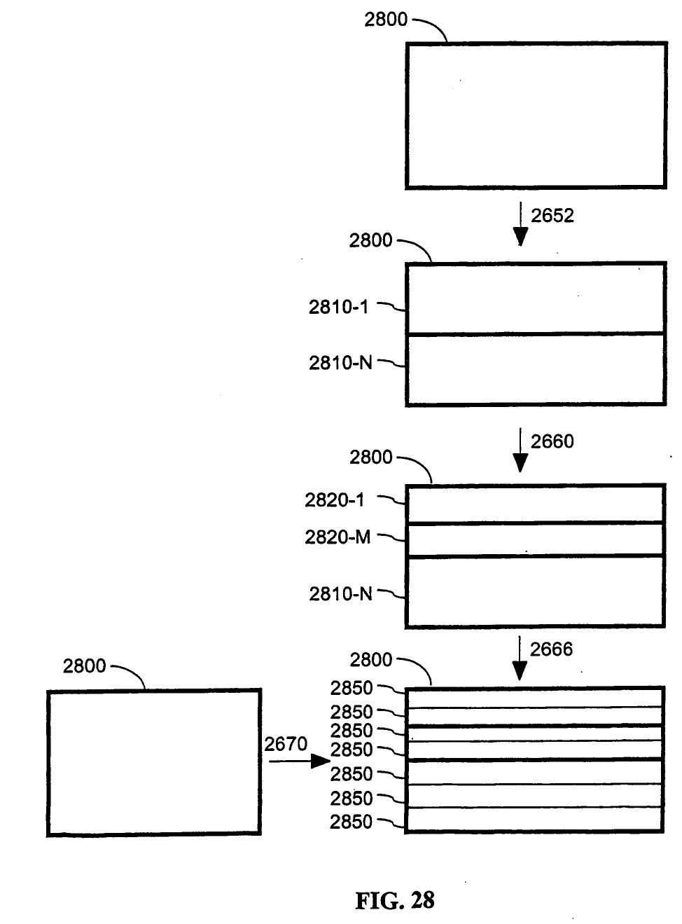

Step 2652. In step 2652 (FIG. 26A), the phenotypic data 2701 (FIG. 27) collected in step 2650 is used to divide the population into phenotypic groups 2810 (FIG. 28). The method by which step 2652 is accomplished is dependent upon the type of phenotypic data measured in step 2650. For example, in the case where the only phenotypic data is whether or not the organism 46 exhibits a particular trait, step 2652 is straightforward. Those organisms 46 that exhibit the trait are placed in a first group and those organisms 46 that do not exhibit the trait are placed in a second group. A slightly more complex example is where amounts 2701 represent gradations of a quantified trait exhibited by each organism 46. For example, in the case where the trait is obesity, each amount 2701 can correspond to an obesity index (e.g., body mass index, etc.) for the respective organism 46. In this second example, organisms 46 can be binned into phenotypic groups 2810 as a function of the obesity index.

In yet another example in accordance with the invention, several phenotypic measurements can be collected for a given organism 46. In such embodiments, each phenotypic measurement 2701 for a respective organism 46 can be treated as elements of a phenotypic vector corresponding to the respective organism 46. These phenotypic vectors can then be clustered using, for example, any of the clustering techniques disclosed in Section 5.5 in order to derive phenotypic groups 2810. To illustrate, in one example, the organisms 46 are human and measurements 2701 are derived from a standard 12-lead electrocardiogram graph (ECG). The standard 12-lead ECG is a representation of the heart's electrical activity recorded from electrodes on the body surface. The ECG provides a wealth of phenotypic data including, but not limited to, heart rate, heart rhythm, conduction, wave form description, and ECG interpretation (typically a binary event, e.g., normal, abnormal). Each of these different phenotypes (heart rate, heart rhythm) can be quantified as elements in a phenotypic vector. Further, some elements of the phenotypic vector (e.g., ECG interpretation) can be given more weight during clustering. For instance, the ECG measurements can be augmented by additional phenotypes such as blood cholesterol level, blood triglyceride level sex, or age in order to derive a phenotypic vector for each respective organism 46. Once suitable phenotypic vectors are constructed, they can be clustered using any of the clustering algorithms in Section 5.5 in order to identify phenotypic groups 2810.

In some embodiments, step 2652 is an iterative process in which various phenotypic vectors are constructed and clustered until a form of phenotypic vector that produces clear, distinct groups is identified. Of particular interest are those phenotypic vectors that are capable of producing phenotypic groups 2810 that are uniquely characterized by certain phenotypes (e.g., an abnormal ECG/ high cholesterol subgroup, a normal ECG/ low cholesterol subgroup).

Using the example presented above, phenotypic vectors that can be iteratively tested include a vector that has ECG data only, one that has blood measurements only, one that is a combination of the ECG data and blood measurements, one that has only select ECG data, one that has weighted ECG data, and so forth. Furthermore, optimal phenotypic vectors can be identified using search techniques such as stochastic search techniques (e.g., simulated annealing, genetic algorithm). See, for example, Duda et al, 2001, Pattern Recognition, second edition, John Wiley & Sons, New York.

Step 2654. In step 2654, the phenotypic extremes within the population are identified. For example, in one case, the trait of interest is obesity. In step 2654, very obese and very skinny organisms 46 can be selected as the phenotypic extremes. In one embodiment of the present invention, a phenotypic extreme is defined as the top or lowest 40^{th},30^{th},20^{th}, or 10^{th} percentile of the population with respect to a given phenotype exhibited by the population

Step 2656. In step 2656, a plurality of cellular constituents (levels 50, FIG. 27) for the species represented by organisms 46 are filtered. Only levels 50 measured for phenotypically extreme organisms 46 selected in step 2654 are used in this filtering. To illustrate using FIG. 28, consider the case in which organism 46-1 and organism 46-N represent phenotypic extremes with respect to some phenotype whereas organism 46-2 does not. Then, in this instance, levels 50 measured for organism 46-6 and 46-N will be considered in the filtering whereas levels 50 measured for organism 46-2 will not be considered in the filtering.

In some embodiments, cellular constituent levels 50 (measured in phenotypically extreme organisms) for a given cellular constituent 48 are subjected to a t-test (or a multivariate test) to determine whether the given cellular constituent 48 can discriminate between the phenotypic groups 2810 (FIG. 28) that were identified in step 2652, above. A cellular constituent 48 will discriminate between phenotypic groups when the cellular constituent is found at characteristically different levels in each of the phenotypic groups 2810. For example, in the case where there are two phenotypic groups 2810, a cellular constituent will discriminate between the two groups 2810 when levels 50 of the cellular constituent (measured in phenotypically extreme organisms) are found at a first level in the first phenotypic group and are found at a second level in the second phenotypic group, where the first and second level are distinctly different.

In preferred embodiments, each cellular constituent is subjected to a t-test without consideration of the other cellular constituents in the organism. However, in other embodiments, groups of cellular constituents are compared in a multivariate analysis in step 2656 in order to identify those cellular constituents that discriminate between phenotypic groups 2810.

Step 2658. Typically, there will be a large number of cellular constituents expressed in phenotypically extreme organisms that appear to differentiate between the phenotypic groups identified in step 2652. In some instances, this number of cellular constituents 48 can exceed the number of organisms 46 available for study. For instance, in some embodiments, 25,000 genes or more are considered in previous steps. Thus, there may be hundreds if not thousands of genes that discriminate. In some instances, these discriminating cellular constituents are analyzed in subsequent steps with statistical models that involve many statistical parameters that increase with the number of predictors. In such instances, it is desirable to reduce the number of cellular constituents sing a reducing algorithm. However, in other instances, other forms of statistical analysis are used that do not require reduction in the number of cellular constituents under consideration.

The reducing algorithms that are optionally used in step 2658 use the p-value or other form of metric computed for each cellular constituent in step 2656 as a basis for reducing the dimensionality of the cellular constituent set identified in step 2656. A few exemplary reducing algorithms will be discussed. However, those of skill in the art will appreciate that many reducing algorithms are known in the art and all such algorithms can be used in step 2658.

One reducing algorithm is stepwise regression. The basic procedure in stepwise regression involves (1) identifying an initial model (e.g. an initial set of cellular constituents), (2) iteratively “stepping,” that is, repeatedly altering the model at the previous step by adding or removing a predictor variable (cellular constituent) in accordance with the “stepping criteria,” and (3) terminating the search when stepping is no longer possible given the stepping criteria, or when a specified maximum number of steps has been reached. Forward stepwise regression starts with no model terms (i.e., no cellular constituents). At each step the regression adds the most statistically significant term until there are none left. Backward stepwise regression starts with all the terms in the model and removes the least significant cellular constituents until all the remaining cellular constituents are statistically significant. It is also possible to start with a subset of all the cellular constituents and then add significant cellular constituents or remove insignificant cellular constituents until a desired dimensionality reduction is achieved.

Another reducing algorithm that can be used in step 2658 is all-possible-subset regression. In fact, all-possible-subset regression can be used in conjunction with stepwise regression. The stepwise regression search approach presumes there is a single “best” subset of cellular constituents and seeks to identify it. In the all-possible-subset regression approach, the range of subset sizes that could be considered to be useful is made. Only the “best” of all possible subsets within this range of subset sizes are then considered. Several different criteria can be used for ordering subsets in terms of “goodness”, such as multiple R-square, adjusted R-square, and Mallow's Cp statistics. When all-possible-subset regression is used in conjunction with stepwise methods, the subset multiple R-square statistic allows direct comparisons of the “best” subsets identified using each approach.

Another approach to reducing higher dimensional space into lower dimensional space in accordance with step 2658 (FIG. 26A) of the present invention is the use of linear combinations of cellular constituents. In effect, linear methods project high-dimensional data onto a lower dimensional space. Two approaches for accomplishing this projection include Principal Component Analysis (PCA) and Multiple-Discriminant Analysis (MDA). PCA seeks a projection that best represents the data in a least-squares sense whereas MDA seeks a projection that bests separates the data in a least-squares sense. See, for example, Duda et al., 2001, Pattern Classification, Chapters 3 and 10.

The ultimate goal of step 2658 is to identify a classifier derived from the set of cellular constituents identified in step 2656 or a subset of the cellular constituents identified in step 2656 that satisfactorily classifies organisms 46 into the phenotypic groups 2810 identified in step 2652. In some embodiments of the present invention, stochastic search methods such as simulated annealing can be used to identify such a classifier or subset. In the simulated annealing approach, for example, each cellular constituent under consideration can be assigned a weight in a function that assesses the aggregate ability of the set of cellular constituents identified in step 2656 to discriminate the organisms 46 into the phenotypic classes identified in step 2652. During the simulated annealing algorithm these weights can be adjusted. In fact, some cellular constituents can be assigned a zero weight and, therefore, be effectively eliminated during the anneal thereby effectively reducing the number of cellular constituents used in subsequent steps. Other stochastic methods that can be used in step 2658 include, but are not limited to, genetic algorithms. See, for example, the stochastic methods in Chapter 7 of Duda et al., 2001, Pattern Classification, second edition, John Wiley & Sons, New York.

Step 2660. In some embodiments, the cellular constituents identified in steps 2656 and/or 2658 are clustered in order to further identify subgroups within each phenotypic subpopulation. To perform such clustering, an expression vector is created for each cellular constituent under consideration. To create an expression vector for a respective cellular constituent, the levels 2701 measured for the respective cellular constituent in each of the phenotypically extreme organisms is used as an element in the vector. For example, consider the case in which an expression vector for cellular constituent 48-1 is to be constructed from organisms 46-1, 46-2, and 46-3. Levels 50-1-1, 50-2-1, and 50-3-1 would serve as the three elements of the expression vector that represents cellular constituent 48-1. Each of the expression vectors are then clustered using, for example, any of the clustering techniques described in Section 5.5. In one embodiment, k-means clustering (Section 5.5.2) is used.

An advantage of step 2660 is that subpopulations 2820 (FIG. 28) that cannot be differentiated based upon phenotype can be identified. Such subgroups 2820 can be used to refine a classifier that classifies organisms into classes, as detailed in the following steps.

Step 2664. In step 2664, the set of cellular constituents identified as discriminators between phenotypic extremes that were identified in previous steps (or principal components derived from such cellular constituents) are used to build a classifier. This set of cellular constituents actually refines the definition of the clinical phenotype under study.

A number of pattern classification techniques can be used to accomplish this task, including, but not limited to, Bayesian decision theory, maximum-likelihood estimation, linear discriminant functions, multilayer neural networks, and supervised as well as unsupervised learning.

In one embodiment in accordance with step 2664, the set of cellular constituents that discriminate the phenotypically extreme organisms into phenotypic groups is used to train a neural network using, for example, a back-propagation algorithm. In this embodiment, the neural network serves as a classifier. First, the neural network is trained with the set of cellular constituents that discriminate the phenotypically extreme organisms into phenotypic groups. In more detail, the cellular constituent values (e.g., measured levels 50 of cellular constituents 48 selected in previous steps) from all the organisms 46 in the phenotypically extreme groups are used to train the neural network. Then, the trained neural network is used to classify the general population into phenotypic groups. In some embodiments the neural network that is trained is a multilayer neural network. In other embodiments, a projection pursuit regression, a generalized additive model, or a multivariate adaptive regression spline is used. See for, example, any of the techniques disclosed in Chapter 6 of Duda et al., 2001, Pattern Classification, second edition, John Wiley & Sons, Inc., New York.

In another embodiment in accordance with step 2664, Bayesian decision theory can be used to build a classifier using the selected cellular constituent data. Bayesian decision theory plays a role when there is some a prioi information about the things to be classified. Here, the set of cellular constituents that discriminate the phenotypically extreme organisms into phenotypic groups serves as the a priori information. More specifically, the intensity or cellular constituent levels 50 for the cellular constituents 248 selected in steps 2656-2660 from each of the phenotypically extreme organisms 46 serve as the a priori information. For more information on Bayesian decision theory, see for, example, any of the techniques disclosed in Chapters 2 and 3 of Duda et al., 2001, Pattern Classification, second edition, John Wiley & Sons, Inc., New York.

In still another embodiment in accordance with step 2664, linear discriminate analysis (functions), linear programming algorithms, or support vector machines are used to create a classifier that is capable of classifying the general population of organisms 46 into phenotypic groups 2810. This classification is based on the cellular constituent data 50 for the cellular constituents 48 that refined the definition of the clinical phenotype (i.e. the cellular constituents selected in steps 2656, 2658, and/or 2660. For more information on this class of pattern classification functions, see for, example, any of the techniques disclosed in Chapter 5 of Duda et al., 2001, Pattern Classification, second edition, John Wiley & Sons, Inc., New York.

Step 2666. In step 2666, the classifier derived in step 2664 is used to classify all or a substantial portion (e.g., more than 30%, more than 50%, more than 75%) of the population under study. Essentially, the classifier bins the remaining population (the portions of the population that do not include the phenotypic extremes) without taking their phenotypic (e.g., phenotype amounts 2701, FIG. 27) into consideration. The process of using the classifier to classify the general population produces phenotypic subgroups 2850 (FIG. 28). Phenotypic subgroups 2850 are, in fact, a refinement of the trait under study.

Step 2668. The steps leading to and including step 2660 serve to identify cellular constituents that are capable of classifying organisms into phenotypic groups. In step 2664, this set of cellular constituents is used to construct a classifier that is capable of classifying the general population under study into phenotypic groups 2810. In many pattern classification techniques, such as a back-propagation algorithm that uses a multilayer network, the classifier constructed in step 2664 will no longer be the simple subset of cellular constituents identified in steps 2656 through 2660. Rather, the form of the classifier will depend on the type of pattern recognition technique used to develop the classifier. In some embodiments, however, the classifier derived in step 2664 can be a set of cellular constituents in the case where the classification scheme is a simple decision tree (e.g., if level for constituent 5 is greater than 50 than place in phenotypic class B).

Regardless of its form, the classifier formed in step 2664 serves to further refine the phenotypic groups 2810 defined in step 2652 or the subgroups 7320 defined in step 2660. As such, the methods disclosed in this section can be used to refine a trait under study. This refinement is illustrated in FIG. 28. At the outset, the trait under study is exhibited by some population 2800 of organisms 46. In step 2652 of the method, observation of gross (visible, measurable) phenotypes (other than cellular constituent levels) related to the trait are used to divide the general population 2800 into two or more phenotypic groups 2810 (FIG. 28). In step 2660 of the method, optional clustering of select cellular constituents serves to refine a phenotypic group into subphenotypic groups 7320 (FIG. 28).

A benefit of step 2660 is that the clustering in step 2660 refines the trait under study into groups 7320 (FIG. 28) that are not distinguishable using gross observable phenotypic data (other than cellular constituent levels) such as amounts 2701 (FIG. 27). As such, optional step 2660 provides a powerful way to refine the definition of the clinical trait under study by focusing on those cellular constituents that actually give rise to the clinical trait or well reflects the varied biochemical response to that trait. However, the refinement provided in step 2660 is incomplete because it is based on only a select portion of the general population under study, those organisms that represent phenotypic extremes. Accordingly, in step 2664, a more robust classifier is built using the initial set of cellular constituents selected based upon phenotypic extremes organisms 46 as a starting point. As illustrated in FIG. 28, in step 2666, the classifier derived in step 2664 classifies the trait under study into highly refined subgroups 2850. Thus, although only gross categories such as groups 2810 or 7320 were used to develop the classifier, the classifier will split the population into clusters that can fall within groups 2810 and/or 1120. These clusters are denoted as subgroups 2850 in FIG. 28. Each of these subgroups 2850 serves to refine the trait under study. In other words, each of the subgroups 2850 is a more homogenous form of the overall trait under study. The classifier classifies the general population without considering phenotypic data (e.g. levels 2701, FIG. 27). Therefore, it is possible that the groups 2850 will not fall neatly within groups 7320 and/or 2810.

The classifier developed using the methods described in this section serves to refine the definition of a trait of interest. Thus, each group 2850 in FIG. 28 identified using the classifier represents a more homogenous population with respect to the trait of interest. Cellular constituent measurements from organisms in respective groups 2850 can be used as quantitative traits in quantitative genetic studies such as linkage analysis (Section 5.13) or association analysis (Section 5.14). It is expected that linkage analysis and/or association analysis using data from individual groups 2850 rather than the general population will provide improved results, particularly in situations where the trait under study is complex and/or is driven by many different genes. In such instances, the individual groups 2850 could represent a more homogenous population or state. Consequently the genes that drive or link to the QTL (or loci) patterns in such populations 2850 could be easier to identify than in the case where cellular constituent data form the entire population is used as quantitative traits in such studies. An example where quantitative genetic analysis on subgroups rather than the general population was used to identify genes associated with a trait of interest is provided in Schadt et al., 2003, Nature 422, p. 297.

### 6. EXAMPLES

The following examples are presented by way of illustration of the invention and are not limiting.

### 6.1. Exemplary Sources of Genotype and Pedigree Data

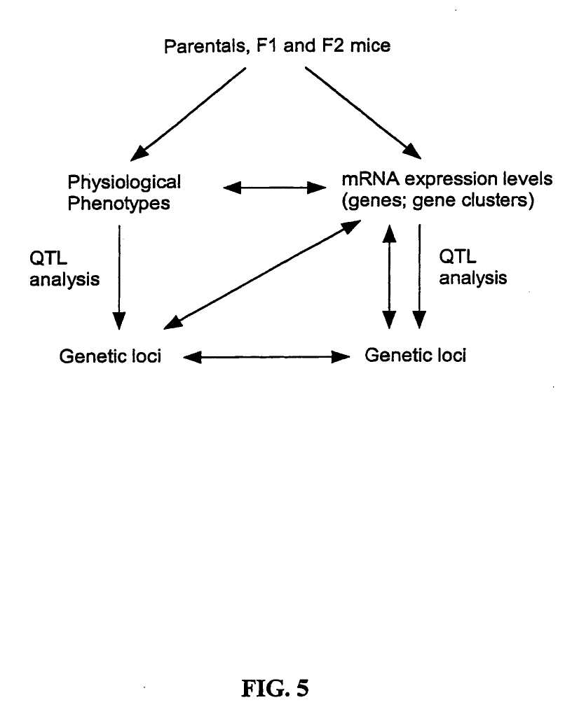

Mice. The methods of the present invention are applicable to any living organism in which genetic variation can be tracked. Therefore, by way of example, genotype and/or pedigree data 68 (FIG. 1) is obtained from experimental crosses or a human population in which genotyping information and relevant clinical trait information is provided. One such experimental design for a mouse model for complex human diseases is given in FIG. 5. In FIG. 5, there are two parental inbred lines that are crossed to obtain an F₁ generation. The F₁ generation is intercrossed to obtain an F2 generation. At this point, the F2 population is genotyped and physiologic phenotypes for each F2 in the population are determined to yield genotype and pedigree data 68. These same determinations are made for the parents as well as a sampling of the F₁ population.

Human populations. The present invention is not constrained to model systems, but can be applied directly to human populations. For example, pedigree and other genotype information for the CEPH family is publicly available (Center for Medical Genetics, Marshfield, Wisconsin), and lymphoblastoid cell lines from individuals in these families can be purchased from the Coriell Institute for Medical Research (Camden, N.J) and used in the expression profiling experiments of the instant invention. The plant, mouse, and human populations discussed in this Section represent non-limiting examples of genotype and/or pedigree for use in the present invention.

### 6.2. Identification of Regions that Broadly Control Transcription

The genome-wide consideration of all genes as quantitative traits, representation of individual QTL analysis results in a database, and summarizing the degree of overlap among all genes at all positions where a QTL analysis was run enables the identification of regions that very broadly control transcription. For a given organism, this allows for the identification of regions that potentially control for basal-level transcription levels across most genes that are expressed. An important utility that is provided by the methods of the present invention is the identification of those genes that control biological pathways and/or interactions between biological pathways as well as the separation of these genes from genes that are simply responding to the signals propagated by the potentially small set of genes.

Some approaches seek genes that have significantly co-regulated expression patterns over a number of relevant conditions. Many forms of cluster analysis and other pattern detection schemes are used to uncover such patterns. Then, techniques such as multivariate analysis are used to determine whether these co-regulated genes participate in the same biological pathway (e.g., whether these genes genetically interact or control each other). That is, multivariate techniques are used to determine whether such genes are trans acting. However, most strongly genetically controlled genes are actually the least similar, least co-regulated with respect to other genes because their expression patterns are independent of the expression patterns of other genes. Therefore, it is expected that trans acting genes (e.g., genes acting on other genes to affect gene transcription) are harder to detect than cis acting genes. An example of a cis acting gene is a gene in which variation within the gene affects transcription of the gene itself. The methods of the present invention allow for the identification of trans acting genes. The identity of trans acting genes further elucidates control of pathways and disease etiology since they are ostensibly important to the proper functioning of so many pathways.

### 6.3. Identifying Genes Under Genetic Control in Small Populations

In this example 56 individuals from four CEPH reference families (Dausset, 1990 Genomics 6:575-577) were selected for expression profiling of lymphoblastoid cell lines using a standard 25K human gene oligonucleotide microarray. The 25K human gene oligonucleotide microarray is described in van't Veer et al., Nature 415, 530-536 as well as Hughes et al., 2001, Nat. Biotechnol. 19, 342-347. Briefly, labeled cRNAs were fragmented to an average size of approximately 50-100 nucleotides by heating at 60° C. in the presence of 10 mM ZnCl₂, added to hybridization buffer containing 1M NaCl, 0.5% sodium sarcosine, 50 mM MES, pH 6.5, and formamide to a final concentration of 30%, final volume 3 ml at 40° C. The 25K human gene oligonucleotide microarray represents 24,479 biological oligonucleotides plus 1,281 control probes.

The four families, CEPH/Utah pedigrees 1362, 1375, 1377 and 1408, consisted of large sibships along with parents and grandparents. These CEPH families have served as an important scientific resource for polymorphism discovery and human genetic map construction. Hence, extensive genotype data is publicly available for these families.

Lymphoblastoid cell lines from CEPH/Utah pedigree families 1362,1375,1377 and 1408 were obtained from Coriell Cell Repositories, Camden, N.J. Other lymphoblastoid cell lines were established from normal donors by immortalization with Epstein-Barr Virus (EBV) as described by Tosatio, Generation of Epstein-Barr Virus (EBV)-immortalized B cell lines, Current Protocols in Immunology 1, 7.22.1-7.22.3, John Wiley & Sons, New York, 1991. Cells were cultured in RPMI 1640 medium containing 15% fetal bovine serum, and peniciliinistreptomycin antibiotics (Invitrogen Life Technologies, Carlsbad, Calif.). Cells were maintained in the log phase of cell growth for at least two days and were harvested at densities of 0.4- 0.9×10e⁶ cells/ml. Total cellular RNA was then purified using an RNeasy Mini kit according to the manufacturer's instructions (Qiagen, Valencia, Calif.). Competitive hybridizations were performed by mixing fluorescently labeled cRNA (5 μg) from each CEPH/Utah lymphoblastoid line with the same amount of cRNA from a reference pool, comprising equal amounts of cRNA from lymphoblastoid lines established from seven unrelated normal blood donors. The human microarray contained 24,479 non-control oligonucleotide probes for human genes. The hybridizations were performed in duplicate with fluor reversal.

Array images were processed to obtain background noise, single channel intensity, and associated measurement error estimates. Expression changes between two samples were quantified as log₁₀ (expression ratio) where the ‘expression ratio’ was taken to be the ratio between normalized, background-corrected intensity values for the two channels (red and green) for each spot on the array. An error model for the log ratio was applied to quantify the significance of expression changes between two samples. See Roberts et al., 2000, “Signaling and Circuitry of Multiple MAPK Pathways Revealed by a Matrix of Global Gene Expression Profiles,” Science 287, 873-880.

Genotype data for the four CEPH families was obtained from the CEPH Genotype database (Murray et al., 1994, Science 265, 2049-2054,). A total of 495 autosomal STR polymorphisms were selected for analysis. Polymorphisms were chosen so that genotypes were available for all but three or fewer individuals per pedigree with this condition being true in at least three of the pedigrees. Marker positions were assigned using a Marshfield sex-averaged genetic map (Broman et al., 1998, Am J. Hum. Genet. 63, 861-869). Variance-components analysis (Amos, 1994, Am J. Hum. Genet. 54, 535-543) was used to estimate the heritability of gene expression, as measured by the mean log₁₀ expression ratio, for each of the 2,726 mRNA that were significantly differentially expressed in the founders, and to test whether the heritability was significantly different from zero. Genes were defined as differentially regulated if eight or more founders had a p-value for differential expression less than 0.05. Heritability estimates were obtained by maximizing the likelihood assuming a multivariate normal distribution for the vector of phenotypes for the pedigree. The null hypothesis of no heritability was tested by comparing the full model, which assumes genetic variation, and a reduced model, which assumes no genetic variation, using a likelihood ratio test. The above analyses was repeated allowing for a shared household effect. All analyses were performed using procedures contained in the Sequential Oligogenic Linkage Analysis Routines (SOLAR) package (Almasy and Blangero, Am. J. Hum. Genet. 62, 1198-1211, 1998).

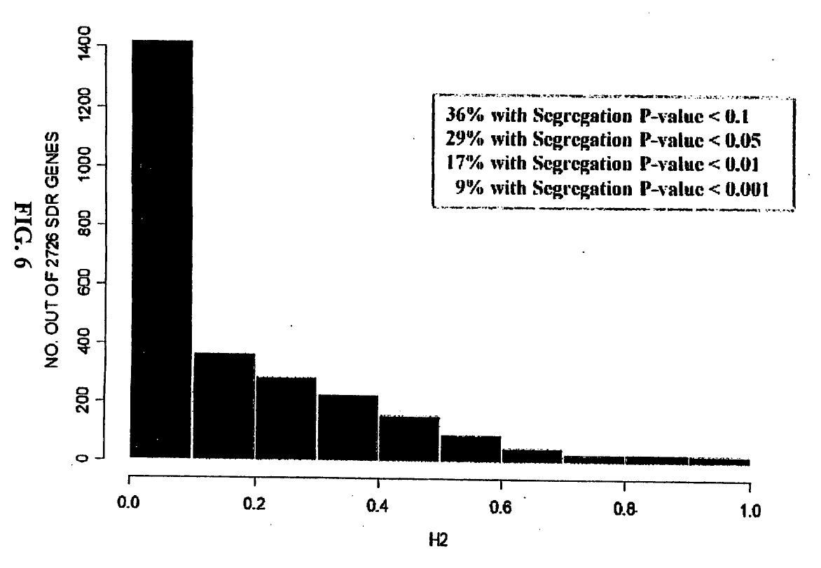

As described above, heritability analysis was performed for gene expression on a subset of 2,726 genes that were significantly differentially regulated within 8 or more of the 16 pedigree founders. Due to the relatively small population size, systematic linkage analysis across all genes was not performed. As indicated in FIG. 6, for the differentially expressed genes, 29% had a detectable genetic component (Type I error<0.05). This result offers a striking glimpse into the genetics of gene expression in humans, with such a large percentage of genes detected with significant heritabilities in such a small sample of “normal” individuals. The group of genes having a detectable genetic component makes good targets for complex human diseases, given the degree of genetic control in these genes is so readily identifiable in this small population. A closer look at many of the genes with most significant heritabilities show that many have already been implicated in human complex diseases: 1) Coagulation Factor XIII, associated with thrombosis (Franco et al., 1999, Thromb. Haemost 81, 676-679), 2) Vitamin D Receptor, associated with osteoporosis (Ralston, 2002, J. Clin Endocrinol Metab 87, 2460-2466), 3) BCAR1, potentially associated with resistance to breast cancer treatment (Brinkman et al., 2000, J Natl Cancer Inst 92, 112-120), 4) Glycophorin C, associated with red blood cell ovalocytosis and malaria resistance (Mgone et al., 1996, Trans R Soc Trop Med Hyg 90, 228-231), 5) Catenin, expressed in colon cancer (Morin et al., 1997, Science 275, 1787-1790), and 6) Cubilin null mutations have been associated with hereditary megaloblastic anemia (Aminoff et al., 1999, Nat Genet 21, 309-313).

### 6.4. Genetic Analysis of the Mouse Transcriptome

The following example illustrates how the methods of the present invention uncover significant patterns of gene interactions. In particular, the example demonstrates how QTL that are linked to quantitative traits (e.g. expression statistic sets 304) cluster to specific loci. As defined previously, a QTL is a region of any genome that is responsible for variation of a quantitative trait. A QTL that is linked to a given expression statistic set 304 is referred to as an “expression QTL” or “eQTL”. Further, the example illustrates how quantitative trait locus analyses can detect several types of transcript abundance polymorphisms, such as differential transcript decay, differential dosing, differential splicing, and differential transcription rate. As such, this example illustrates the type of information that can be obtain by performing steps 202 through 210 of FIG. 2.

An F2 intercross was constructed from C57BL/6J and DBN2J strains of mice. All mice were housed under conditions meeting the guidelines of the Association for Accreditation of Laboratory Animal Care. Mice were on a rodent chow diet up to 12 months of age, and then switched to an atherogenic high-fat, high-cholesterol diet for another four months. Parental and F2 mice were sacrificed at sixteen months of age. At death the livers were immediately removed, flash-frozen in liquid nitrogen and stored at −80° C. Total cellular RNA was purified from 25 μg portions using an Rneasy Mini kit according to the manufacturer's instructions (Qiagen, Valencia, Calif.). Competitive hybridizations were performed by mixing fluorescently labeled cRNA from each of 111 F2 liver samples, 5 DBA/2J liver samples, and 5 C57BL/6J liver samples, with the same amount of cRNA from a reference pool comprised of equal amounts of cRNA from each of the 121 samples profiled.

Liver tissue from the 111 F2 mice constructed from two standard inbred strains of mice, C57BW/6J and DBA/2J, were profiled using a 25K mouse gene oligonucleotide microarray. The hybridizations were performed in duplicate using fluor reversal. The mouse microarray contained 23,574 non-control oligonucleotide probes for mouse genes and 2,186 control oligos. Full-length mouse sequences were extracted from Unigene clusters, build #91 (Schuler et al., 1996, Science 274, 540-546), and combined with RefSeq mouse sequences (Pruitt and Maglott, Nucleic Acids Research 29, 137-140, 2001), and RIKEN full-length sequences, version fantom 1.01 (Kawai et al., Nature 409, 685-690, 2001). This collection of full-length sequences was clustered and one representative sequence per cluster was selected, resulting in 18,597 fill-length mouse sequences. To complete the array, 3′ ESTs were selected from Unigene clusters that did not cluster with any full-length sequence from Unigene, RefSeq, or RIKEN. To down-select ESTs, 3′ ESTs that had significant homology to human genes were chosen, resulting in 4,977 3′ mouse ESTs with human homology. To select a probe for each gene sequence, a series of filtering steps was used, taking into account repeat sequences, binding energies, base composition, distance from the 3′ end, sequence complexity, and potential cross-hybridization interactions (Hughes et. al., Nat Biotechnol. 19, 342-347, 2001). For each gene, every potential 60-nucleotide sequence was examined and the 60-mer best satisfying the criteria was selected and printed on the microarray.

Array images were processed to obtain background noise, single channel intensity, and associated measurement error estimates using the techniques described in Schuler et al., 1996, Science 274, 540-546. Expression changes between two samples were quantified as log₁₀ (expression ratio) where the ‘expression ratio’ was taken to be the ratio between normalized, background-corrected intensity values for the two channels (red and green) for each spot on the array. An error model for the log ratio was applied to quantify the significance of expression changes between two samples. This error model is described in Roberts et al., 2000, Science 287, 873-880. This error model for the log ratio was applied to quantify the significance of expression changes between the two samples.

The expression values from these experiments were treated as quantitative traits and carried through a linkage analysis using evenly spaced markers across the autosomal chromosomes, to identify eQTL controlling for transcript abundances in this segregating population (FIG. 2, step 210). For this QTL analysis, a complete linkage map for all chromosomes except the Y chromosome in mouse was constructed at an average density of 13 cM using microsatellite markers in the manner described by Drake et al. (J. Orthop. Res. 19, 511-517, 2001). Linkage maps were constructed and QTL analysis was performed using MapMaker QTL (Lander et al., Genomics 1, 174-181, 1987) and QTL Cartographer (Basten and Zeng, 1994, Zmap-a QTL cartographer, Proceedings of the 5th World Congress on Genetics Applied to Livestock Production: Computing Strategies and Software, Smith et al. eds., 22,65-66, The Organizing Committee, 5th World Congress on Genetics Applied to Livestock Production, Guelph, Ontario, Canada; Basten et al., 2001, QTL Cartographer, Version 1.15, Department of Statistics, North Carolina State University, Raleigh, N.C.). Log of the odds ratio (lod) scores were calculated at 2-cM intervals throughout the genome for each of the 23,574 genes represented on the mouse microarray. In addition to standard interval mapping techniques employed to detect loci affecting the gene expression traits of interest, additional analyses were performed to determine whether controlling for genetic background variation using makers outside a putative region of linkage and whether multiple traits considered simultaneously could increase evidence for linkage. Composite interval mapping (“CIM”) techniques were employed so that markers unlinked with the test position were considered as cofactors in the statistical model for marker-trait association. Given multiple quantitative traits, CIM analysis can be extended to consider multiple traits simultaneously, potentially dramatically increasing the power to detect loci affecting the traits of interest. Joint CIM analysis is currently implemented in the QTL Cartographer software.

Of the 23,574 genes represented on the microarray, 7,861 were detected as significantly differentially expressed (Type I error=0.05) in at least ten of the mice profiled. That is, the expression values for the candidate gene varied across the mouse population. Such behavior is in contrast to the case where a gene is not significantly differentially expressed across a mouse population because, for example, it is always expressed at the same level or is rarely expressed at all. In this experiment, genes that are differentially expressed are of interest for use in constructing expression statistic sets 304 (e.g., FIGS. 3A and 3B).

Each of the 7,861 genes that exhibited differential expression were used to construct a respective expression statistic set 304 (e.g., FIGS. 3A and 3B). That is, each set 304 corresponded to the expression value for one of the 7,861 differentially expressed genes from each of the 111 F2 mice. Each set 304 therefore included 111 expression statistics 308 (FIGS. 3A and 3B) and each of these expression statistics 308 represented the expression value for the same gene from each of the 111 mice. These expression statistics sets 304 as well as a mouse genetic marker map 78 (FIG. 1) were used as input to standard QTL analysis software (FIG. 2, steps 208 and 210). Using such standard QTL analysis techniques, eQTL with a lod score greater than 4.3 (P-value<0.00005) were identified for 2,123 genes. The lod scores over this set ranged from 4.3 to 80.0 (pvalue<<10⁻²⁰), among the highest lod scores ever reported for a quantitative trait. On average, eQTL with lod scores greater than 4.3 explained twenty-five percent of the transcription variation of the 7,861 corresponding genes observed in the F2 set, with this percentage increasing to nearly 50% for lod scores greater than 7. For any given position, it is expected that no false positive eQTL over the 7,861 differentially expressed genes tested. If the multiple positions tested for each gene is taken into account, it is expected that only 393 false positives at a lod score threshold of 4.3.

In processing all genes with standard interval mapping techniques (without filtering on significant differential expression over the set of mice profiled), 4,339 eQTL over 3,701 genes were detected with lod scores greater than 4.3. When the lod score threshold was dropped to 3.0, 11,021 genes gave rise to at least one eQTL, with a total of 17,415 eQTL over this set of genes. The number of eQTL with lod scores exceeding 7.0 (p-value=10⁻³) jumped by 50% when genes that were not detected as significantly differentially regulated in ten or more mice were considered. This indicates that, while individual tests of hypotheses on the differential regulation of a single gene may not be significant, viewing the behavior of that gene by genotype over II1 animals provides sufficiently more information on the biological activity of that gene. Of the 965 genes with lod scores greater than 7.0, 157 has a maximum log ratio separation among any two mice of less than 0.48 (less than 3.0 fold change), indicating a class of genes whose high lod scores reflect tight transcriptional control (small variance), not large expression differences. Additionally, 153 genes from this same set of 965 were expressed in mice homozygous for one of the parental stains at the genes' location, but not detectably expressed in mice homozygous for the other parental strain.

The distribution of the number of eQTL per chromosome as it relates to the number of mapped genes was computed. Chromosomes 9, 10, and 19 stood out as having a significantly larger fraction of eQTL than genes. In addition, it was determined that at a lod score of 4.3, over 80% of the genes have only a single eQTL, with only 10% of the genes having more than two detected eQTL. The view at a lower lod score threshold presents a slightly more complex picture, given the appearance of many more genes under the control of multiple loci, with roughly 60% of the genes having a single eQTL and close to 4% of the genes having 3 or more detected eQTL. While a 3.0 lod score does not meet genome-wide significance criteria (See Lander & Kruglyak, 1995, Nat Genet 11, 241-247) in a single trait setting and while this significance is even more questionable in a multiple-testing setting where a large number of traits is considered, the pattern of eQTL clustering to specific loci and the relationship between these genes with respect to expression, when taken together, give rise to significant patterns of gene interactions. This idea is more fully discussed in examples described below.

Of the 23,574 genes represented on the mouse array, 9,331 could be reliably mapped to a unique chromosome location using the Ensembl and Refseq databases. See Hubbard et al., 2002, Nucleic Acids Research 30, 38-41, and Pruitt and Maglott, 2001, Nucleic Acids Res 29, 137-140. Of these 9,331 mapped genes, 1,912 had eQTL with lod scores greater than 4.3 and 664 had eQTL with lod scores greater than 9.0. Only thirty-five percent of the mapped genes with eQTL exceeding 4.3 had a physical location coincident with the eQTL position. However, 78% of the mapped genes with eQTL exceeding 9.0 had a physical location coincident with its eQTL position. Due to the unreliable nature of QTL positioning in the type of experimental cross used in this experiment as well as the relatively small population of animals used, an eQTL and gene were defined as coincident when the physical location of the gene mapped to within 15 cM of its eQTL. By chance alone, it would be expected that the physical location of genes would coincide with their eQTL positions fewer than 2% of the time. Therefore, eQTL with high lod scores act in cis in most cases, while moderately significant eQTL act in trans in most cases. This is consistent with the expectation that first order effects (DNA variations in a gene that affect transcription of the gene itself) are easier to detect than second order effects (genes acting on other genes to affect transcription), and suggests that transcriptional control appears to be more Mendelian in nature for cis-acting cases, and more polygenic in nature for trans-acting cases.

There are many possible explanations for significant eQTL identified for transcript abundance measurements. While the genetic regulation of transcription explains only a percentage of protein diversity, the extent of biologically meaningful polymorphisms that can be detected in this setting is surprising. In addition, additive and dominance effects in genes whose transcription is polymorphic can be teased apart in experimental crosses such as the one described in this example.

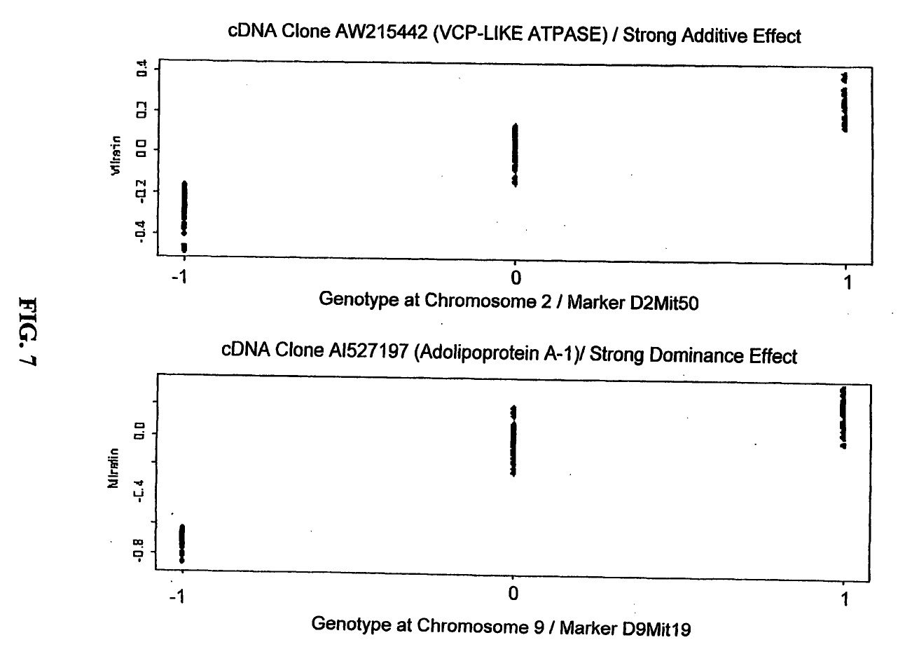

FIG. 7 illustrates a plot of the mean log 10 expression ratios for the Apo-A1 gene (lower panel) and a VCP-like ATbase gene (upper panel) by genotype at markers D9Mit19 (lod score equal to 32.5) and D2Mit50 (lod score equal to 54.3), respectively. Both the Apo-A1 gene and the VCP-like ATPase gene have lod scores exceeding 30.0. The highly significant eQTL are explained by the significant separation of the expression ratios between the genotypes and the tight variance within each genotype group. The eQTL effect at the VCP-like ATPase gene is mostly additive, given the differences in expression between the heterozygotes (“0”) and DBA homozygotes (“−1”), and between the heterozygotes (“0”) and B6 homozygotes (“+1”), are roughly equal. The eQTL effect at the Apo-Al locus has a large dominance component evidenced by the large expression separation between the DBA homozygotes (“−1”) and the heterozygotes (“0”), and the small separation between the B6 homozygotes (“+1”) and the heterozygotes (“0”). In summary, the eQTL for Apo-A1 demonstrates strong dominance and the QTL for the VCP-like ATPase demonstrates simple additive effects. Overall, for the 4,339 QTL with lods greater than 4.3, 20% demonstrated a significant dominance effect (lod associated with dominance effect greater than 3.0).

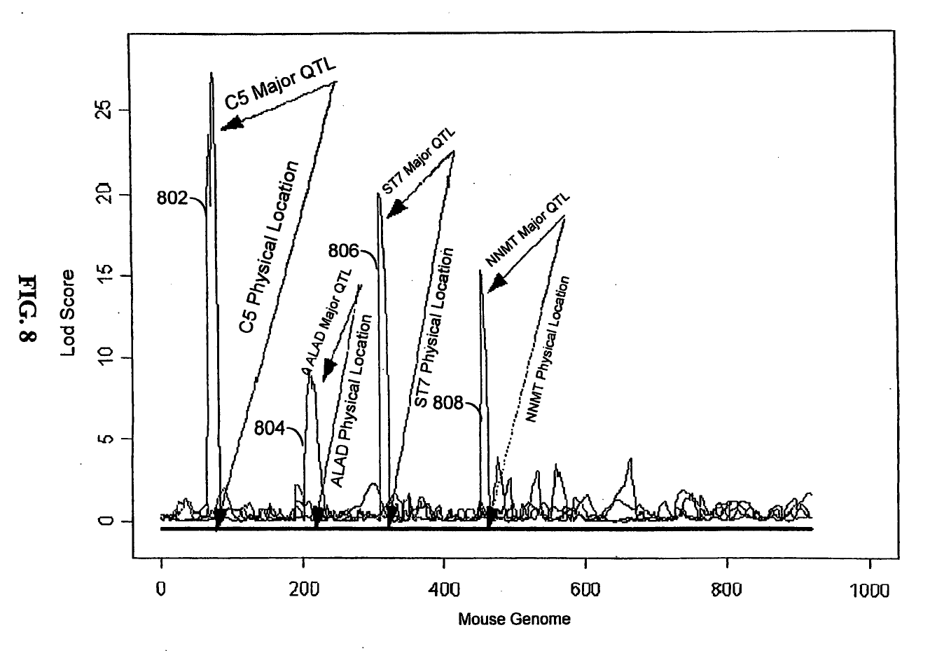

FIG. 8 highlights a range of gene-centered polymorphisms known to exist between DBA and B6 mouse strains. In each of the examples highlighted, the loci identified by linkage to the transcript abundances of the genes listed were coincident with the physical location of the gene itself. Single nucleotide polymorphisms covered by 60-mer oligonucleotide probes would not be expected to significantly affect transcript abundance measurements among the samples (See Hughes, et al., 2001, Nat Biotechnol 19, 342-347), but polymorphisms that lead to changes in transcript half-life, that directly enhance promoter and transcription factor binding sites, or more significant polymorphisms, such as insertions and deletions that could arise by alternative splicing, all provide signatures that are readily detectable by the examination of expression levels in a segregating population.

In particular, FIG. 8 illustrates examples of four types of transcript abundance polymorphisms (differential transcript decay, differential dosing, differential splicing, and differential transcription rate) readily detected by eQTL analysis. More details on these observations are provided in Section 6.5 below. The mouse C5 gene has a two base pair deletion in a 5′ exon in the DBA strain, which causes a more rapid decay of the transcript in DBA compared to the B6 mouse strain See, for example, Karp et al., 2000, “Identification of complement factor 5 as a susceptibility locus for experimental allergic asthma,” Nat. Immunol. 1, 221-226. A lod score of 27.4 centered over the C5 gene on chromosome 2 is readily detected (curve 802). The ALAD gene is present in two copies in the DBA strain and only one copy in the B6 strain. See, for example, Claudio et al., 1997, “A murine model genetic susceptibility to lead bioaccumulation,” Fundam Appl Toxicol 35, 84-90. The major QTL (lod score of 9.3) for ALAD transcript abundances is centered over the ALAD gene (curve 804) and represents the differential dosing that occurs between the two strains, due to the different copy numbers. The ST7 gene is differentially spliced at several locations (See Huang et al., 2002, Nucleic Acids Res 30, 186-190), and for a stable splice form at the 3′ location of the gene, the probe for this gene fortuitously overlapped the region alternatively spliced out in DBA, but not B6. The differential splicing event is detected by the major QTL (lod score of 20.1) for ST7, which is centered over the ST7 gene (curve 806). Finally, the NNMT gene, important for drug metabolism, is known to be polymorphic with respect to transcription between the DBA and B6 strains. See, for example, Huang et al., 2002, “Putative Alternative Splicing database,” Nucleic Acids Research 30, 186-190. This polymorphism is confirmed by a major QTL (lod score of 15.3) for the NNMT gene, centered over the NNMT gene (curve 808).

Identification of cis-acting transcriptional control can serve as a filter for associating polymorphisms in DNA sequence with polymorphisms in transcription. For instance, while the DNA variations noted in FIG. 8 lead to transcriptional polymorphisms, the insulin-like growth factor binding protein complex acid labile chain (Igfals) has five SNPs identified between the B6 and DBA strains, two of which are mis-sense mutations: 1) codon 165 is arginine in DBA and glutamine in B6 and 2) codon 69 is glycine in DBA and serine in B6. Igfals is significantly differentially expressed in 18 of the 1 11 samples, and has two suggestive linkages on chromosomes 1 1 (lod=2.72) and 18 (lod=2.5), but is physically mapped to chromosome 17, where no linkage is detected. One can conclude from this that the polymorphisms in the sequence of this gene do not give rise to variation in its transcript levels, unlike those cases highlighted in FIG. 8.

### 6.5. Types of Polymorphisms that can be Detected Using Expression QTL Analysis

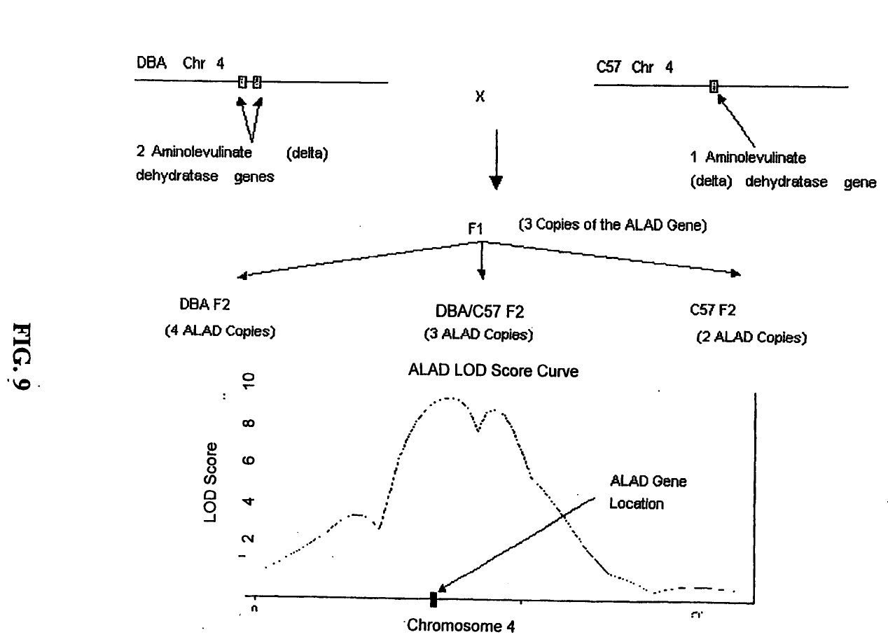

Some embodiments of the QTL analysis performed in step 210 (FIG. 2) or step 1910 (FIG. 9) are limited in the sense that the transcription must be polymorphic in the population under study in order for QTL for that transcription to be detected. However, the types of DNA polymorphisms that lead to transcription polymorphisms are extensive, and this example illustrates how QTL analysis on gene expression data is capable of detecting many of these polymorphisms. This example specifically includes (1) identifying QTL for genes that have a higher copy number in one parent than the other (2) identifying QTL associated with differential splicing between two strains (3) identifying QTL associated with a differentially expressed gene between two strains where polymorphisms in the promoter/regulatory regions of the gene explain the differential expression, and (4) identifying QTL for genes that have a nonsense mutation in one parent but not the other. It will be appreciated that, in some embodiments, protein levels are used as quantitative traits in step 210 (FIG. 2) or step 1910 (FIG. 9) rather than transcription levels.

Referring to FIG. 9, the ALAD gene is present in two copies in DBA/2J and a single copy in C57BL/6J, and the gene is known to be expressed in liver. In the F2 generation there are three possible genotypes at the ALAD locus leading to different ALAD copy numbers: 1) homozygous for DBA, giving four total copies of the ALAD gene, 2) heterozygous, giving three total copies of the ALAD gene, and 3) homozygous for C57BL/6J, giving two total copies of the ALAD gene. As illustrated in FIG. 9, the differential expression due to the three different doses is detected in the F2 data. First, the gene is identified as differentially expressed between the parent and F2 stains. Second, a high lod score for ALAD expression that is coincident with the gene's physical location is found using processing steps 202 through 210 of FIG. 2. In particular, an expression statistic set 304 for the ALAD expression level is used as the quantitative trait in a QTL analysis that mouse strains as well as the phenotype data from the DBA/2J, C57BL/6J cross.

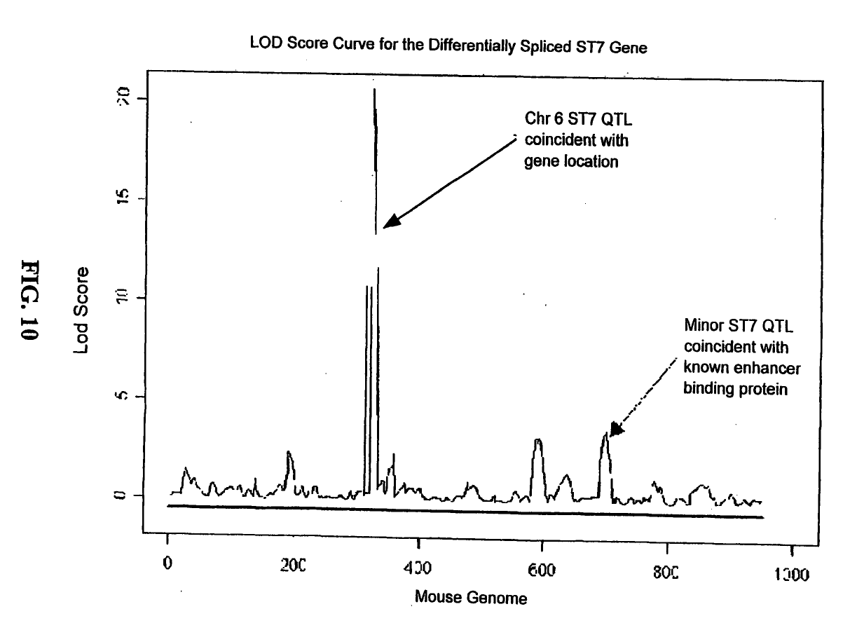

Referring to FIG. 10, the Putative Alternative Splicing DB (PALS DB) for murine genes are predicted to be alternatively spliced with very high confidence. Approximately 200 genes had a significant lod score (lod>5.0) in the mouse data set described in Example 6.4 above (liver tissue from 111 F2 mice constructed from two standard inbred strains of mice, C57BW/6J and DBA/2J). Probe sequences used on the arrays for each of the 200 genes were mapped to the sequences for those genes. The probes that overlapped the predicted splice sites were identified. Of the 200 genes with significant lod scores, five had predicted splice sites that overlapped probe sequences. FIG. 10 shows one of these examples. The ST7 gene has a stable splice form in DBA that has an approximate 30 base pair stretch deleted, compared to B6. The lod score curve plot in FIG. 10 demonstrates how the QTL analysis picks up this differential splicing event, since not only is the gene detected to be significantly differentially expressed in the F2 and between the parental strains, but this differential expression leads to a very significant QTL for the ST7 gene that is coincident with the physical location of the ST7 gene. Note that the lod score plot covers the entire genome in this case. In addition, there is a minor QTL on one of the chromosomes that happens to coincide with an enhancer binding protein that is known to be involved in differential splicing. So, not only can splicing events be detected, but the genetic determinants behind the alternative splicing can begin to be understood.

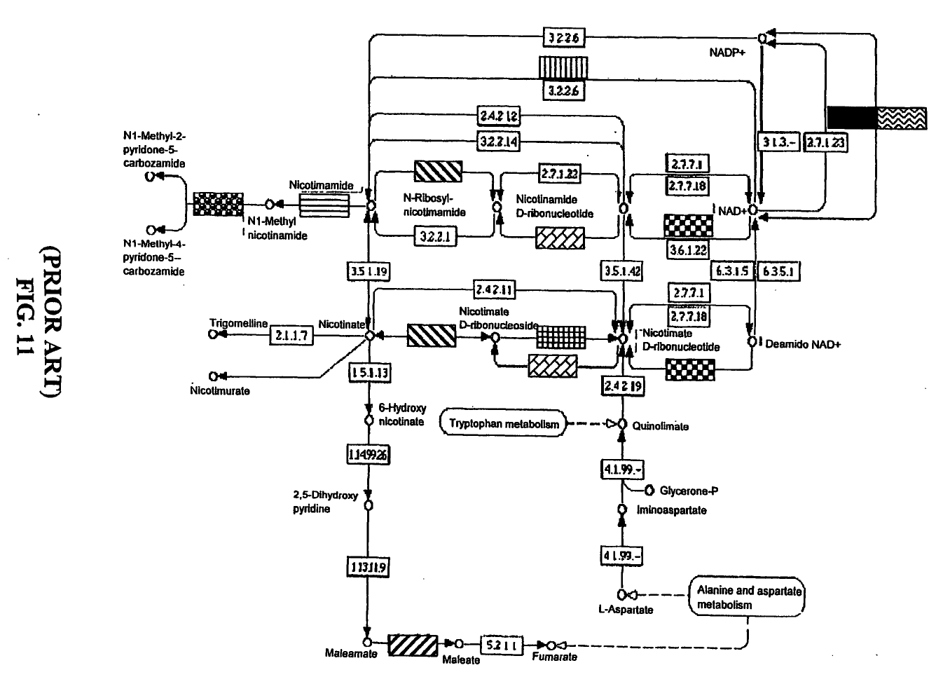

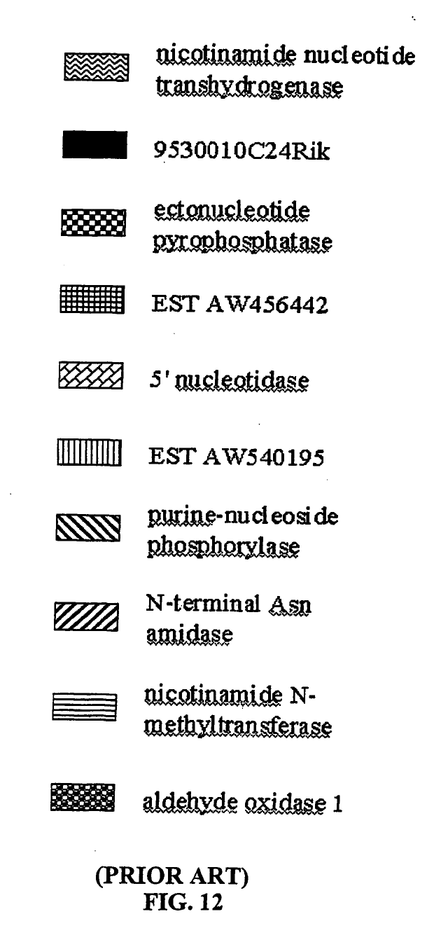

Referring to FIGS. 11 and 12, the nicotinamide N-methyltransferase gene codes for an enzyme that is critical to drug metabolism. Others have shown polymorphisms in the promoter for this gene are responsible for its differential expression between the DBA and B6 mouse strains. The following table demonstrates that this differential expression is detected since the expression levels of this gene give rise to a QTL with a lod score of 20.1 that is coincident with the physical location of the gene.

| | Physical Gene Location | | QTL Locations | | QTL Peak |
|---|---|---|---|---|---|
| Gene Name | (Chromosome/Location | | (Chromosome/Location) | | Lod Scores |
| nicotinamide nucleotide | 13/64.0 | cM | 13/107 | cM | 8.7 |
| transhydrogenase | | | | | |
| 9530010C24Rik | Unknown | | 6/39.5 | cM | 2.2 |
| ectonucleotide | 15/30.0 | cM | 15/26.3 | cM | 10.3 |
| pyrophosphatase | | | | | |
| EST AW456442 | 11 | | not available | | not |
| | | | | | available |
| 5′ nucleotidase | 9 | | 6/39.5 | | 2.5 |
| | | | 9/10.0 | | 3.1 |
| EST AW540195 | 5/25.0 | cM | not available | | not |
| | | | | | available |
| purine-nucleoside | 14/19.5 | cM | 9/1.0 | cM | 2.4 |
| phosphorylase | | | | | |
| N-terminal Asn amidase | 16/8.7 | cM | 2/79.9 | cM | 2.2 |
| | | | 14/22.0 | cM | 3.9 |
| nicotinamide N- | 9/29.0 | cM | 9/5.0 | cM | 20.1 |
| methyltransferase | | | 13/88.0 | cM | 2.6 |
| aldehyde oxidase 1 | 1/23.2 | cM | 16/1.0 | cM | 2.1 |

The pathways associated with nicotinate and nicotinamide metabolism are fairly well known. FIG. 11 illustrates these different pathways. FIG. 12 provides a key for the important genes that are found in the pathways illustrated in FIG. 11. The table above gives the physical location for these key genes in addition to any QTL for those genes represented on the mouse array that were detected using the expression values of those genes in QTL analysis (FIG. 2, steps 202 through 210). The table shows that several of the genes involved in this pathway have QTL co-localized with the major chromosome 9 nicotinamide N-methyltransferase QTL. In addition, several of the other genes in this pathway are polymorphic with respect to expression (nicotinamide nucleotide transhydrogenase and ectonucleotide pyrophosphatase), with QTL coincident with the physical gene location. Further, several of the other genes in this pathway have QTL co-localizing with these major QTL. The results summarized in the table above show that the cross talk going on between genes in the same biochemical pathway are detectable using the combination of genetics and gene expression.

None of the genes described in the table above colocalize as clusters in a gene expression cluster map (FIG. 2, step 216). Thus, analysis of a gene expression map would not have tied these genes together. Rather the relationships were discovered by treating the expression level of each respective gene in a plurality of organisms as a quantitative trait in a QTL analysis regimen (FIG. 2, steps 202 through 210).

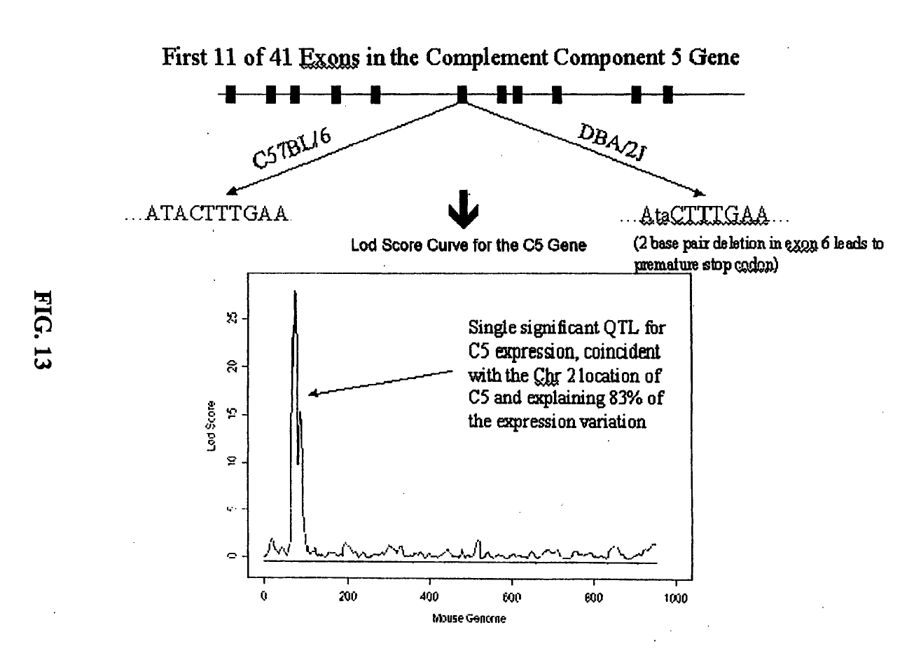

Referring to FIG. 13, the complement component 5 gene (C5) has a two base pair deletion in exon 6 in the DBA strain, but not in the B6 strain. Others have associated C5 in these two strains with complex diseases, such as asthma and arthritis. The gene is detected as differentially expressed between the two strains because the two base pair deletion in DBA leads to a premature stop codon, which causes the transcripts to be degraded more rapidly. The lod score plot in FIG. 13 covers the genetic signal for the C5 gene over the entire mouse genome. From FIG. 13, it seen that the only significant spike occurs at the chromosome 2 position where the C5 gene physically resides. The lod score in this case is 28, which means that more than 90% of the variation in the C5 gene in this F2 population is explained by the two base pair deletion.

### 6.6. Colocalization of eQTL for Lipid Metabolism Genes Reveals a QTL Hot Spot that is a Possible Causative Agent for the eQTL

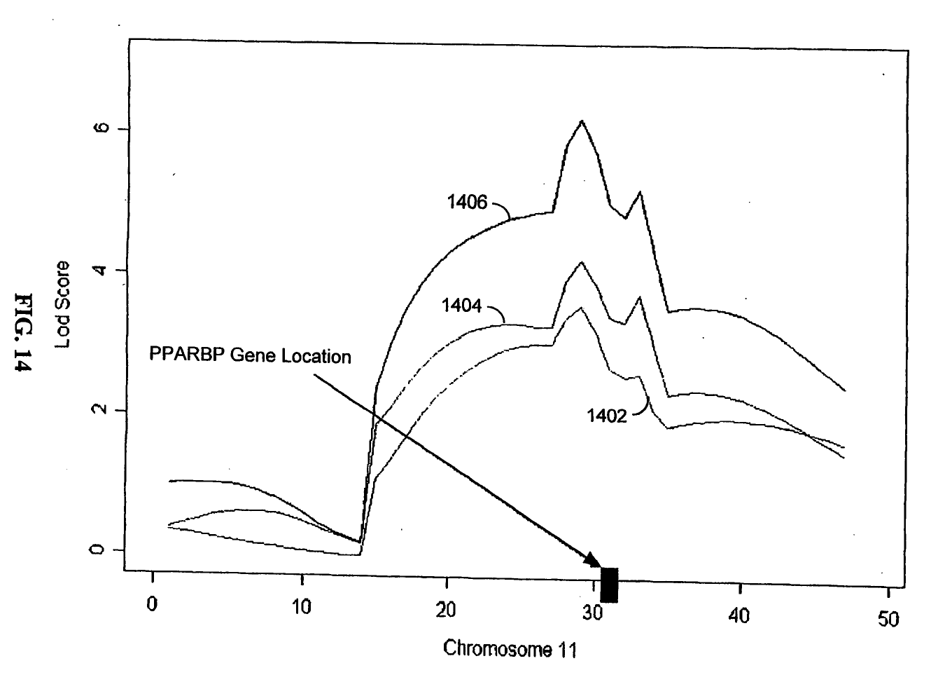

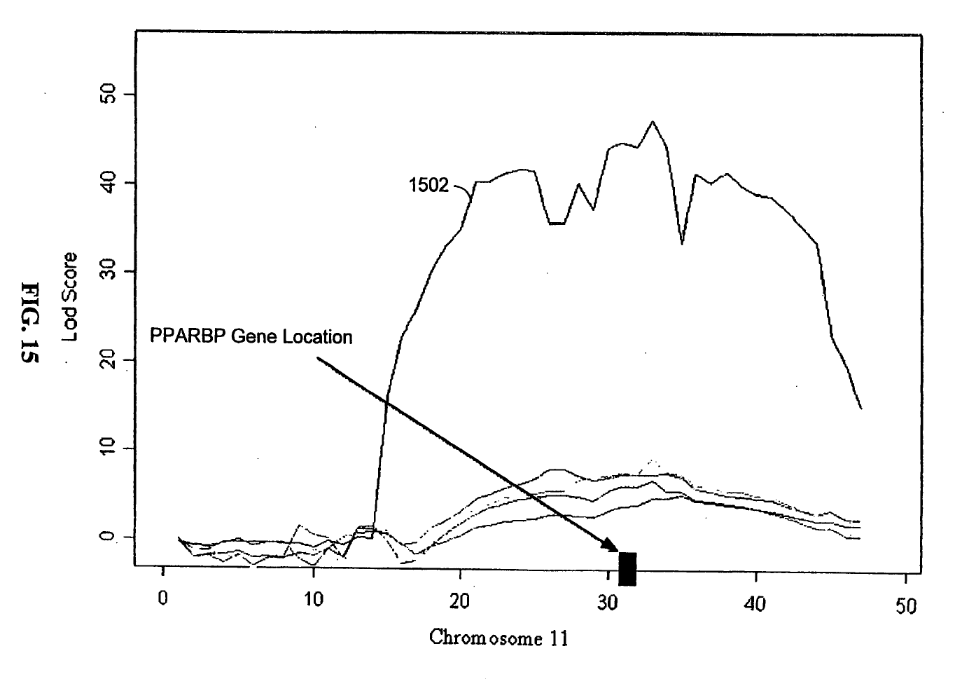

In this example, mice from a C57BL/6J×DBA/2J cross were placed on a chow-fed diet through four months of age, and at four months various phenotypic measurements were taken and the mice were then placed on a high-fat diet. At six months of age, the mice were sacrificed and scored with respect to over sixty traits, such as adiposity, retroperitoneal fat pad, body weight, fat pad mass, omental fat pad, perimetrial fat pad, subcutaneous fat pad, and total cholesterol. Each of these phenotypic traits may be used to identify linking QTL using standard QTL analysis. FIG. 14 illustrates the results of one such QTL analysis in a region of mouse chromosome 11 for the phenotypic traits “free fatty acid” (curve 1402) and “triglyceride level” (curve 1404). Curve 1406 is the joint lod score curve. Expression QTL (“eQTL”) (not shown in FIG. 14) from approximately 40 genes known to be involved with glucose and lipid metabolism overlap the “free fatty acid” and “triglyceride level” clinical trait QTL (“cQTL”). FIG. 15 highlights five of these genes. Each of these five genes has an eQTL that co-localizes with the “fatty acid” and “triglyceride” cQTL.

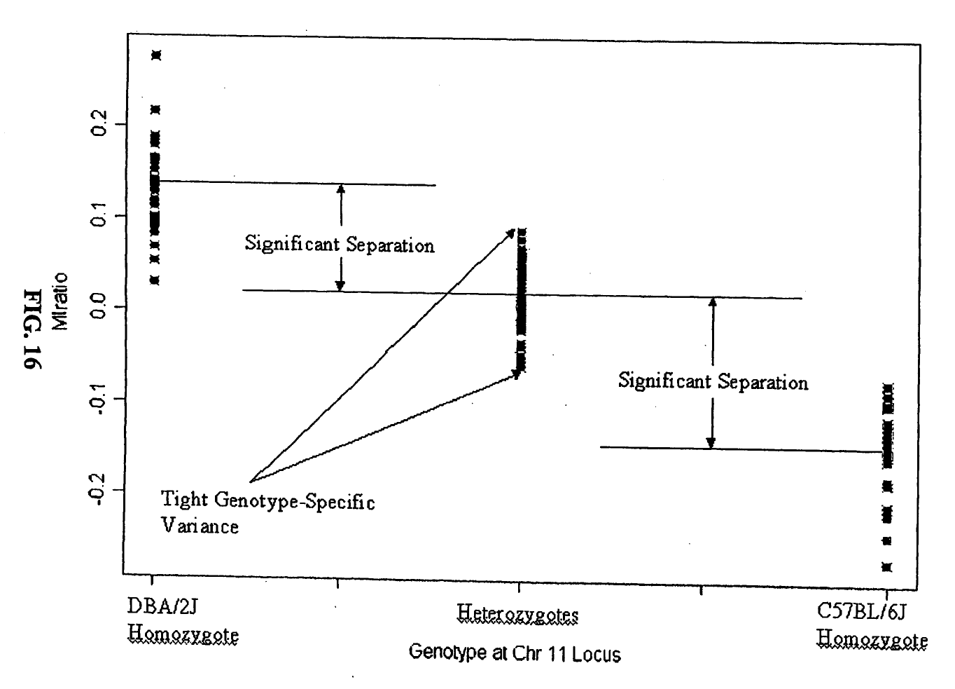

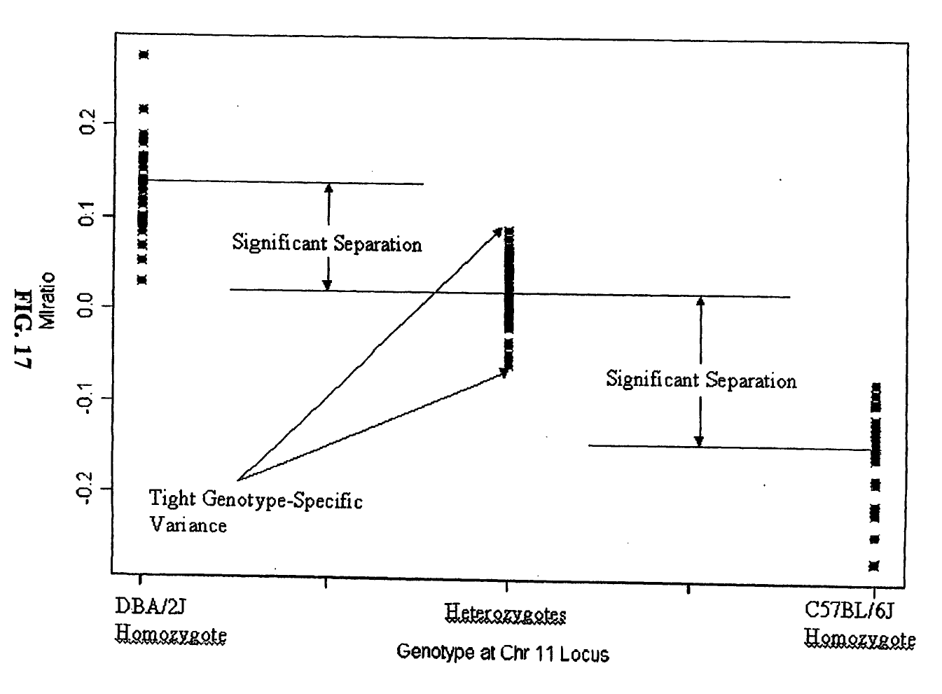

One of the genes illustrated in FIG. 15, the peroxisome proliferator activated receptor (PPAR) binding protein, has a very large QTL at this chromosome 11 locus (curve 1502). The PPAR binding protein is known to be a key co-activator for PPAR alpha, which also links to this chromosome 11 locus. FIG. 16 shows a scatter plot that breaks down the mean log ratios for the PPAR binding protein by genotype at the chromosome 11 location across the F2 mouse population (120 F2 mouse livers) that was profiled. Of note in FIG. 16 is the subtle, but consistent expression among the genotypes that would have been completely missed if only the differential expression had been analyzed (i.e., without the use of quantitative expression QTL analysis) because the fold changes range only from only −1.5 to 1.5. However, with the genetics, a very strong signal is measured due to the tightness with which expression groups by genotype. FIG. 17 illustrates what the plot illustrated in FIG. 16 would look like in the random case. FIG. 17 illustrates the expression of PPAR alpha by genotype at the chromosome 15 location where the PPAR alpha gene physically resides. As can be seen by FIG. 17, the expression of PPAR alpha is almost completely random with respect to genotype, although a wider range of expression for the B6 genotype is observed. This may be of some interest because changes in variation are potentially as interesting as changes in mean.

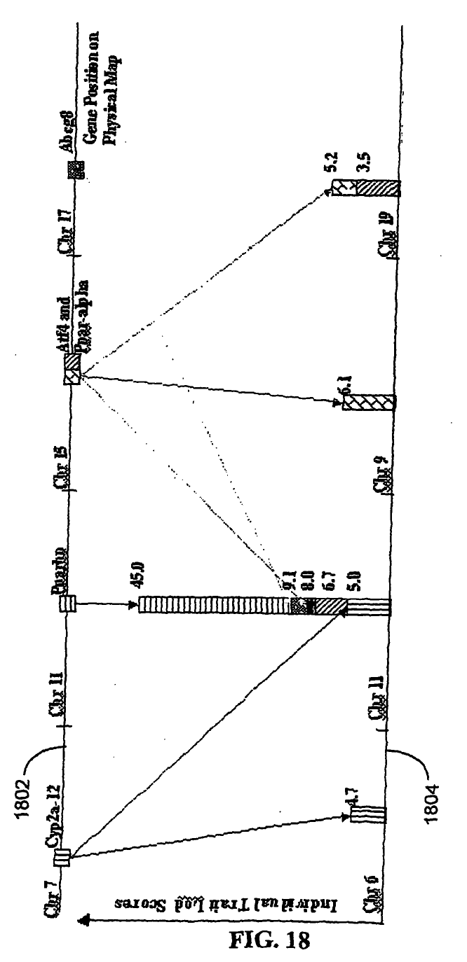

FIG. 18 illustrates how genes known to be involved in lipid metabolism link to the same genetic locus, even though they physically reside at different locations. In FIG. 18, the chromosomal positions of the genes Cyp2a-12, peroxisome proliferator activated receptor binding protein (PPARBP), Atf4, PPAR_{α}, and Abcq8 are shown on mouse genome map 1802. Further, the positions of eQTL that correspond to these genes are shown on mouse genome map 1804. Specifically, the eQTL that arise when each of the genes mapped to genome map 1802 is treated as a quantitative trait in a QTL analysis is shown mapped to mouse genome map 1804 of FIG. 18. The gene PPARBP physically resides at an eQTL hot spot positioned on chromosome 11 of genome map 1804. The correspondence of the physical location of PPARBP with this eQTL hot spot implicates this gene as the causative agent for the eQTL at the hotspot. Thus, the data shown in FIG. 8 suggest that PPARBP is in a biological pathway at a point that it is upstream from the genes Cyp2a-12, Atf4, PPAR_{α}, and Abcq8.

### 6.7. Elucidating Genes and Pathways for Complex Traits

Associating patterns of expression with a clinical trait and dissecting those patterns by associating them with susceptibility loci, represents a potentially powerful way to dissect complex diseases. The present example provides a method for associating a gene with a clinical trait T. In some embodiments, clinical trait T is a complex trait (e.g., complex disease). Section 5.15 describes the characteristics of some complex traits within the scope of the present invention. The method works by interfacing gene expression data with clinical trait data in order to identify potential causative genes for a trait and the associated pattern of response. The steps used in the method are illustrated in FIG. 19 and described in section 5.16, above.

### 6.7.1. Case Study Using Mouse Data

The steps outlined in FIG. 19 were performed using the mouse system described in Section 6.4. Livers were profiled in mice after the mice had been on a high-fat, atherogenic diet for four months. Such mice represent the spectrum of disease in a natural population, with many mice developing atherosclerotic lesions and brain lesions, and others having significantly higher fat-pad masses, higher cholesterol levels and larger bone structures than others in the same population. Identifying QTL for these clinical traits (cQTL) and linking this information with the gene expression traits to elucidate genes and pathways associated with the clinical traits is a central motivation of the inventive method (FIG. 19) described in this example.

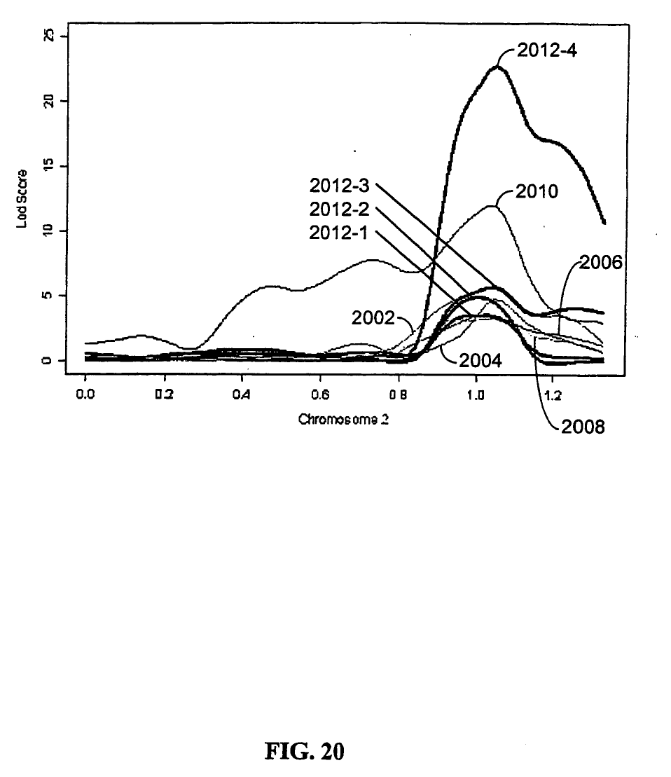

More than one percent of the eQTL identified genome-wide for the 7,861 genes G that were used in respective QTL analysis (e.g., instances of processing step 1910, FIG. 19) fall within a 10 cM window centered at approximately 100 cM on chromosome 2 in the mouse genome (FIG. 20). There are 867 genes with lod scores over 2.0 linked to this region. Co-localized with this locus are many cQTL (determined by instances of processing step 1912, FIG. 19) for clinical traits T such as adiposity, fat pad mass, plasma lipid levels and bone density. FIG. 20 shows the lod score curves for four of the obesity-related traits, the peaks of which are almost perfectly coincident with the hundreds of eQTL falling at that locus. The four obesity related traits are (1) subcutaneous fat pad mass (curve 2002 peaking at 105 cM with a lod score=6.25), (2) perimetrial fat pad mass (curve 2004 peaking at 103 cM with a lod score=5.31, (3) omental fat pad mass (curve 2006 peaking at 103 cM with a lod score=3.80), and (4) adiposity (curve 2008 peaking at 105 cM with a lod score=3.69). The joint lod score curve for these four clinical traits is given by line 2010, peaking at 1.05M with a lod score=13.02. The majority of genes linked to this region do not physically reside on chromosome 2, and so are at least partially regulated by one or more loci in the chromosome 2 hot-spot region. For the 423 genes with mapping information, there are only four eQTL with lod scores greater than 3.0 that correspond to genes whose physical locations are within 2 cM of the peak (1916—Yes, 1920, FIG. 19). The lod score curves for these four potential candidate genes that may explain the chromosome 2 eQTL hot spot are represented by lines 2012 in FIG. 20. From highest lod score to the lowest, the four candidate genes are (1) RIKEN cDNA 2610042014 (NM_{—}025575) peaking at 103 cM with a lod score=24.43 (curve 2012-4), (2) ATPase, class It, type 9A (NM-015731) peaking at 105 cM with a lod score=6.13 (curve 2012-3), (3) RIKEN cDNA2610100K07 (NM-025996) peaking at 101 cM with a lod score=5.04 (curve 2012-2), and (4) zinc finger protein 64 (NM-009564) peaking at 101 cM with a lod score=3.56 (curve 2012-1).

The class of genes represented in FIG. 20 (curves 2012), identified by intersecting cQTL data with eQTL data in accordance with FIG. 19, provides convincing evidence that many of the genes co-localized to a single QTL hot spot are associated with the obesity-related traits. Hence, several candidate genes whose physical locations are coincident with their respective eQTL are reasonable candidate genes for further research It may be that the causative gene is not differentially regulated and so is not detectable with the methods described in this example. However, when these inventive methods are viewed from the standpoint of hypothesis generation, the candidate genes with supporting genetic clusters offers researchers valuable insight into complex traits and suggests meaningful hypothesis for further validation In this example, the combined gene expression/genetics approach has effectively generated interesting hypotheses by filtering the number of genes that would otherwise need to be considered from 25,000 to three or four reasonable candidates, with hundreds of additional genes forming patterns that represent the reactive changes induced by the causative set, all of which have been identified in a completely objective manner.

### 6.7.2. Hierarchical Clustering

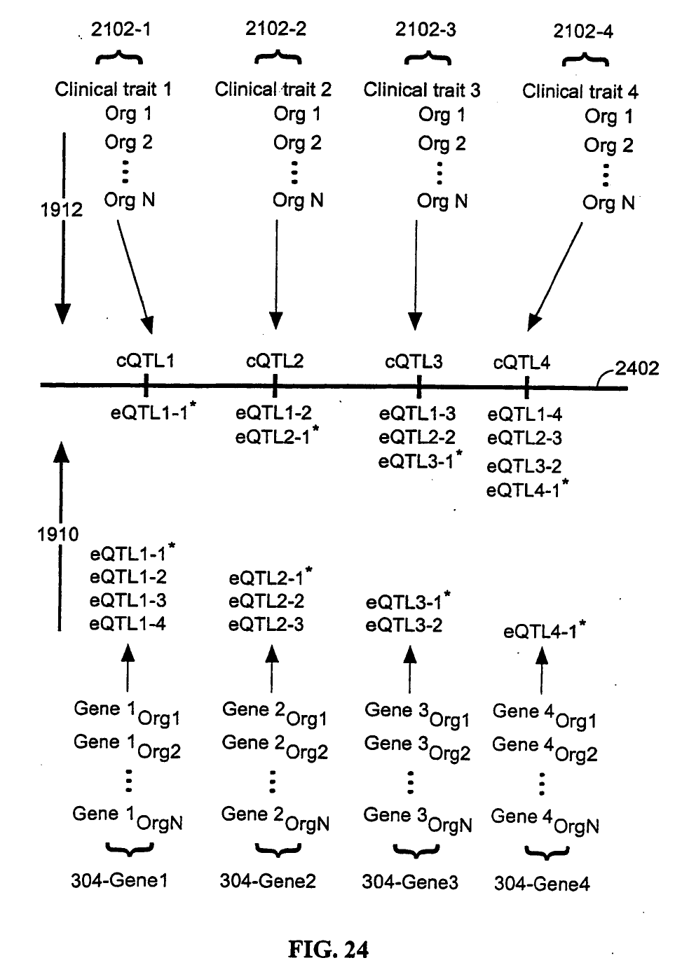

FIG. 23 represents the results of a two-dimensional hierarchical clustering, with 123 genes along the x-axis and 36 mice along the y-axis, representing the upper and lower 25^{th} percentile for the subcutaneous fat pad mass trait over 72 of the 111 F2 mice that were scored with respect to this trait. Two criteria were applied in selecting the 123 genes along the x-axis: 1) genes in this set had to be significantly expressed and differentially expressed in at least 10 mice, and 2) genes in this set had to have expression values that were able to discriminate between the extreme subcutaneous fat pad mass groups (using standard two-sample t test and a significance level of 0.05). To compute the array illustrated in FIG. 23, the log₁₀(expression ratio) was plotted as red (regions 2320) when the red channel is up-regulated to the green channel and 2) green (regions 2340) when the red channel is down-regulated relative to the green channels. White and gray areas in the array illustrated in FIG. 23 respectfully represent areas in which the log₁₀ (expression ratio) is close to zero and when data from both of the channels for a given prove is unreliable.

All genes depicted in FIG. 23 are either linked to the chromosome 2 locus identified in FIG. 20, or are highly correlated with genes that are linked to the region. The 123 genes used in FIG. 23 is able to discriminate between mice with high fat pad masses and those with low fat pad masses. Arrows 2302 highlight mice that have low fat pad mass, but a high fat pad mass gene signature. Arrow 2304 highlights a single mouse that has high fat pad mass, but a low fat pad mass gene signature.

Interestingly, a group of major urinary protein genes (MUP1, MUP4, and MUP5) are linked to the chromosome 2 locus, in addition to 7 other loci (all with lod scores exceeding 4.0), 4 of which co-localize with adiposity or fat pad mass traits. The MUP genes stand out because they are highly correlated with many other genes known to be involved in obesity-related pathways, including retinoid X receptor (RXR) gamma (R=0.75/P-value<<1.0E⁻¹⁵, acyl-Coenzyme A oxidase 1 (R=0.65/P-value=3.78E⁻¹⁵), and leptin receptor (R=−0.74/P-value<<1.0E⁻¹⁵), in addition to co-localizing with other genes like peroxisome proliferator activated receptor (PPAR) gamma, RXR interacting protein and LPR6, all known to be involved in these pathways. Mutations in the Leptin receptor in mice and man cause hyperphagia and extreme obesity. See, for example, Chen et al, 1996, Cell 84, 491-495; Chua et al, 1996, Science 271, 994-996; Clement et al., 1998, Nature 392, 398401; Montague et al., 1997, Nature 387, 903-908; Strobel et al., 1998, Nat. Genet. 18, 213-215; Tsigos et al., 2002, J. Pediatr. Endocrinol Metab. 15, 241-253. RXR is the obligate partner of many nuclear receptors including PPARα and PPARγ that are involve in many aspects of the control of lipid metabolism, glucose tolerance and insulin sensitivity. See Chawla et al, 2001, Science 294, 1866-1870. This demonstrates that the chromosome 2 locus identified in FIG. 20 draws together adiposity, fat pad mass, cholesterol and triglyceride levels and is linked to genes with proven roles in obesity and diabetes. Further, the MUP genes are members of the lipocalin protein family and are known to play a central role in phermone-binding processes that affect mouse physiology and behavior. See Timm et al., 2001, Protein Science 10, 997-1004. Furthermore, MUP expression levels have been associated with variations in body weight, bone length, and VLDL levels. See, for example, Metcalf et al., 2000, Nature 405, 109-1073; Swift et al., 2001, J. Lipid Res. 42, 218-224; Jiang and Zeng, 1995, Genetics 140, 1111-1127. Arrows 2306 in FIG. 23 indicate the positions of the MUP1, MUP2, and MUP3 genes.

The region supporting the chromosome 2 locus illustrated in FIG. 20 is homologous to human chromosome 20q12-q13.12, a region that has previously been linked to human obesity-related phenotypes. See Borecki et al., 1994, Obesity Research 2, 213-219; Lembertas et al., 1997, J. Clin. Invest 100, 1240-1247. The human homolog for gene NM_{—}025575 (FIG. 20; curve 2012-4) resides in the human chromosome 20 region, is novel, and is completely uncharacterized (no known function). While other genes such as melanocortin 3 receptor (MC3R) have been suggested as possible candidates for obesity at this locus (Lembertas et al., 1997, J. Clin. Invest 100, 1240-1247), this data suggests additional hypotheses for testing, such as gene NM_{—}025575 (FIG. 20; curve 2012-4), which are not only significantly linked to the murine chromosome 2 locus, but that are also significantly correlated with several of the fat pad mass traits also linked to the chromosome 2 locus. It is observed that expression levels or MC3R are not linked to the chromosome 2 locus illustrated in FIG. 20.

### 6.7.3. Testing for Pleiotropy

In some embodiments, the inventive method disclosed in FIG. 19 is extended. Tests developed by Jiang and Zheng (Genetics 140, 1111-1127, 1995) and implemented by Drake et al. Physiol. Genomics 5, 205-215, 2001) were applied to assess whether pleiotropy of a common underlying gene rather than close linkage of separate genes were responsible for the colocalized cQTL and eQTL in the chromosome 2 region. As set forth by Jiang and Zeng (Genetics 140, 1111-1127, 1995), to test the hypothesis of pleiotropy versus close linkage for two coincident QTL of interest, the multi-trait composite interval mapping (CIM) (Lynch and Walsh, 1998, Genetics and Analysis of Quantitative Traits, Sunderland, Mass.: Sinauer Associates) is reformulated. The hypothesis of interest (H₀ and H₁) involve the positions p of the QTL having an effect on trait 1 and position p₂ of the QTL having an effect on trait 2 are given by:
H₀:p₁=p₂
H₁:p₁≠p₂
The alternative hypothesis indicates that the QTL are nonpleiotropic and are located at different map positions. The likelihood for H₀ is the same as that given for the multi-trait CIM model. However, the likelihood for the alternative is that developed by Jiang and Zeng (Genetics 140, 1111-1127, 1995). Using the prescription set forth by Jiang and Zeng, calculation of the maximum likelihoods for each hypothesis was carried out using the expectation-conditional maximization (ECM) algorithm. Once the maximum likelihoods under each hypothesis were computed, the log ration of the likelihoods was computed to serve as the test statistic. This log-likelihood ration test statistic is asymptotic to a χ² distribution with one degree of freedom.

The test supported the hypothesis of pleiotropy (one allele affecting several traits) in that no significant results for the traits subcutaneous fat pad mass, perimetrial fat pad mass, omental fat pad mass, or adiposity at the 0.05 significance level were found. The results obtained are consistent with pleiotropy of a common underlying gene regulating the clinical and expression traits linked to the chromosome 2 locus. The four genes detailed in FIG. 20 by curves 2012-1 through 2012-4 may be considered as primary causative candidates for all of the linkage activity at the chromosome 2 locus. The majority of genes linked to the chromosome 2 region are significantly correlated among themselves, and functional patterns emerge from these data that support the hypothesis that these genes are associated with the clinical traits linked to this region. As an example, 186 of the 867 genes linked to this region have been assigned to GO categories (The Gene Ontology Consortium, 2001, Genome Research 11, 1425-1433). Of these, 39 have been assigned to the “ATP binding” molecular function category. With 4,771 genes having GO classifications and lod scores greater than 2.0, the “ATP binding” category occurs in 514 of these genes. Fisher's Exact Test was used to determine if the “AT? binding” category is more represented in the chromosome 2 QTL cluster than would be expected by chance (p-value=0.0000008). Such strong significance indicates that the high occurrence of “ATP binding” in the cluster could not have happened by chance. Further, subsets within the 39 genes are highly correlated with genes known to be associated with obesity related traits. These genes include Leptin receptor (correlation coefficient=3.8E⁻¹³) and RXR gamma (correlation coefficient 0.78/pvalue=3.8E⁻¹³).

### 7. REFERENCES CITED

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that comprises a computer program mechanism embedded in a computer readable storage medium. For instance, the computer program product could contain the program modules shown in FIG. 1. These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

Many modifications and variations of this invention can be made without departing from its spirit and scope, as will be apparent to those skilled in the art. The specific embodiments described herein are offered by way of example only, and the invention is to be limited only by the terms of the appended claims, along with the fill scope of equivalents to which such claims are entitled.

1. A method for associating a gene G in the genome of a species with a clinical trait T exhibited by one or more organisms in a plurality of organisms of said species, the method comprising:
(A) identifying an expression quantitative trait loci (eQTL) for said gene G using a first quantitative trait loci (QTL) analysis, wherein said first QTL analysis uses a plurality of expression statistics for gene G as a quantitative trait, wherein each expression statistic in said plurality of expression statistics represents an expression value for gene G in an organism in said plurality of organisms;
(B) identifying a clinical quantitative trait loci (cQTL) that is linked to said clinical trait T using a second QTL analysis, wherein said second QTL analysis uses a plurality of phenotypic values as a quantitative trait, wherein each phenotypic value in said plurality of phenotypic values is a phenotypic value for said clinical trait T in an organism in said plurality of organisms; and
(C) determining whether said eQTL and said cQTL colocalize to the same locus in the genome of said species, wherein, when said eQTL and said cQTL colocalize to the same locus, said gene G is associated with said clinical trait T.

2. The method of claim 1, wherein said determining step further comprises determining whether the locus of said eQTL in the genome of said species corresponds to the physical location of said gene G in the genome of said species, wherein, when said locus of said eQTL in the genome of said species corresponds to the physical location of said gene G in the genome of said species, the association between said gene G and said clinical trait T is confirmed.

3. The method of claim 2, wherein said eQTL corresponds to the physical location of said gene G when the eQTL and gene G colocalize within 3 cM of each other in the genome of said species.

4. The method of claim 2, wherein said eQTL corresponds to the physical location of said gene G when the eQTL and gene G colocalize within 1 cM of each other in the genome of said species.

5. The method of claim 1, wherein said eQTL and said cQTL are not colocalized unless a test for pleiotropy indicates that said eQTL and said cQTL are represented by a QTL that is common to both said eQTL and said cQTL.

6. The method of claim 1, wherein said first QTL analysis and said second QTL analysis each uses a genetic map.

7. The method of claim 6, which further comprises, prior to the first identifying step, a step of constructing said genetic map from a set of genetic markers associated with said plurality of organisms.

8. The method of claim 7, wherein said set of genetic markers comprises single nucleotide polymorphisms (SNPs), microsatellite markers, restriction fragment length polymorphisms, short tandem repeats, DNA methylation markers, sequence length polymorphisms, random amplified polymorphic DNA, amplified fragment length polymorphisms, or simple sequence repeats.

9. The method of claim 7, wherein genotype data is used in said constructing step and wherein said genotype data comprises knowledge of which alleles, for each marker in said set, of genetic markers, are present in each organism in said plurality of organisms.

10. The method of claim 7, wherein said plurality of organisms represents a segregating population and pedigree data is used in said constructing step, and wherein said pedigree data shows one or more relationships between organisms in said plurality of organisms.

11. The method of claim 10, wherein said plurality of organisms comprises an F2 population, a Fₜ population, a F_{2:3} population, or a Design III population and said one or more relationships between organisms in said plurality of organisms indicates which organisms in said plurality of organisms are members of said F2 population, said Fₜ population, said F_{2:3} population, or said Design III population.

12. The method of claim 1, wherein each said expression value is a normalized expression level measurement for said gene G in an organism in said plurality of organisms.

13. The method of claim 12, wherein each said expression level measurement is determined by measuring an amount of a cellular constituent that corresponds to said gene G in one or more cells from an organism in said plurality of organisms.

14. The method of claim 13, wherein said amount of said cellular constituent comprises an abundance of an RNA present in said one or more cells of said organism, an abundance of a protein in said one or more cells of said organism, an abundance of an mRNA expressing said gene, or a degree of protein modification.

15. The method of claim 14, wherein said abundance of said RNA is measured by a method comprising contacting a gene transcript array with said RNA from said one or more cells of said organism, or with nucleic acid derived from said RNA, wherein said gene transcript array comprises a positionally addressable surface with attached nucleic acids or nucleic acid mimics, wherein said nucleic acids or nucleic acid mimics are capable of hybridizing with said RNA species, or with nucleic acid derived from said RNA species.

16. The method of claim 12, wherein said normalized expression level measurement is obtained by a normalization technique selected from the group consisting of Z-score of intensity, median intensity, log median intensity, Z-score standard deviation log of intensity, Z-score mean absolute deviation of log intensity, calibration DNA gene set, user normalization gene set, ratio median intensity correction, and intensity background correction.

17. The method of claim 1, wherein said first QTL analysis comprises:
(i) testing for linkage between (a) the genotype of said plurality of organisms at a position in the genome of said species and (b) said plurality of expression statistics for gene G;
(ii) advancing the position in said genome by an amount; and
(iii) repeating steps (i) and (ii) until all or a portion of the genome of said species has been tested.

18. The method of claim 17, wherein said amount is less than 100 centiMorgans.

19. The method of claim 17, wherein said amount is less than 10 centiMorgans.

20. The method of claim 17, wherein said amount is less than 5 centiMorgans.

21. The method of claim 17, wherein said amount is less than 2.5 centiMorgans.

22. The method of claim 17, wherein said testing comprises performing linkage analysis or association analysis.

23. The method of claim 22, wherein said linkage analysis or association analysis generates a statistical score for said position in the genome of said species.

24. The method of claim 23, wherein said testing is linkage analysis and said statistical score is a logarithm of the odds (lod) score.

25. The method of claim 24, wherein said eQTL is represented by a lod score that is greater than 2.0.

26-27. (canceled)

28. The method of claim 24, wherein said eQTL is represented by a lod score that is greater than 5.0.

29. The method of claim 1, wherein said second QTL analysis comprises:
(i) testing for linkage between (a) the genotype of said plurality of organisms at a position in the genome of said species and (b) said plurality of phenotypic values;
(ii) advancing the position in said genome by an amount; and
(iii) repeating steps (i) and (ii) until all or a portion of the genome of said species has been tested.

30. The method of claim 29, wherein said amount is less than 100 centiMorgans.

31-32. (canceled)

33. The method of claim 29, wherein said amount is less than 2.5 centiMorgans.

34. The method of claim 29, wherein said testing comprises performing linkage analysis or association analysis.

35. The method of claim 34, wherein said linkage analysis or association analysis generates a statistical score for said position in the genome of said species.

36. The method of claim 35, wherein said testing is linkage analysis and said statistical score is a logarithm of the odds (lod) score.

37. The method of claim 36, wherein said cQTL is represented by a lod score that is greater than 2.0.

38-39. (canceled)

40. The method of claim 36, wherein said cQTL is represented by a lod score that is greater than 5.0.

41. The method of claim 1, wherein said plurality of organisms is human.

42. The method of claim 1, wherein said clinical trait T is a complex trait.

43. The method of claim 42, wherein said complex trait is characterized by an allele that exhibits incomplete penetrance in said species.

44. The method of claim 42, wherein said complex trait is a disease that is contracted by an organism in said population, and wherein said organism inherits no predisposing allele to said disease.

45. The method of claim 42, wherein said complex trait arises when any of a plurality of different genes in the genome of said species is mutated.

46. The method of claim 42, wherein said complex trait requires the simultaneous presence of mutations in a plurality of genes in the genome of said species.

47. The method of claim 42, wherein said complex trait is associated with a high frequency of disease-causing alleles in said species.

48. The method of claim 42, wherein said complex trait is a phenotype that does not exhibit Mendelian recessive or dominant inheritance attributable to a single gene locus.

49. The method of claim 42, wherein said complex trait is asthma, ataxia telangiectasia, bipolar disorder, cancer, common late-onset Alzheimer's disease, diabetes, heart disease, hereditary early-onset Alzheimer's disease, hereditary nonpolyposis colon cancer, hypertension, infection, maturity-onset diabetes of the young, mellitus, migraine, nonalcoholic fatty liver, nonalcoholic steatohepatitis, non-insulin-dependent diabetes mellitus, obesity, polycystic kidney disease, psoriases, schizophrenia, or xeroderma pigmentosum.

50. The method of claim 1, wherein said eQTL and said cQTL colocalize to the same locus in the genome of said species when the physical location of the eQTL in said genome is within 40 cM of the physical location of the cQTL in said genome.

51. (canceled)

52. The method of claim 1, wherein said eQTL and said cQTL colocalize to the same locus in the genome of said species when the physical location of the eQTL in said genome is within 10 cM of the physical location of the cQTL in said genome.

53. The method of claim 1, wherein said eQTL and said cQTL colocalize to the same locus in the genome of said species when the physical location of the eQTL in said genome is within 6 cM of the physical location of the cQTL in said genome.

54. A computer program product for use in conjunction with a computer system, the computer program product comprising a computer readable storage medium and a computer program mechanism embedded therein, the computer program mechanism for associating a gene G in the genome of a species with a clinical trait T exhibited by one or more organisms in a plurality of organisms of said species, the computer program mechanism comprising:
an expression quantitative trait loci (eQTL) identification module for identifying an expression quantitative trait loci (eQTL) for said gene G using a first quantitative trait loci (QTL) analysis, wherein said first QTL analysis uses a plurality of expression statistics for gene G as a quantitative trait, wherein each expression statistic in said plurality of expression statistics represents an expression value for gene G in an organism in said plurality of organisms;
a clinical quantitative trait loci (cQTL) identification module for identifying a clinical quantitative trait loci (cQTL) that is linked to said clinical trait T using a second QTL analysis, wherein said second QTL analysis uses a plurality of phenotypic values as a quantitative trait, wherein each phenotypic value in said plurality of phenotypic values represents a phenotypic value for said clinical trait T in an organism in said plurality of organisms; and
a determination module for determining whether said eQTL and said cQTL colocalize to the same locus in the genome of said species, wherein, when said eQTL and said cQTL colocalize to the same locus, said gene G is associated with said clinical trait T.

55-106. (canceled)

107. A computer system for associating a gene G in the genome of a species with a clinical trait T exhibited by one or more organisms in a plurality of organisms of said species, the computer system comprising:
a central processing unit;
a memory, coupled to the central processing unit, the memory storing an expression quantitative trait loci (eQTL) identification module, a clinical quantitative trait loci (cQTL) identification module, and a determination module; wherein
the expression quantitative trait loci (eQTL) identification module comprises instructions for identifying an expression quantitative trait loci (eQTL) for said gene G using a first quantitative trait loci (QTL) analysis, wherein said first QTL analysis uses a plurality of expression statistics for gene G as a quantitative trait, wherein each expression statistic in said plurality of expression statistics represents an expression value for gene G in an organism in said plurality of organisms;
the clinical quantitative trait loci (cQTL) identification module comprises instructions for identifying a clinical quantitative trait loci (cQTL) that is linked to said clinical trait T using a second QTL analysis, wherein said second QTL analysis uses a plurality of phenotypic values as a quantitative trait, wherein each phenotypic value in said plurality of phenotypic values represents a phenotypic value for said clinical trait T in an organism in said plurality of organisms; and
the determination module comprises instructions for determining whether said eQTL and said cQTL colocalize to the same locus in the genome of said species, wherein, when said eQTL and said cQTL colocalize to the same locus, said gene G is associated with said clinical trait T.

108-251. (canceled)

252. The method of claim 1, the method further comprising:
(D) validating said association between said gene G and said clinical trait T by testing for genetic linkage between said expression quantitative trait loci (eQTL) and said clinical quantitative trait loci (cQTL).

253. The method of claim 252 wherein said testing for genetic linkage comprises marker-difference regression or a multiple-trait extension of composite interval mapping.

254-257. (canceled)

258. The method of claim 5 wherein said test for pleiotropy comprises comparing a null hypothesis, indicating that said eQTL and said cQTL are represented by a QTL that is common to both said eQTL and said cQTL, to an alternative hypothesis, indicating linkage disequilibrium.

259. The method of claim 258 wherein said null hypothesis is:
$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} \\ {β}_{2}\end{matrix} ) Q + ( \begin{matrix}{ɛ}_{1} \\ {ɛ}_{2}\end{matrix} ) ,$$
wherein
Q is a categorical random variable indicating the genotypes at the position of said eQTL and said cQTL in said plurality of organisms;
$$( \begin{matrix}{ɛ}_{1} \\ {ɛ}_{2}\end{matrix} )$$
is distributed as a bivariate normal random variable with mean
$$( \begin{matrix}0 \\ 0\end{matrix} )$$
and covariance matrix
$$( \begin{matrix}{σ}_{1}^{2} & {σ}_{1} {σ}_{2} \\ {σ}_{2} {σ}_{1} & {σ}_{2}^{2}\end{matrix} ) ; and$$
μᵢ and βᵢ are model parameters.

260. The method of claim 258 wherein the alternative hypothesis is:
$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} & {β}_{2} \\ {β}_{3} & {β}_{4}\end{matrix} ) ( \begin{matrix}{Q}_{1} \\ {Q}_{2}\end{matrix} ) + ( \begin{matrix}{ɛ}_{1} \\ {ɛ}_{2}\end{matrix} ) ,$$
wherein
Q₁ and Q₂ are categorical random variables indicating the genotypes at the positions of said eQTL and said cQTL in said plurality of organisms;
$$( \begin{matrix}{ɛ}_{1} \\ {ɛ}_{2}\end{matrix} )$$
is distributed as a bivariate normal random variable with mean
$$( \begin{matrix}0 \\ 0\end{matrix} )$$
and covariance matrix
$$( \begin{matrix}{σ}_{1}^{2} & {σ}_{1} {σ}_{2} \\ {σ}_{2} {σ}_{1} & {σ}_{2}^{2}\end{matrix} ) ; and$$
μᵢ and βᵢ are model parameters.

261. The method of claim 258 wherein the alternative hypothesis is:
$$( \begin{matrix}{y}_{1} \\ {y}_{2}\end{matrix} ) = ( \begin{matrix}{μ}_{1} \\ {μ}_{2}\end{matrix} ) + ( \begin{matrix}{β}_{1} & {β}_{2} \\ {β}_{3} & {β}_{4}\end{matrix} ) ( \begin{matrix}{Q}_{1} \\ {Q}_{2}\end{matrix} ) + ( \begin{matrix}{ɛ}_{1} \\ {ɛ}_{2}\end{matrix} ) ,$$
wherein
Q₁ and Q₂ are categorical random variables indicating the genotypes at the positions of said eQTL and said cQTL in said plurality of organisms;
$$( \begin{matrix}{ɛ}_{1} \\ {ɛ}_{2}\end{matrix} )$$
is distributed as a bivariate normal random variable with mean
$$( \begin{matrix}0 \\ 0\end{matrix} )$$
and covariance matrix
$$( \begin{matrix}{σ}_{1}^{2} & {σ}_{1} {σ}_{2} \\ {σ}_{2} {σ}_{1} & {σ}_{2}^{2}\end{matrix} ) ;$$
μᵢ and βᵢ are model parameters; and one of conditions (i) through (iv) is valid:
β₁≠0, β₄≠0, β₂=0, and β₃=0; (i)
β₁≠0, β₄≠0, β₂≠0, and β₃=0; (ii)
β₁≠0, β₄≠0, β₂=0, and β₃≠0; and (iii)
β₁≠0, β₄≠0, β₂≠0, and β₃≠0. (iv)

262. The method of claim 258 wherein the negative log likelihood for the null hypothesis and the alternative hypothesis are minimized using maximum likelihood analysis thereby forming a likelihood ratio test statistic.

263-272. (canceled)
